(19) United States
(12) Patent Application Publication
(10) Pub. No.: US 2025/0011241 A1
(43) Pub. Date: Jan. 9, 2025

(54) GEOPOLYMER COMPOSITIONS INCLUDING ORGANIC BASES AND METHODS OF SYNTHESIZING AND FORMING CERAMICS THEREFROM

(71) Applicant: The Board of Trustees of the University of Illinois, Urbana, IL (US)

(72) Inventors: Waltraud M. Kriven, Urbana, IL (US); Devon Samuel, Urbana, IL (US)

(21) Appl. No.: 18/753,291

(22) Filed: Jun. 25, 2024

Related U.S. Application Data
(60) Provisional application No. 63/510,944, filed on Jun. 29, 2023.

(51) Int. Cl. C04B 35/185; B33Y 70/00; C04B 41/00; C09D 1/06

(52) U.S. Cl. CPC C04B 35/185; B33Y 70/00; C04B 41/0072; C09D 1/06; C04B 2235/3463; C04B 2235/48; C04B 2235/6567; C04B 2235/72

(57) ABSTRACT

Geopolymer compositions are provided herein, the geopolymer compositions including an aluminosilicate or a silicate of magnesium, zinc, and/or one or more rare earth metals, and an organic base, the organic base including an amidine, a guanidine, a vinamidine, a tetra-substituted ammonium species, an amine, a phosphazene, a tetra-substituted phosphonium species, a conjugate acid thereof, a salt thereof, or any combination thereof. Methods of making the geopolymer compositions are further provided. Methods of making alkali-free ceramics from geopolymer compositions including an organic base are further provided.

### CROSS-REFERENCE TO RELATED APPLICATIONS

The present application claims the benefit of U.S. Provisional Application No. 63/510,944, filed Jun. 29, 2023, the entirety of which is incorporated by reference herein for all purposes.

### STATEMENT REGARDING FEDERALLY FUNDED RESEARCH

This invention was made with government support under contract number W9132T-21-C-0005 AH571 Banner Grant Code 1-476030-919000-191100 awarded by the United States Army Construction Engineering Research Lab (Champaign, IL). The government has certain rights in the invention.

### TECHNICAL FIELD

The present disclosure relates to geopolymer compositions and ceramics.

### BACKGROUND

Conventional ceramics may contain appreciable calcium and may thereby set by formation of calcium silicate hydrate (“CSH”). However, calcium-free ceramics are desirable. Ceramics may alternatively be dried to induce setting, so that partially dissolved silicates bind the remaining particles. Drying may cause warping, cracking, and other defects due to capillary forces.

Conventional geopolymers include alkali metal ionic species, such as sodium, potassium, and cesium ions, when formed. The geopolymer may undergo ion exchange of the alkali cations by being soaked in an aqueous salt, sometimes undergoing several cycles of soaking, which adds significant time to the preparation of geopolymers. Ion exchange relies on diffusion of ions and may be extremely slow for nonporous bulk bodies, and geopolymers with high porosity may yield ceramics with low strength and low density. Further ion exchange may not reach completion, and may leave some alkali cations in the geopolymer, resulting in a gradient in composition.

There is a need for methods of synthesizing and forming calcium-free ceramics. Further, there is a need for ceramics that may be manipulated more during forming. Further, there is a need for ceramics with reduced or eliminated drying defects. Further, there is a need for geopolymers that do not require an ion exchange process to remove alkali cations.

### SUMMARY

In an example, the present disclosure provides a geopolymer composition, including: an organic base; and an aluminosilicate.

In another example, the present disclosure provides a geopolymer composition, including: an organic base; and a silicate of magnesium, zinc, aluminum, and/or one or more rare earth elements.

In certain examples, the one or more rare earth elements may be yttrium.

In certain examples, the organic base may include an amidine, a guanidine, a vinamidine, a tetra-substituted ammonium species, an amine, a phosphazene, a tetra-substituted phosphonium species, a conjugate acid thereof, a salt thereof, or any combination thereof.

In certain examples, the organic base may include a compound of formula (I), or a salt of a conjugate acid of a compound of formula (I):

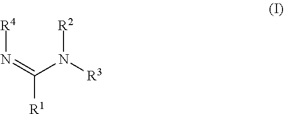

wherein each of R¹, R², R³, and R⁴ is independently selected from hydrogen, (C₁-C₂₀)alkyl, (C₁-C₂₀)alkoxy, (C₂-C₂₀)alkenyl, (C₂-C₂₀)alkenyloxy, (C₂-C₂₀)alkynyl, (C₂-C₂₀)alkynyloxy, aryl, aryloxy, heteroaryl, heteroaryloxy, heterocyclyl, heterocyclyloxy, aryl(C₁-C₄)alkyl, (C₁-C₄)alkylaryl(C₁-C₄)alkyl, heteroaryl(C₁-C₄)alkyl, (C₁-C₄)alkylheteroaryl(C₁-C₄)alkyl, heterocyclyl(C₁-C₄)alkyl, and (C₁-C₄)alkylheterocyclyl(C₁-C₄)alkyl, each of which is optionally substituted with alkoxy, hydroxy, amino, or N-substituted amino; or any two of R¹, R², R³, and R⁴, taken together with the carbon and/or nitrogen to which the two of R¹, R², R³, and R⁴ are respectively bonded, form a heterocyclic or heteroaryl ring that is optionally substituted with alkoxy, hydroxy, amino, or N-substituted amino; and provided that R¹, R², R³, and R⁴ are not all simultaneously hydrogen.

In certain examples, the organic base may include a compound of formula (II), or a salt of a conjugate acid of a compound of formula (II):

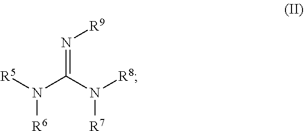

wherein each of R⁵, R⁶, R⁷, R⁸, and R⁹ is independently selected from hydrogen, (C₁-C₂₀)alkyl, (C₁-C₂₀)alkoxy, (C₂-C₂₀)alkenyl, (C₂-C₂₀)alkenyloxy, (C₂-C₂₀)alkynyl, (C₂-C₂₀)alkynyloxy, aryl, aryloxy, heteroaryl, heteroaryloxy, heterocyclyl, heterocyclyloxy, aryl(C₁-C₄)alkyl, (C₁-C₄)alkylaryl(C₁-C₄)alkyl, heteroaryl(C₁-C₄)alkyl, (C₁-C₄)alkylheteroaryl(C₁-C₄)alkyl, heterocyclyl(C₁-C₄)alkyl, and (C₁-C₄)alkylheterocyclyl(C₁-C₄)alkyl, each of which is optionally substituted with alkoxy, hydroxy, amino, or N-substituted amino; wherein any two of R⁵, R⁶, R⁷, R¹, and R⁹, taken together with nitrogen, to which the two of R⁵, R⁶, R⁷, R⁸, and R⁹ are bonded and optionally carbon, optionally form a heterocyclic or heteroaryl ring that is optionally substituted with alkoxy, hydroxy, amino, or N-substituted amino.

In certain examples, the organic base may include a compound of formula (III) or a salt thereof:

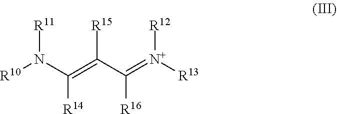

wherein each of R¹⁰, R¹¹, R¹², R¹³, R¹⁴, R¹⁵, and R¹⁶ is independently selected from hydrogen, (C₁-C₂₀)alkyl, (C₁-C₂₀)alkoxy, (C₂-C₂₀)alkenyl, (C₂-C₂₀)alkenyloxy, (C₂-C₂₀)alkynyl, (C₂-C₂₀)alkynyloxy, aryl, aryloxy, heteroaryl, heteroaryloxy, heterocyclyl, heterocyclyloxy, aryl(C₁-C₄)alkyl, (C₁-C₄)alkylaryl(C₁-C₄)alkyl, heteroaryl(C₁-C₄)alkyl, (C₁-C₄)alkylheteroaryl(C₁-C₄)alkyl, heterocyclyl(C₁-C₄)alkyl, and (C₁-C₄)alkylheterocyclyl(C₁-C₄)alkyl, each of which is optionally substituted with alkoxy, hydroxy, amino, or N-substituted amino; wherein R¹⁵, and one of R¹¹ or R¹⁵, taken together with the carbons and nitrogen between R¹⁵, and the one of R¹¹ or R¹², optionally form a heterocyclic or heteroaryl ring; wherein R¹⁰ and R¹¹ and/or R¹² and R¹³, taken together with nitrogen, optionally form a heterocyclic or heteroaryl ring; wherein R¹⁴, and one of R¹⁰ or R¹¹, and/or R¹⁶, and one of R¹² and R¹³, taken together with carbon and nitrogen, optionally form a heterocyclic ring; wherein R¹⁴ and R¹⁶, taken together with the carbons between R¹⁴ and R¹⁶, optionally form a carbocyclic or heterocyclic ring; provided that R¹⁰ and R¹¹ are not simultaneously hydrogen; and provided that R¹² and R¹³ are not simultaneously hydrogen.

In certain examples, the organic base may include a compound of formula (IV) or a salt thereof:

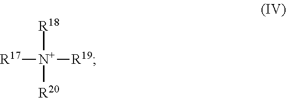

wherein each of R¹⁷, R¹⁸, R¹⁹, and R²⁰ is independently selected from (C₁-C₂₀)alkyl, (C₁-C₂₀)alkoxy, (C₂-C₂₀)alkenyl, (C₂-C₂₀)alkenyloxy, (C₂-C₂₀)alkynyl, (C₂-C₂₀)alkynyloxy, aryl, aryloxy, heteroaryl, heteroaryloxy, heterocyclyl, heterocyclyloxy, aryl(C₁-C₄)alkyl, (C₁-C₄)alkylaryl(C₁-C₄)alkyl, heteroaryl(C₁-C₄)alkyl, (C₁-C₄)alkylheteroaryl(C₁-C₄)alkyl, heterocyclyl(C₁-C₄)alkyl, and (C₁-C₄)alkylheterocyclyl(C₁-C₄)alkyl, each of which is optionally substituted with alkoxy, hydroxy, amino, or N-substituted amino; wherein any two of R¹⁷, R¹⁸, R¹⁹, and R²⁰, taken together with nitrogen, optionally form a heterocyclic or heteroaryl ring.

In certain examples, the organic base may include a compound of formula (V) or a salt of a conjugate acid of a compound of formula (V):

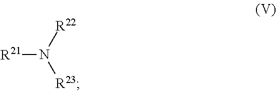

wherein each of R²¹, R²², and R²³ is independently selected from (C₁-C₂₀)alkyl, (C₁-C₂₀)alkoxy, (C₂-C₂₀)alkenyl, (C₂-C₂₀)alkenyloxy, (C₂-C₂₀)alkynyl, (C₂-C₂₀)alkynyloxy, aryl, aryloxy, heteroaryl, heteroaryloxy, heterocyclyl, heterocyclyloxy, aryl(C₁-C₄)alkyl, (C₁-C₄)alkylaryl(C₁-C₄)alkyl, heteroaryl(C₁-C₄)alkyl, (C₁-C₄)alkylheteroaryl(C₁-C₄)alkyl, heterocyclyl(C₁-C₄)alkyl, and (C₁-C₄)alkylheterocyclyl(C₁-C₄)alkyl, each of which is optionally substituted with alkoxy, hydroxy, amino, or N-substituted amino; and wherein any two of R²¹, R²², and R²³, taken together with nitrogen, optionally form a heterocyclic or heteroaryl ring.

In certain examples, the organic base may include a compound of formula (VI) or a salt of of a compound of formula (VI):

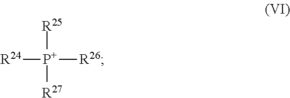

wherein each of R²⁴, R²⁵, R²⁶, and R²⁷ is independently selected from (C₁-C₂₀)alkyl, (C₁-C₂₀)alkoxy, (C₂-C₂₀)alkenyl, (C₂-C₂₀)alkenyloxy, (C₂-C₂₀)alkynyl, (C₂-C₂₀)alkynyloxy, aryl, aryloxy, heteroaryl, heteroaryloxy, heterocyclyl, heterocyclyloxy, aryl(C₁-C₄)alkyl, (C₁—C₄)alkylaryl(C₁-C₄)alkyl, heteroaryl(C₁-C₄)alkyl, (C₁-C₄)alkylheteroaryl(C₁-C₄)alkyl, heterocyclyl(C₁-C₄)alkyl, and (C₁-C₄)alkylheterocyclyl(C₁-C₄)alkyl, each of which is optionally substituted with alkoxy, hydroxy, amino, or N-substituted amino; and wherein any two of R²⁴, R²⁵, R²⁶, and R²⁷, taken together with phosphorus, optionally form a heterocyclic ring.

In certain examples, the organic base may include a compound of formula (VII) or a salt of a conjugate acid of formula (VII):

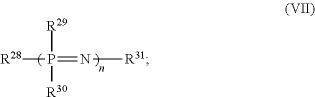

wherein each of R²⁸, R²⁹, and R³⁰ is N(R³²)₂ or N═P(N(R³³)₂)₃; wherein R³¹, each R³², and each R³³ are independently selected from hydrogen, (C₁-C₂₀)alkyl, (C₁-C₂₀)alkoxy, (C₂-C₂₀)alkenyl, (C₂-C₂₀)alkenyloxy, (C₂-C₂₀)alkynyl, (C₂-C₂₀)alkynyloxy, aryl, aryloxy, heteroaryl, heteroaryloxy, heterocyclyl, heterocyclyloxy, aryl(C₁-C₄)alkyl, (C₁-C₄)alkylaryl(C₁-C₄)alkyl, heteroaryl(C₁-C₄)alkyl, (C₁-C₄)alkylheteroaryl(C₁-C₄)alkyl, heterocyclyl(C₁-C₄)alkyl, and (C₁-C₄)alkylheterocyclyl(C₁-C₄)alkyl, each of which is optionally substituted with alkoxy, hydroxy, amino, or N-substituted amino; and wherein any two of R²⁸, R²⁹, and R³⁰, and/or any two R³², and/or any two R³³, taken together with nitrogen, may form a heterocyclic ring.

In certain examples, the organic base may include formamidine, acetamidine, 1,8-diazabicyclo[5.4.0]undec-7-ene, tetramethylguanidine, guanidine, tetramethylammonium, 1,8-bis(dimethylamino)naphthalene, diphenyldimethylphosphonium, P3 phosphazene, t-Bu-P₄, 2-tert-butylimino-2-diethylamino-1,3-dimethylperhydro-1,3,2-diazaphosphorine, a conjugate acid thereof, a salt thereof, or any combination thereof.

In certain examples, the salt may be a hydroxide or carbonate salt.

In certain examples, the geopolymer composition may further include water.

In certain examples, the aluminosilicate may include a molar ratio of Al₂O₃ to SiO₂ of from about 1:5 to about 5:1.

In certain examples, the geopolymer composition may be free of alkali metal species.

In certain examples, the geopolymer composition may be free of calcium.

In an example, the present disclosure provides a cured composition formed from a geopolymer composition.

In an example, the present disclosure provides a ceramic, including a geopolymer composition. In certain examples, the ceramic may include mullite. In certain examples, the ceramic may include cordierite. In certain examples, the ceramic may include a mixed yttrium and aluminum silicate. In certain examples, the ceramic may include yttrium disilicate. In certain examples, the ceramic may include willemite.

In an example, the present disclosure provides a coating including a geopolymer composition.

In an example, the present disclosure provides a three-dimensional printing resin including a geopolymer composition.

In an example, the present disclosure provides a method of making a geopolymer composition, including mixing the aluminosilicate with the organic base to provide the geopolymer composition. In certain examples, the method further includes dissolving the organic base in water to provide an aqueous solution of the organic base prior to the mixing. In certain examples, the method further includes dissolving silica in the aqueous solution of the organic base prior to the mixing. In certain examples, the method further includes forming the geopolymer composition in to a desired shape to provide a set geopolymer composition. In certain examples, the method further includes curing the set geopolymer composition to provide a cured geopolymer composition. In certain examples, the curing may be at a temperature of from about 5° C. to about 90° C. for a period of up to 1 month. In certain examples, the present disclosure may provide a method of making a ceramic from the cured geopolymer composition, including heating the cured geopolymer at a temperature of at least about 300° C. for at least about 4 hours. In certain examples, the ceramic may include mullite.

In an example, the present disclosure provides a method of making an alkali-free ceramic, including: mixing an aqueous solution of an organic base with an aluminosilicate to provide a geopolymer composition; forming the geopolymer composition into a desired shape to provide a set geopolymer composition; curing the set geopolymer composition to provide a cured geopolymer composition; and heating the cured geopolymer composition to provide the alkali-free ceramic. In certain examples, the method may further include dissolving silica in the aqueous solution of the organic base prior to the mixing. In certain examples, the method may be free of ion exchange. In certain examples, the forming may include applying the geopolymer composition as a coating that is the set geopolymer composition. In certain examples, the forming may include three-dimensionally printing the desired shape. In certain examples, the forming may include extruding the desired shape. In certain examples, the curing may be at a temperature of from about 5° C. to about 90° C. for a period of up to 1 month. In certain examples, the heating may be at a temperature of at least about 300° C. for at least about 4 hours.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

In order that the present disclosure may be well understood, there will now be described various forms thereof, given by way of example, reference being made to the accompanying drawings. The components in the figures are not necessarily to scale.

FIG. 1 illustrates a ²⁷Al nuclear magnetic resonance (“NMR”) spectrum of solid product made using an example of a tetramethylammonium hydroxide (“TMAOH”) geopolymer composition prepared in accordance with the principles of the present disclosure;

FIG. 2 illustrates a ²⁹Si NMR spectrum of solid product made using the example of the TMAOH geopolymer composition for which FIG. 1 illustrates an ²⁷Al NMR spectrum;

FIG. 3 illustrates an ²⁷Al NMR spectrum of solid product made using an example of a typical, potassium-based geopolymer composition prepared in accordance with the principles of the present disclosure;

FIG. 4 illustrates a ²⁹Si NMR spectrum of solid product made using the example of the potassium-based geopolymer composition for which FIG. 3 illustrates an ²⁷Al NMR spectrum;

FIG. 5 illustrates an X-ray diffraction (“XRD”) pattern of an example of a ceramic prepared from a geopolymer composition including TMAOH fired at 900° C.;

FIG. 6 illustrates an XRD pattern of an example of a ceramic prepared from a geopolymer composition including TMAOH fired at 1050° C.;

FIG. 7 illustrates an XRD pattern of an example of a ceramic prepared from a geopolymer composition including TMAOH fired at 1300° C.;

FIG. 8 illustrates an XRD pattern of the product of an example of a geopolymer composition including 2 guanidine·Al₂O₃·4SiO₂·13H₂O, prepared by mixing guanidine silicate solution with synthetic Al₂O₃·2SiO₂, prepared in accordance with the principles of the present disclosure;

FIG. 9 illustrates XRD patterns of the product of an example of a geopolymer composition including 2 guanidine·Al₂O₃·2SiO₂·13H₂O, prepared by mixing guanidine silicate solution with 1 mole of synthetic Al₂O₃ powder, prepared in accordance with the principles of the present disclosure;

FIG. 10 illustrates an XRD pattern of the product of an example of a geopolymer composition including 2 guanidine·3Al₂O₃·2SiO₂·13H₂O, prepared by mixing guanidine silicate solution with 3 moles of synthetic Al₂O₃ powder, prepared in accordance with the principles of the present disclosure;

FIG. 11 illustrates an ²⁷Al NMR spectrum of the product of an example of a geopolymer composition including 2 guanidine·Al₂O₃·4SiO₂·13H₂O, prepared by mixing guanidine silicate solution with synthetic Al₂O₃·2SiO₂ powder, prepared in accordance with the principles of the present disclosure;

FIG. 12 illustrates an ²⁷Al NMR spectrum of the product of FIG. 8;

FIG. 13 illustrates an ²⁷Al NMR spectrum of the product of FIG. 9;

FIG. 14 illustrates an ²⁷Al NMR spectrum of the product of FIG. 10;

FIG. 15 illustrates an XRD pattern of the example of the product illustrated in FIG. 11 after firing at 1600° C. for 2 hours;

FIG. 16 illustrates an XRD pattern of a product of an example of a geopolymer composition including 2 guanidine·Al₂O₃·4SiO₂·13H₂O, prepared by mixing guanidine silicate solution and commercial metakaolin powder, after firing at 1600° C. for 2 hours, prepared in accordance with the principles of the present disclosure;

FIG. 17 illustrates an XRD pattern of the example of the product illustrated in FIG. 9 after firing at 1600° C. for 2 hours;

FIG. 18 illustrates an XRD pattern of a product of an example of a geopolymer composition including an example of 2 guanidine·3Al₂O₃·2SiO₂·13H₂O, prepared by mixing guanidine silicate solution and 3 moles of Al₂O₃ synthetic powder, after firing at 1600° C. for 2 hours, prepared in accordance with the principles of the present disclosure;

FIG. 19 illustrates a plot of the particle size distributions of examples of 2 MgO·Al₂O₃·SiO₂, Y₂O₃, and ZnO synthetic powders, prepared in accordance with the principles of the present disclosure;

FIG. 20 illustrates a plot of powder XRD patterns of examples of 2 MgO·Al₂O₃·SiO₂, Y₂O₃, and ZnO synthetic powders, prepared in accordance with the principles of the present disclosure;

FIG. 21 illustrates a ²⁷Al NMR spectrum of an example of 2 MgO·Al₂O₃·SiO₂ synthetic powder, prepared in accordance with the principles of the present disclosure;

FIG. 22 illustrates a plot of powder XRD patterns of the examples of set geopolymer compositions listed in Table 7, prepared in accordance with the principles of the present disclosure;

FIG. 23 illustrates a ²⁷Al spectrum for an example of gdnGP+2 MgO·Al₂O₃·SiO₂ (left side), and ²⁹NMR spectra for examples of each of gdnGP+2 MgO·Al₂O₃·SiO₂, gdnWG+Y₂O₃, and gdnWG+4 ZnO (right side), prepared in accordance with the principles of the present disclosure;

FIG. 24(A) illustrates an electron micrograph of an example of GP+2 MgO·Al₂O₃·SiO₂, prepared in accordance with the principles of the present disclosure;

FIG. 24(B) illustrates a magnified view of the electron micrograph of the example illustrated in FIG. 24(A) at fifty (50) times the magnification of FIG. 24(A);

FIG. 24(C) illustrates an electron micrograph of an example of GP+Y₂O₃ prepared in accordance with the principles of the present disclosure;

FIG. 24(D) illustrates a magnified view of the electron micrograph of the example illustrated in FIG. 24(C) at fifty (50) times the magnification of FIG. 24(C);

FIG. 25(A) illustrates an electron micrograph of an example of WG+Y₂O₃, prepared in accordance with the principles of the present disclosure;

FIG. 25(B) illustrates a magnified view of the electron micrograph of the example illustrated in FIG. 25(A) at fifty (50) times the magnification of FIG. 25(A);

FIG. 25(C) illustrates an electron micrograph of an example of WG+ZnO, prepared in accordance with the principles of the present disclosure;

FIG. 25(D) illustrates a magnified view of the electron micrograph of the example illustrated in FIG. 25(C) at ten (10) times the magnification of FIG. 25(C);

FIG. 26 illustrates powder XRD patterns of examples of samples in Table 5 at the temperatures indicated in Table 5, the samples prepared in accordance with the principles of the present disclosure;

FIG. 27(A) illustrates an electron micrograph of the fracture surfaces of an example of fired GP+2 MgO·Al₂O₃·SiO₂, prepared in accordance with the principles of the present disclosure;

FIG. 27(B) illustrates a magnified view of the electron micrograph of the example illustrated in FIG. 27(A) at ten (10) times the magnification of FIG. 27(A);

FIG. 27(C) illustrates an electron micrograph of the fracture surfaces of an example of fired GP+Y₂O₃, prepared in accordance with the principles of the present disclosure;

FIG. 27(D) illustrates a magnified view of the electron micrograph of the example illustrated in FIG. 27(C) at twenty-five (25) times the magnification of FIG. 27(C);

FIG. 28 illustrates a magnified view of the electron micrograph illustrated in FIG. 27(D);

FIG. 29(A) illustrates an electron micrograph of the fracture surfaces of an example of fired WG+Y₂O₃, prepared in accordance with the principles of the present disclosure;

FIG. 29(B) illustrates a magnified view of the electron micrograph of the example illustrated in FIG. 29(A) at about 16-17 times the magnification of FIG. 29(A);

FIG. 29(C) illustrates an electron micrograph of the fracture surfaces of an example of fired WG+ZnO, prepared in accordance with the princpiles of the present disclosure; and

FIG. 29(D) illustrates a magnified view of the electron micrograph of the example illustrated in FIG. 29(C) at about 16-17 times the magnification of FIG. 29(C).

The drawings described herein are for illustration purposes only and are not intended to limit the scope of the present disclosure in any way.

### DETAILED DESCRIPTION

The following description is merely exemplary in nature and is not intended to limit the present disclosure, application, or uses.

The uses of the terms “a” and “an” and “the” and similar referents in the context of describing the present disclosure (especially in the context of the following claims) are to be construed to cover both the singular and the plural, unless otherwise indicated herein or clearly contradicted by context. The use of the term “plurality of” is defined by the Applicant in the broadest sense, superseding any other implied definitions or limitations hereinbefore or hereinafter unless expressly asserted by Applicant to the contrary, to mean a quantity of more than one. All methods described herein may be performed in any suitable order unless otherwise indicated herein by context.

As will be understood by one skilled in the art, for any and all purposes, all ranges recited herein also encompass any and all possible sub-ranges and combinations of sub-ranges thereof, as well as the individual values making up the range, particularly integer values. It is therefore understood that each unit between two particular units is also disclosed. For example, if “10 to 15” is disclosed, then 11, 12, 13, and 14 are also disclosed, individually, and as part of a range. A recited range (for example, weight percentages or carbon groups) includes each specific value, integer, decimal, or identity within the range. Any listed range may be easily recognized as sufficiently describing and enabling the same range being broken down into at least equal halves, thirds, quarters, fifths, or tenths. As will also be understood by one skilled in the art, all language such as “up to,” “at least,” “greater than,” “less than,” “more than,” “or more,” and the like, include the number recited and such terms refer to ranges that may be subsequently broken down into sub-ranges. In the same manner, all ratios recited herein also include all sub-ratios falling within the broader ratio. Accordingly, specific values recited for radicals, substituents, and ranges are for illustration only; the specific values do not exclude other defined values or other values within defined ranges for radicals and substituents. It will be further understood that the endpoints of each of the ranges are significant both in relation to the other endpoint, and independently of the other endpoint.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or examples whereby any one or more of the recited elements, species, or examples may be excluded from such categories or examples, for example, for use in an explicit negative limitation.

As used herein, the terms “comprise(s),” “include(s),” “having,” “has,” “may,” “contain(s),” and variants thereof, are intended to be open-ended transitional phrases, terms, or words that do not preclude the possibility of additional acts or structures. The present description also contemplates other examples “comprising,” “consisting of,” and “consisting essentially of,” the examples or elements presented herein, whether explicitly set forth or not.

In describing elements of the present disclosure, the terms “1^{st},” “2^{nd},” “first,” “second,” “A,” “B,” “(a),” “(b),” and the like may be used herein. These terms are only used to distinguish one element from another element, but do not limit the corresponding elements irrespective of the nature or order of the corresponding elements.

Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art.

As used herein, the term “about,” when used in the context of a numerical value or range set forth means a variation of ±15%, or less, of the numerical value. For example, a value differing by ±15%, ±14%, ±10%, or ±5%, among others, would satisfy the definition of “about,” unless more narrowly defined in particular instances.

The term “alkyl,” by itself or as part of another substituent, refers, unless otherwise stated, to a straight, branched, or cyclic chain aliphatic hydrocarbon (“cycloalkyl”) monovalent radical having the number of carbon atoms designated (in other words, “C₁-C₂₀” means one to twenty carbons, and includes C₂, C₃, C₄, C₅, C₆, C₇, C₈, C₉, C₁₀, C₁₁, C₁₂, C₁₃, C₁₄, C₁₅, C₁₆, C₁₇, C₁₈, and C₁₉). Examples include methyl, ethyl, propyl, isopropyl, cyclopropyl, butyl, isobutyl, sec-butyl, tert-butyl, cyclobutyl, methylcyclopropyl, cyclopropylmethyl, pentyl, neopentyl, hexyl, and cyclohexyl. In a particular example, the term “C₁-C₂₀” may not include C₁, and/or may not include C₂, and/or may not include C₃, and/or may not include C₄, and/or may not include C₅, and/or may not include C₆, and/or may not include C₇, and/or may not include C₈, and/or may not include C₉, and/or may not include C₁₀, and/or may not include C₁₁, and/or may not include C₁₂, and/or may not include C₁₃, and/or may not include C₁₄, and/or may not include C₁₅, and/or may not include C₁₆, and/or may not include C₁₇, and/or may not include C₁₅, and/or may not include C₁₉, and/or may not include C₂₀.

The term “alkylene,” by itself or as part of another substituent, refers, unless otherwise stated, to a straight, branched, or cyclic chain bivalent saturated aliphatic radical having the number of carbon atoms designated (in other words, “C₁-C₂₀” means one to twenty carbon atoms) such as methylene (“C₁alkylene,” or “—CH₂—”) or that may be derived from an alkene by opening of a double bond or from an alkane by removal of two hydrogen atoms from different carbon atoms. Examples include methylene, methylmethylene, ethylene, propylene, ethylmethylene, dimethylmethylene, methylethylene, butylene, cyclopropylmethylene, dimethylethylene, and propylmethylene.

The term “alkenyl,” by itself or as part of another substituent, refers, unless otherwise stated, to a stable mono-unsaturated or di-unsaturated or poly-unsaturated straight chain, branched chain, or cyclic hydrocarbon group, with a carbon-carbon double bond (—CH═CH—), and having the stated number of carbon atoms (in other words, “C₂-C₂₀” means two to twenty carbons). Examples include vinyl, propenyl, allyl, crotyl, isopentenyl, butadienyl, 1,3-pentadienyl, 1,4-pentadienyl, cyclopentenyl, cyclopentadienyl, and the higher homologs and isomers. Functional groups representing an alkene are exemplified by —CH═CH—CH₂— and CH₂═CH—CH₂—.

The term “alkenylene,” by itself or as part of another substituent, refers, unless otherwise stated, to a straight, branched, or cyclic chain bivalent unsaturated aliphatic radical containing a double bond having the number of carbon atoms designated (in other words, “C₂-C₂₀” means two to twenty carbon atoms) and that may be derived from an alkyne by opening of a triple bond or from an alkene by removal of two hydrogen atoms from different carbon atoms.

The term “alkynyl,” by itself or as part of another substituent, refers, unless otherwise stated, to a stable carbon-carbon triple bond-containing radical (—C≡C—), branched chain, or cyclic hydrocarbon group having the stated number of carbon atoms (in other words, “C₂-C₂₀” means two to twenty carbons). Examples include ethynyl and propargyl.

The term “alkynylene,” by itself or as part of another substituent, refers, unless otherwise stated, to a straight, branched, or cyclic chain bivalent unsaturated aliphatic radical containing a triple bond having the number of carbon atoms designated (in other words, “C₂-C₂₀” means two to twenty carbon atoms) and that may be derived from an alkyne by removal of two hydrogen atoms from different carbon atoms.

As used herein, the term “hydroxy,” refers, unless otherwise stated, to —OH, attached to a carbon by the oxygen of the hydroxy.

As used herein, the term “alkoxy,” by itself or as part of another substituent, refers, unless otherwise stated, to an alkyl group having the designated number of carbon atoms, as defined above, connected to the rest of the molecule via an oxygen atom, such as, for example, methoxy, ethoxy, 1-propoxy, 2-propoxy (“isopropoxy”), and the higher homologs and isomers.

As used herein, the term “alkenyloxy,” by itself or as part of another substituent, refers, unless stated otherwise, to an alkenyl group having the designated number of carbon atoms, as defined above, connected to the rest of the molecule via an oxygen atom.

As used herein, the term “alkynyloxy,” by itself or as part of another substituent, refers, unless stated otherwise, to an alkynyl group having the designated number of carbon atoms, as defined above, connected to the rest of the molecule via an oxygen atom.

The term “aromatic” generally refers to a carbocycle or heterocycle having one or more polyunsaturated rings having aromatic character (in other words, having (4n+2) delocalized π (pi) electrons where n is an integer).

The term “aryl,” by itself or in combination with another substituent, refers, unless otherwise stated, to a carbocyclic aromatic system substituent containing one or more rings (typically one, two, or three rings), wherein such rings may be attached together in a pendant manner, such as biphenyl, or may be fused, such as naphthalene. Examples may include phenyl, benzyl, anthracyl, and naphthyl. Preferred are phenyl, benzyl, and naphthyl; most preferred are phenyl and benzyl.

As used herein, the term “aryloxy,” by itself or in combination with another substituent, refers, unless otherwise stated, to an aryl group connected to the rest of the molecule via an oxygen atom.

The term “arylene,” by itself or in combination with another substituent, refers, unless otherwise stated, to a bivalent radical produced by removal of two hydrogen atoms from two different carbon atoms of an aryl group.

The terms “heterocyclic,” “heterocycle,” and “heterocyclyl,” by themselves or in combination with another substituent, refer, unless otherwise stated, to a stable, mono- or multi-cyclic ring system that consists of carbon atoms and at least one heteroatom independently selected from N, O, and S, and wherein the nitrogen and sulfur heteroatoms may be optionally oxidized, and the nitrogen atom may be optionally quaternized. The heterocyclic system may be attached, unless otherwise stated, at any hetero-atom or carbon atom that affords a stable structure. Non-limiting examples of monocyclic heterocyclic groups include: aziridine, oxirane, thiirane, azetidine, oxetane, thietane, pyrrolidine, pyrroline, imidazoline, pyrazolidine, dioxolane, sulfolane, 2,3-dihydrofuran, 2,5-dihydrofuran, tetrahydrofuran, thiophane, piperidine, 1,2,3,6-tetrahydropyridine, piperazine, N-methylpiperazine, morpholine, thiomorpholine, pyran, 2,3-dihydropyran, tetrahydropyran, 1,4-dioxane, 1,3-dioxane, homopiperazine, homopiperidine, 1,3-dioxepane, 4,7-dihydro-1,3-dioxepin, and hexamethyleneoxidine.

As used herein, the term “heterocyclyloxy,” by itself or in combination with another substituent, refers, unless otherwise stated, to a heterocyclyl group connected to the rest of the molecule via an oxygen atom.

The term “heterocyclylene,” by itself or in combination with another substituent, refers, unless otherwise stated, to a bivalent radical produced by removal of two hydrogen atoms from two different carbon atoms of a heterocyclyl group.

The terms “heteroaryl” and “heteroaromatic,” by themselves or in combination with another substituent, refer, unless otherwise stated, to a heterocyclic having aromatic character.

Non-limiting examples of monocyclic heteroaryl groups include: pyridyl; pyrazinyl; pyrimidinyl, particularly 2- and 4-pyrimidinyl; pyridazinyl; thienyl; furyl; pyrrolyl, particularly 2-pyrrolyl; imidazolyl; thiazolyl; oxazolyl; pyrazolyl, particularly 3- and 5-pyrazolyl; isothiazolyl; 1,2,3-triazolyl; 1,2,4-triazolyl; 1,3,4-triazolyl; tetrazolyl; 1,2,3-thiadiazolyl; 1,2,3-oxadiazolyl; 1,3,4-thiadiazolyl; and 1,3,4-oxadiazolyl.

Polycyclic heterocycles include both aromatic and non-aromatic polycyclic heterocycles, non-limiting examples of which include: indolyl, particularly 3-, 4-, 5-, 6-, and 7-indolyl; indolinyl; indazolyl, particularly 1H-indazol-5-yl; quinolyl; tetrahydroquinolyl; isoquinolyl, particularly 1- and 5-isoquinolyl; 1,2,3,4-tetrahydroisoquinolyl; cinnolyl; quinoxalinyl, particularly 2- and 5-quinoxalinyl; quinazolinyl; phthalazinyl; naphthyridinyl, particularly 1,5- and 1,8-naphthyridinyl; 1,4-benzodioxanyl; coumaryl; dihydrocoumaryl; benzofuryl, particularly 3-, 4-, 5-, 6-, and 7-benzofuryl; 2,3-dihydrobenzofuryl; 1,2-benzoisoxazoyl; benzothienyl, particularly 3-, 4-, 5-, 6- and 7-benzothienyl; benzoxazolyl; benzothiazolyl, particularly 2- and 5-benzothiazolyl; purinyl; benzimidazolyl, particularly 2-benzimidazolyl; benztriazolyl; thioxanthinyl; carbazolyl; carbolinyl; acridinyl; pyrrolizidinyl; pyrrolo[2,3-b]pyridinyl, particularly 1H-pyrrolo[2,3-b]pyridin-5-yl; and quinolizidinyl. Particularly preferred are 4-indolyl, 5-indolyl, 6-indolyl, 1H-indazol-5-yl, and 1H-pyrrolo[2,3-b]pyridin-5-yl.

The term “heteroaryloxy,” by itself or in combination with another substituent, refers, unless otherwise stated, to a heteroaryl group connected to the rest of the molecule via an oxygen atom.

The term “heteroarylene,” by itself or in combination with another substituent, refers, unless otherwise stated, to a bivalent radical produced by removal of two hydrogen atoms from two different carbon atoms of a heteroaryl group.

The term “aryl(C₁-C₄)alkyl” refers to a functional group wherein a one to four carbon alkylene chain is attached to an aryl group, for example, —CH₂—CH₂-phenyl. Examples may include benzyl. The term “heteroaryl(C₁-C₄)alkyl” refers to a functional group wherein a one to four carbon alkylene chain is attached to a heteroaryl group, for example, —CH₂—CH₂-pyridyl. The term “heterocyclyl(C₁-C₄)alkyl” refers to a functional group wherein a one to four carbon alkylene chain is attached to a heterocyclyl group, for example, —CH₂—CH₂-aziridine. The terms “aryl(C₁-C₄)alkylene” and “(C₁-C₄)alkylarylene” refer to a bivalent radical produced by removal of two hydrogen atoms from two different carbon atoms of an aryl(C₁-C₄)alkyl group, preferably wherein one of the two different carbon atoms is in the (C₁-C₄)alkyl group and the other of the two different carbon atoms is in the aryl group. The term “(C₁-C₄)alkylaryl(C₁-C₄)alkylene” refers to a bivalent radical produced by removal of two hydrogen atoms from two different carbon atoms of a (C₁-C₄)alkylaryl(C₁-C₄)alkyl group, wherein one of the two different carbon atoms is in one of the (C₁-C₄)alkyl groups and the other of the two different carbon atoms is in the other of the (C₁-C₄)alkyl groups, for example, —CH₂-phenyl-CH₂—. The terms “heteroaryl(C₁-C₄)alkylene” or “(C₁-C₄)alkylheteroarylene” refer to a bivalent radical produced by removal of two hydrogen atoms form two different carbon atoms of a heteroaryl(C₁-C₄)alkyl group, preferably wherein one of the two different carbon atoms is in the (C₁-C₄)alkyl group and the other of the two different carbon atoms is in the heteroaryl group. The term “(C₁-C₄)alkylheteroaryl(C₁-C₄)alkylene” refers to a bivalent radical produced by removal of two hydrogen atoms from two different carbon atoms of a (C₁-C₄)alkylheteroaryl(C₁-C₄)alkyl group, wherein one of the two different carbon atoms is in one of the (C₁-C₄)alkyl groups and the other of the two different carbon atoms is in the other of the two (C₁-C₄)alkyl groups, for example, —CH₂-pyridinyl-CH₂—. The terms “heterocyclyl(C₁-C₄)alkylene” or “(C₁-C₄)alkylheterocyclylene” refer to a bivalent radical produced by removal of two hydrogen atoms from two different carbon atoms of a heterocyclyl(C₁-C₄)alkyl group, preferably wherein one of the two different carbon atoms is in the (C₁-C₄)alkyl group and the other of the two different carbon atoms is in the heterocyclyl group. The term “(C₁-C₄)alkylheterocyclyl(C₁-C₄)alkylene” refers to a bivalent radical produced by removal of two hydrogen atoms from two different carbon atoms of a (C₁-C₄)alkylheterocyclyl(C₁-C₄)alkyl group, wherein one of the two different carbons is in one of the (C₁-C₄)alkyl groups and the other of the two different carbon atoms is in the other of the (C₁-C₄)alkyl groups, for example, —CH₂— aziridinyl-CH₂—.

Any alkyl, alkoxy, alkylene, alkenyl, alkenyloxy, alkenylene, alkynyl, alkynyloxy, alkynylene, aryl, aryloxy, arylene, heterocyclyl, heterocyclyloxy, heterocyclylene, heteroaryl, heteroaryloxy, heteroarylene, aryl(C₁-C₄)alkyl, heteroaryl(C₁-C₄)alkyl, heterocyclyl(C₁-C₄)alkyl, (C₁-C₄)alkylaryl(C₁-C₄)alkyl, (C₁-C₄)alkylheteroaryl(C₁-C₄)alkyl, (C₁-C₄)alkylheterocyclyl(C₁-C₄)alkyl, aryl(C₁-C₄)alkylene, (C₁-C₄)alkylaryl(C₁-C₄)alkylene, heteroaryl(C₁-C₄)alkylene, (C₁-C₄)alkylheteroaryl(C₁-C₄)alkylene, heterocyclyl(C₁-C₄)alkylene, or (C₁-C₄)alkylheterocyclyl(C₁-C₄)alkylene may be optionally substituted with an alkoxy, hydroxy, amino, or N-substituted amino. As used herein, the term “amino” refers to a —NH₂ group. As used herein, the term “N-substituted amino” refers to an —NHR or —NR₂ group, in which each R is independently (C₁-C₂₀)alkyl, or when the N-substituted amino is —NR₂, the two R groups taken together with nitrogen to which the two R groups are bonded form a heterocyclic ring.

As used herein, the term “organic base” refers to an organic chemical species that may act as a base. Examples of organic bases are proton acceptors bearing a lone pair of electrons that is localized on an atom, the atom typically being nitrogen. Examples of classes of organic bases may include amidines, guanidines, vinamidines, tetra-substituted ammonium species, amines, phosphazenes, and tetra-substituted phosphonium species. As used herein, the term “conjugate acid” refers to an organic base that has accepted a hydrogen ion (H⁺) (in other words, a “protonated organic base”).

As used herein, the term “salt” refers to a neutral ionic chemical species including a charge-balanced combination of cations and anions. Examples of anions may include fluoride, chloride, bromide, iodide, carbonate, hydrogen carbonate, hydroxide, hydrogen sulfate, nitrate, sulfate, acetate, formate, methanesulfonate, and trifluoromethylsulfonate.

Examples of geopolymers may include repeating amorphous chemical networks including: repeating Si—O—Al—O— bond units, wherein the Si atoms are the central atoms of SiO₄ tetrahedra and the Al atoms are the central atoms of AlO₄⁻ tetrahedra; and, conventionally, one or more Group I element cations.

As used herein, the term “rare earth elements” refer to elements including lanthanum, yttrium, scandium, cerium, dysprosium, neodymium, terbium, praseodymium, samarium, ytterbium, europium, lutetium, gadolinium, holmium, promethium, thulium, and erbium.

Herein is described geopolymer compositions including organic bases or hydroxides of protonated organic bases rather than alkali hydroxides, which may yield alkali-free ceramics, such as aluminosilicate ceramics, mullite ceramics, and mixed mullite/silica body ceramics, without requiring ion exchange. Because ion exchange is not required to prepare alkali-free ceramics from the geopolymer compositions described herein, the conventional practical limits on ceramic body size due to the limitations of ion exchange do not apply to the geopolymer compositions or ceramics disclosed herein. Because the geopolymer compositions described herein include organic bases, the cast geopolymer composition may simply be dried and heated to convert the geopolymer into a ceramic, because the organic base may advantageously decompose upon heating. The geopolymer compositions also set in place by chemical reaction rather than: by “inorganic gel-casting,” in which silica bodies are formed by inorganic gel casting set by drying out, which may be accompanied by significant shrinkage; or by reaction of calcium with dissolved silica to make calcium silicate hydrate that acts as a cementitious binder for other particles.

The geopolymer compositions described herein may be used to prepare ceramic-matrix composites, which may be used, for example, for structural applications. Various fiber and particulate reinforcements may be added to the geopolymer compositions described herein, and after hardening, an entire body may be fired to convert the geopolymer composition into a ceramic. Alternatively, the geopolymer composition may be poured over a fabric and fired after the geopolymer composition hardens. The geopolymer composition may also be used to prepare protective coatings, for example by applying the geopolymer composition on to a surface, and heating the surface with the geopolymer composition so as to crystallize the geopolymer composition, or heating the geopolymer composition alone to crystallize the geopolymer composition. Because initially the geopolymer composition is a viscous fluid, the geopolymer composition may also be three-dimensionally printed, and the three-dimensionally printed body may be later fired to produce a ceramic; alternatively, the geopolymer composition may undergo sequential three-dimensional printing and laser firing. The geopolymer compositions described herein may also be extruded to form extrudates or injection molded, which may be subsequently heated to prepare ceramics from the extrudates or injection molded forms.

The geopolymer compositions described herein may also serve as a base for compositions that yield other non-alkali aluminosilicate ceramics including other or additional metal cations. The geopolymer compositions may be adjusted by adding small particles that react with the geopolymer composition only during the firing process, such as zinc oxide or yttrium aluminum garnet (“YAG”). The other ceramics may have structural, protective, or functional applications and may generally be of interest in the aerospace industry as alternatives to various metal alloys to increase operating temperatures and reduce weight.

The geopolymer compositions described herein may be applied to a metal or adhering ceramic or polymeric surface. The geopolymer compositions described herein may be iteratively deposited by three-dimensional printing and then laser-fired. Three-dimensional printing may be used to coat an inner surface of a large container with a chemically resistant mullite layer. Large containers may be shaped as, for example, cylinders that may be 10 meters in diameter and 20 meters in height. After applying and firing the geopolymer composition coat on the inner surface of the large container, the geopolymer coating may be fired such as by heating with a laser or an oxyacetylene torch, and converted to a ceramic layer, such as crystalline mullite (3Al₂O₃·2SiO₂) for example. The container may subsequently be filled with a fluid such as a molten salt mixture, (such as a eutectic NaCl—KCl mixture which melts at ˜650° C.). The fluid may then be used for thermal energy storage in conjunction with concentrated solar power, for example by storing heat that could be used for energy generation, such as making electricity from the stored heat to boil water or power an electric generator, rather than generating heat by, for example, by burning coal.

In an example, a geopolymer composition may include an organic compound of formula (I), or a salt of a conjugate acid of a compound of formula (I):

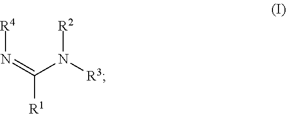

wherein each of R¹, R², R³, and R⁴ may be independently selected from hydrogen, and from (C₁-C₂₀)alkyl, (C₂-C₂₀)alkoxy, (C₂-C₂₀)alkenyl, (C₂-C₂₀)alkenyloxy, (C₂-C₂₀)alkynyl, (C₂-C₂₀)alkynyloxy, aryl, aryloxy, heteroaryl, heteroaryloxy, heterocyclyl, heterocyclyloxy, aryl(C₁-C₄)alkyl, (C₁-C₄)alkylaryl(C₁-C₄)alkyl, heteroaryl(C₁-C₄)alkyl, (C₁-C₄)alkylheteroaryl(C₁-C₄)alkyl, heterocyclyl(C₁-C₄)alkyl, and (C₁-C₄)alkylheterocyclyl(C₁-C₄)alkyl, each of which may be optionally substituted with alkoxy, hydroxy, amino, or N-substituted amino; or any two of R¹, R², R³, and R⁴, taken together with the carbon and/or nitrogen to which the two of R¹, R², R³, and R⁴ are respectively bonded, form a heterocyclic or heteroaryl ring which may be optionally substituted with alkoxy, hydroxy, amino, or N-substituted amino; provided that R¹, R², R³, and R⁴ are not all simultaneously hydrogen.

In certain examples, the compound of formula (I) may include formamidine, acetamidine, and 1,8-diazabicyclo[5.4.0]undec-7-ene (“DBU”), which have the following structural formulae:

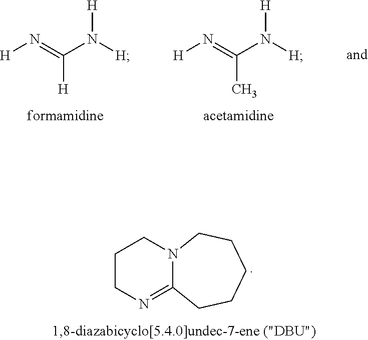

In an example, a geopolymer composition may include a compound of formula (II), or a salt of a conjugate acid of a compound of formula (II):

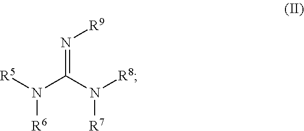

wherein each of R⁵, R⁶, R⁷, R⁸, and R⁹ may be independently selected from hydrogen, and from (C₁-C₂₀)alkyl, (C₁-C₂₀)alkoxy, (C₂-C₂₀)alkenyl, (C₂-C₂₀)alkenyloxy, (C₂-C₂₀)alkynyl, (C₂-C₂₀)alkynyloxy, aryl, aryloxy, heteroaryl, heteroaryloxy, heterocyclyl, heterocyclyloxy, aryl(C₁-C₄)alkyl, (C₁-C₄)alkylaryl(C₁-C₄)alkyl, heteroaryl(C₁-C₄)alkyl, (C₁-C₄)alkylheteroaryl(C₁-C₄)alkyl, heterocyclyl(C₁-C₄)alkyl, and (C₁-C₄)alkylheterocyclyl(C₁-C₄)alkyl, each of which may be optionally substituted with alkoxy, hydroxy, amino, or N-substituted amino; or any two of R⁵, R⁶, R⁷, R⁸, and R⁹, taken together with nitrogen to which the two of R⁵, R⁶, R⁷, R⁸, and R⁹ are bonded and optionally carbon, may form a heterocyclic or heteroaryl ring which may be optionally substituted with alkoxy, hydroxy, amino, or N-substituted amino.

In certain examples, the compound of formula (II) may include tetramethylguanidine or guanidinium hydroxide, which have the following structural formulae:

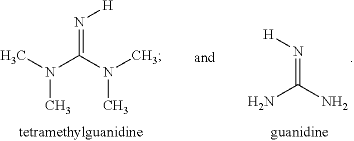

In an example, a geopolymer composition may include a compound of formula (III) or a salt thereof:

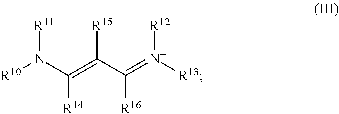

wherein each of R¹⁰, R^{1D}, R¹², R¹³, R¹⁴, R¹⁵, and R¹⁶ may be independently selected from hydrogen, and (C₁-C₂₀)alkyl, (C₁-C₂₀)alkoxy, (C₂-C₂₀)alkenyl, (C₂-C₂₀)alkenyloxy, (C₂-C₂₀)alkynyl, (C₂-C₂₀)alkynyloxy, aryl, aryloxy, heteroaryl, heteroaryloxy, heterocyclyl, heteroaryloxy, aryl(C₁-C₄)alkyl, (C₁-C₄)alkylaryl(C₁-C₄)alkyl, heteroaryl(C₁-C₄)alkyl, (C₁-C₄)alkylheteroaryl(C₁-C₄)alkyl, heterocyclyl(C₁-C₄)alkyl, and (C₁-C₄)alkylheterocyclyl(C₁-C₄)alkyl, each of which may be optionally substituted with alkoxy, hydroxy, amino, or N-substituted amino; wherein R¹⁵, and one of R¹¹ or R¹², taken together with the carbons and nitrogen between R¹⁵ and the one of R¹¹ or R¹², may form a heterocyclic or heteroaryl ring; wherein R¹⁰ and R¹¹ and/or R¹² and R¹³, taken together with nitrogen, may form a heterocyclic or heteroaryl ring; wherein R¹⁴, and one of R¹⁰ or R¹¹, and/or R¹⁶, and one of R¹² or R¹³, taken together with carbon and nitrogen, may form a heterocyclic ring; wherein R¹⁴ and R¹⁶, taken together with the carbons between R¹⁴ and R¹⁶, may form a carbocyclic or heterocyclic ring; provided that R¹⁰ and R¹¹ are not simultaneously hydrogen; and provided that R¹² and R¹³ are not simultaneously hydrogen.

In an example, a geopolymer composition may include a compound of formula (IV) or a salt thereof:

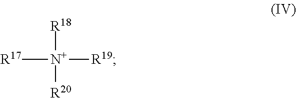

wherein each of R¹⁷, R¹⁸, R¹⁹, and R²⁰ may be independently selected from (C₁-C₂₀)alkyl, (C₁-C₂₀)alkoxy, (C₂-C₂₀)alkenyl, (C₂-C₂₀)alkenyloxy, (C₂-C₂₀)alkynyl, (C₂-C₂₀)alkynyloxy, aryl, aryloxy, heteroaryl, heteroaryloxy, heterocyclyl, heterocyclyloxy, aryl(C₁-C₄)alkyl, (C₁-C₄)alkylaryl(C₁-C₄)alkyl, heteroaryl(C₁-C₄)alkyl, (C₁-C₄)alkylheteroaryl(C₁-C₄)alkyl, heterocyclyl(C₁-C₄)alkyl, and (C₁-C₄)alkylheterocyclyl(C₁-C₄)alkyl, each of which may be optionally substituted with alkoxy, hydroxy, amino, or N-substituted amino; wherein any two of R¹⁷, R¹⁸, R¹⁹, and R²⁰, taken together with nitrogen, may form a heterocyclic or heteroaryl ring.

In an example, a geopolymer composition may include a compound of formula (V) or a salt of a conjugate acid of a compound of formula (V):

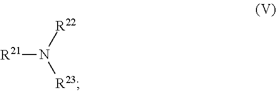

wherein each of R²¹, R²², and R²³ may be independently selected from (C₁-C₂₀)alkyl, (C₁-C₂₀)alkoxy, (C₂-C₂₀)alkenyl, (C₂-C₂₀)alkenyloxy, (C₂-C₂₀)alkynyl, (C₂-C₂₀)alkynyloxy, aryl, aryloxy, heteroaryl, heteroaryloxy, heterocyclyl, heteroaryloxy, aryl(C₁-C₄)alkyl, (C₁-C₄)alkylaryl(C₁-C₄)alkyl, heteroaryl(C₁-C₄)alkyl, (C₁-C₄)alkylheteroaryl(C₁-C₄)alkyl, heterocyclyl(C₁-C₄)alkyl, and (C₁-C₄)alkylheterocyclyl(C₁-C₄)alkyl, each of which may be optionally substituted with alkoxy, hydroxy, amino, or N-substituted amino; wherein any two of R²¹, R²², and R²³, taken together with nitrogen, may form a heterocyclic or heteroaryl ring. Examples of compounds of formula (V) may include 1,8-bis(dimethylamino)naphthalene (“Proton Sponge®”), which has the following structural formula:

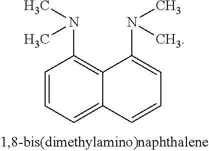 [SMILES: CN(C)c1cccc2cccc(N(C)C)c12]

In an example, a geopolymer composition may include a compound of formula (VI) or a salt of a compound of formula (VI):

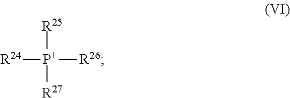

wherein each of R²⁴, R²⁵, R²⁶, and R²⁷ may be independently selected from (C₁-C₂₀)alkyl, (C₁-C₂₀)alkoxy, (C₂-C₂₀)alkenyl, (C₂-C₂₀)alkenyloxy, (C₂-C₂₀)alkynyl, (C₂-C₂₀)alkynyloxy, aryl, aryloxy, heteroaryl, heteroaryloxy, heterocyclyl, heterocyclyloxy, aryl(C₁-C₄)alkyl, (C₁-C₄)alkylaryl(C₁-C₄)alkyl, heteroaryl(C₁-C₄)alkyl, (C₁-C₄)alkylheteroaryl(C₁-C₄)alkyl, heterocyclyl(C₁-C₄)alkyl, and (C₁-C₄)alkylheterocyclyl(C₁-C₄)alkyl, any of which may be substituted with alkoxy, hydroxy, amino, or N-substituted amino; wherein any two of R²⁴, R²⁵, R²⁶, and R²⁷, taken together with phosphorus, may form a heterocyclic ring. Examples of compounds of formula (VI) may include diphenyldimethylphosphonium, which has the following structural formula:

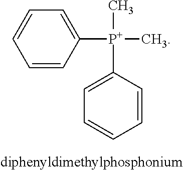

In an example, a geopolymer composition may include a compound of formula (VII) or a salt of a conjugate acid of a compound of formula (VII):

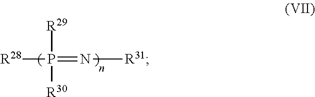

wherein each of R²⁸, R²⁹, and R³⁰ is N(R³²)₂ or N═P(N(R³³)₂)₃; wherein R³¹, each R³², and each R³³ is independently hydrogen, (C₁-C₂₀)alkyl, (C₁-C₂₀)alkoxy, (C₂-C₂₀)alkenyl, (C₂-C₂₀)alkenyloxy, (C₂-C₂₀)alkynyl, (C₂-C₂₀)alkynyloxy, aryl, aryloxy, heteroaryl, heteroaryloxy, heterocyclyl, heterocyclyloxy, aryl(C₁-C₄)alkyl, (C₁-C₄)alkylaryl(C₁-C₄)alkyl, heteroaryl(C₁-C₄)alkyl, (C₁-C₄)alkylheteroaryl(C₁-C₄)alkyl, heterocyclyl(C₁-C₄)alkyl, and (C₁-C₄)alkylheterocyclyl(C₁-C₄)alkyl; any of which may be substituted with alkoxy, hydroxy, amino, or N-substituted amino, wherein any two of R²⁸, R²⁹, and R³⁰ or any two R³² or any two R³³, taken together with nitrogen, may form a heterocyclic ring. Examples of compounds of formula (VII) may include P3 phosphazene, t-Bu-P₄, and BEMP, which have the following structural formulae:

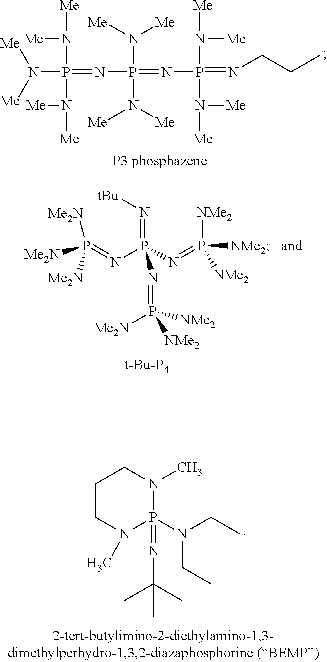

In an example, a geopolymer composition may include any combination of compounds of formulae (I), (II), (III), (IV), (V), (VI), and/or (VII), and/or additionally or alternatively, any combination of protonated compounds of formulae (I), (II), (III), (IV), (V), (VI), and/or (VII), and/or additionally or alternatively, any combination of hydroxides of protonated compounds of formulae (I), (II), (III), (IV), (V), (VI), and/or (VII). In certain examples, a geopolymer composition may include an organic base in an amount of v moles, which may be 0.1 moles, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, or 4.0 moles. In certain examples, a geopolymer composition may include a solution of organic base in water as represented by the formula v base·z H₂O, such as about 1 base·25H₂O or 2 base·25H₂O.

In an example, a geopolymer composition may include a base/silica solution in water having a formula of v base·ySiO₂·zH₂O. In certain examples, the base/silica solution may be about 1 base·0.9SiO₂·7.7 H₂O, about 2 base·2SiO₂·13H₂O or about 2 base·2SiO₂·25H₂O.

In an example, a geopolymer composition may include aluminum oxide (Al₂O₃). In another example, a geopolymer composition may include silicon dioxide (SiO₂). In yet another example, a geopolymer composition may include Al₂O₃ and SiO₂. In certain examples, Al₂O₃ and SiO₂ may be included in a geopolymer composition, such as a composition resulting in mullite, in a molar ratio of x to y according to the formula xAl₂O₃·ySiO₂. In certain examples, the aluminum oxide and silicon dioxide may be present in a geopolymer composition in an amount represented by Al₂O₃·4SiO₂, Al₂O₃·3 SiO₂, Al₂O₃·2 SiO₂, or 3Al₂O₃·2 SiO₂.

In yet another example, a geopolymer composition, including, for example, a composition resulting in mullite, may include water. Relative to x moles of Al₂O₃ and y moles of SiO₂, water may be present in an amount of z moles, according to the formula xAl₂O₃·ySiO₂·zH₂O.

In an example, x may have a value relative to y and z, of 0.1 moles, or 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, or 5.0 moles.

In an example, y may have a value relative to x and z, of 0.1 moles, or 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, or 5.0 moles.

In an example, z may have a value relative to x and y, of 5.0 moles, or 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, 10.0, 10.1, 10.2, 10.3, 10.4, 10.5, 10.6, 10.7, 10.8, 10.9, 11.0, 11.1, 11.2, 11.3, 11.4, 11.5, 11.6, 11.7, 11.8, 11.9, 12.0, 12.1, 12.2, 12.3, 12.4, 12.5, 12.6, 12.7, 12.8, 12.9, 13.0, 13.1, 13.2, 13.3, 13.4, 13.5, 13.6, 13.7, 13.8, 13.9, 14.0, 14.1, 14.2, 14.3, 14.4, 14.5, 14.6, 14.7, 14.8, 14.9, 15.0, 15.1, 15.2, 15.3, 15.4, 15.5, 15.6, 15.7, 15.8, 15.9, 16.0, 16.1, 16.2, 16.3, 16.4, 16.5, 16.6, 16.7, 16.8, 16.9, 17.0, 17.1, 17.2, 17.3, 17.4, 17.5, 17.6, 17.7, 17.8, 17.9, 18.0, 18.1, 18.2, 18.3, 18.4, 18.5, 18.6, 18.7, 18.8, 18.9, 19.0, 19.1, 19.2, 19.3, 19.4, 19.5, 19.6, 19.7, 19.8, 19.9, 20.0, 20.1, 20.2, 20.3, 20.4, 20.5, 20.6, 20.7, 20.8, 20.9, 21.0, 21.1, 21.2, 21.3, 21.4, 21.5, 21.6, 21.7, 21.8, 21.9, 22.0, 22.1, 22.2, 22.3, 22.4, 22.5, 22.6, 22.7, 22.8, 22.9, 23.0, 23.1, 23.2, 23.3, 23.4, 23.5, 23.6, 23.7, 23.8, 23.9, 24.0, 24.1, 24.2, 24.3, 24.4, 24.5, 24.6, 24.7, 24.8, 24.9, 25.0, 25.1, 25.2, 25.3, 25.4, 25.5, 25.6, 25.7, 25.8, 25.9, 26.0, 26.1, 26.2, 26.3, 26.4, 26.5, 26.6, 26.7, 26.8, 26.9, 27.0, 27.1, 27.2, 27.3, 27.4, 27.5, 27.6, 27.7, 27.8, 27.9, 28.0, 28.1, 28.2, 28.3, 28.4, 28.5, 28.6, 28.7, 28.8, 28.9, 29.0, 29.1, 29.2, 29.3, 29.4, 29.5, 29.6, 29.7, 29.8, 29.9, or 30.0 moles.

In an example, a molar ratio of Al₂O₃ to SiO₂ is from about 1:5 to about 5:1, including, for example, from about 1:4, or from about 1:3, or from about 1:2, or from about 2:3, or from about 3:4, or from about 1:1, or from about 4:3, or from about 3:2, or from about 2:1, or from about 3:1, or from about 4:1 to about 5:1; or from about 1:5 to about 1:4, or to about 1:3, or to about 1:2, or to about 2:3, or to about 3:4, or to about 1:1, or to about 4:3, or to about 3:2, or to about 2:1, or to about 3:1, or to about 4:1; or any range of ratios formed from any two of the foregoing ratios; including any sub-ranges therebetween.

In an example, a geopolymer composition may solidify so as to hold a particular shape and/or exhibit self-support within up to about 15 minutes, or up to about 30 minutes, or up to about 45 minutes, or up to about 1 hour, or up to about 1.5 hours, or up to about 2 hours, or up to about 3 hours, or up to about 4 hours, or up to about 5 hours, or up to about 6 hours, or up to about 7 hours, or up to about 8 hours, or up to about 9 hours, or up to about 10 hours, or up to about 11 hours, or up to about 12 hours, or up to about 15 hours, or up to about 18 hours, or up to about 21 hours, or up to about 24 hours, or up to about 2 days, or up to about 3 days, or up to about 4 days, or up to about 5 days, or up to about 6 days, or up to about 7 days, or up to about 2 weeks, or up to about 3 weeks, or up to about 4 weeks, or up to about 2 months.

In an example, a geopolymer composition may solidify so as to hold a particular shape and/or exhibit self-support at ambient temperature, or a temperature of about 5° C., or about 10° C., or about 15° C., or about 20° C., or about 25° C., or about 30° C., or about 35° C., or about 40° C., or about 45° C., or about 50° C., or about 55° C., or about 60° C., or about 65° C., or about 70° C., or about 75° C., or about 80° C., or about 85° C., or about 90° C., or about 95° C., or about 100° C.

In an example, the present disclosure provides a method of making a geopolymer composition, including mixing an aluminosilicate with an organic base to provide the geopolymer composition. In certain examples, the method further includes dissolving the organic base in water to provide an aqueous solution of the organic base prior to the mixing. In certain examples, the method further includes dissolving silica in the aqueous solution of the organic base prior to the mixing. In certain examples, the method further includes forming the geopolymer composition into a desired shape to provide a set geopolymer composition. In certain examples, the method further includes curing the set geopolymer composition to provide a cured geopolymer composition.

In an example, the present disclosure provides a method of making an alkali-free ceramic, including: mixing an aqueous solution of an organic base with an aluminosilicate to provide a geopolymer composition; forming the geopolymer composition into a desired shape to provide a set geopolymer composition; curing the set geopolymer composition to provide a cured geopolymer composition; and heating the cured geopolymer composition to provide the alkali-free ceramic. In certain examples, the ceramic is also free of calcium. In certain examples, the method does not include any ion exchange.

In an example, the heating of the cured geopolymer composition may be at a temperature of at least about 300° C., or at least about 350° C., or at least about 400° C., or at least about 450° C., or at least about 500° C., or at least about 550° C., or at least about 600° C., or at least about 650° C., or at least about 700° C., or at least about 750° C., or at least about 800° C., or at least about 850° C., or at least about 900° C., or at least about 950° C., or at least about 1000° C., or at least about 1050° C., or at least about 1100° C., or at least about 1150° C., or at least about 1200° C., or at least about 1250° C., or at least about 1300° C., or at least about 1350° C., or at least about 1400° C., or at least about 1450° C., or at least about 1500° C. In certain examples, the heating may be at more than one temperature for different periods of time.

In an example, the heating of the cured geopolymer composition may be for a set period of time of at least about 1 hour, or at least about 1.5 hours, or at least about 2 hours, or at least about 2.5 hours, or at least about 3 hours, or at least about 3.5 hours, or at least about 4 hours, or at least about 4.5 hours, or at least about 5 hours, or at least about 5.5 hours, or at least about 6 hours, or at least about 6.5 hours, or at least about 7 hours, or at least about 7.5 hours, or at least about 8 hours. In certain examples, the set period of time of heating may be a total period of time that is divided into even or uneven increments of time of heating at different temperatures of at least 900° C.

The compositions and methods described above may be better understood in connection with the following Examples. In addition, the following non-limiting examples are an illustration. The illustrated methods are applicable to other examples of compositions. The procedures described as general methods describe what is believed will be typically effective to prepare the compositions indicated. However, the person skilled in the art will appreciate that it may be necessary to vary the procedures for any given example of the present disclosure, for example, vary the order or steps and/or the chemical reagents used.

### EXAMPLE 1

### I. Introduction

In an example of the geopolymer compositions and example of the methods described herein, mullite, and specifically of formula 3Al₂O₃·2SiO₂, was chosen as an exemplary alkali-free component because 3Al₂O₃·2SiO₂ is a binary compound in a phase diagram at standard temperature and pressure.

### II. Experimental Methods

All samples were synthesized by mixing an amorphous aluminosilicate (xAl₂O₃·ySiO₂) or alumina (Al₂O₃) powder with an aqueous solution of an organic base. Silica (SiO₂) may be dissolved in the solution of the organic base before mixing the organic base with the aluminosilicate or alumina powder. The overall compositions were approximately v base-Al₂O₃·2-4SiO₂·zH₂O, which corresponds approximately to a composition of conventional geopolymer made using alkali hydroxides/silicates, or v base·3Al₂O₃·2SiO₂·zH₂O, which corresponds approximately to the composition of mullite (3Al₂O₃·2SiO₂) after the water and organic base are removed by calcination. Preferably v may be about 2, so to provide only enough organic base cations to charge balance the aluminum, and n may be about 10 to about 25, and generally the lowest value of n possible to fully dissolve the organic base and maintain useful workability.

Organic base solutions were prepared by dissolving the organic base in water at the desired water content. Silicate solutions, when used, were prepared by adding fumed silica (Cab-O-Sil M5, Cabot Corp.) to the organic base solution while stirring on a magnetic stir plate and allowed to stir until dissolved. Dissolution was ascertained by checking that the solution was transparent. Tetramethylguanidine (“TMG”) and guanidinium hydroxide (“gdmOH”) solutions were used within a few days due to the hydrolysis of TMG and gdmOH over time in water, leading to decreased basicity and lower reactivity.

Guanidinium hydroxide is not practically available from chemical suppliers. A solution with a concentration of 0.35 mol sodium hydroxide (NaOH) in 100 g ethanol was prepared by adding powdered NaOH pearls to absolute ethanol. The mixture was covered and stirred for 1 hour to allow the NaOH to fully dissolve. Guanidinium chloride (gdmCl) was added to the NaOH/ethanol solution at a molar ratio of 1 gdmCl: 1 NaOH and allowed to stir for 1 hour. Sodium chloride precipitated from solution and was removed by vacuum filtration at −5 to −10 inches Hg using H635 expanded perlite (Imerys SA) held on Whatman #1 filter paper. The residual solution of ethanol and guanidine was concentrated under vacuum (about −28 inHg). After about 12 hours to 2 days, depending on the batch size, the solution reached a concentration of around 80-90% guanidine as determined by titration to the phenolphthalein endpoint, the remainder being water. This concentrated filtrate was used to make guanidinium hydroxide solutions and guanidinium silicate solutions.

Silicate solutions of guanidine, TMG, and NaOH were prepared by dissolving/mixing the base in deionized water and adding fumed silica (Cab-o-Sil M5, Cabot Corp.) while stirring on a magnetic stir plate. Overall compositions were 2 B·2 SiO₂·n H₂O, where B is NaOH, TMG, or guanidine, and where n is preferably 12, 13, or 20, depending on the base and overall composition. The fumed silica was added over 1-3 days, contingent on the base and rate of dissolution/dispersion of the silica, and the solution was left to stir until clear, generally eight hours to one day after the last of the silica was added. The solution was weighed again and any water that had evaporated was replaced, and allowed to stir for about 10 minutes. The time between silica additions was about 8 hours for guanidine and TMG, and approximately ¼ of the total SiO₂ could be added in one addition for guanidine and TMG before the solutions became too viscous for the stir bar to move. All three silicate solutions were clear, and colorless or slightly yellow. The guanidine and TMG silicate solutions were used within one day after the last of the silica had been added to avoid decomposition of the base.

Silicate solutions of tetramethylammonium hydroxide (“TMAOH”) was prepared by mixing 2 TMAOH pentahydrate·2 H₂O (equivalent to 2 TMAOH·12 H₂O) in a glass beaker and heating to 80° C. on a heated stir plate while sitting in a dish of water. Heating was necessary in part because the solubility of TMAOH pentahydrate (“TMAOH—PH”) is only about 1 TMAOH—PH·9.5 H₂O at 20° C., but after TMAOH—PH melts at 63° C., the molten TMAOH—PH is infinitely soluble. Fumed silica was added while the solution was maintained at 80° C. and stirred in by a magnetic stir bar. The silica took approximately 1 hour to add. About 45 minutes after all of the silica has been added, a clear, viscous solution was attained. The beaker was weighed to determine water loss from evaporation, and the amount of water lost was replaced and allowed to stir in, and the solution was used immediately. The temperature of the solution was not maintained at 80° C. when the solution was being mixed with the powder reagents.

Aluminosilicate and alumina powders (for example, Al₂O₃·4SiO₂, Al₂O₃·2SiO₂, 3Al₂O₃·2SiO₂, and Al₂O₃) were synthesized by the organic-inorganic steric entrapment method (“OISE”). Appropriate amounts of colloidal silica (Ludox SK from W.R. Grace) and Al(NO₃)₃·9H₂O were stirred in deionized water until all the Al(NO₃)₃·9H₂O was dissolved. While the solution was stirring on a magnetic stir plate, poly(vinyl alcohol) (“PVA,” 80% hydrolyzed, 9-10 kDa; Sigma Aldrich) was added. The amount of PVA that was added was enough to provide a ratio of 1 PVA group to 4 units of cation charge, and the amount of water was enough to give a 5 weight % solution of PVA (based on only the water and PVA). The solution was then heated at about 40-50° C. to evaporate the water, leaving a partially dry gel/foam in the reaction vessel. The foam was dried more completely at 200° C. for four hours after an increase in temperature of 10° C. per minute, ground into a coarse powder with a mortar and pestle, and then calcined to remove the PVA. The calcining temperatures and times as shown below in Table 1 were selected because the temperatures and times provide the highest amounts of five-coordinated aluminum based on ²⁷Al NMR spectroscopy. A greater amount of five-coordinated aluminum increases the reactivity of aluminosilicate and alumina during geopolymer synthesis. The powders, mixed with isopropanol to make a slurry with 33 weight % solids, were attrition-milled to reduce the particle size using 5-millimeter yttrium-stabilized zirconia balls at 500 RPM for 1 hour, then the balls were filtered out and the isopropanol evaporated on a hot plate. To remove residual isopropanol, the milled powders were calcined again at 600° C. with no dwell time and a ramp rate of 10° C./min.

TABLE 1
Calcination conditions for removing PVA
during steric entrapment synthesis.

| | Calcination | Dwell time | Ramp rate |
|---|---|---|---|
| Composition | temperature (° C.) | (hours) | (° C./min) |
| 1Al₂O₃•4SiO₂ | 900 | 0 | 10 |
| 1Al₂O₃•2SiO₂ | 700 | 1 | 5 |
| 3Al₂O₃•2SiO₂ | 600 | 1 | 10 |
| Al₂O₃ | 600 | 1 | 10 |

To synthesize geopolymers, the powders were added to the organic base solution or silicate solution and mixed with a high-shear mixer (Eurostar 200 with R1303 stirrer, IKA) at 2000 RPM for up to 10 minutes. Some mixtures became more viscous while mixing, so mixing was stopped early to avoid damaging the mixer. The mixtures were poured into weigh boats, which were sealed in plastic bags along with wet paper towels to maintain high relative humidity (approximately 100%) around the samples. The samples were cured at room temperature (18-22° C.) or in an oven held at 50° C. Samples were left to harden until no longer deformable by touch or until it was concluded that solidification would not occur. Details on curing times of specific samples are provided below.

### III. Results

### A. Tetramethylammonium Hydroxide Samples.

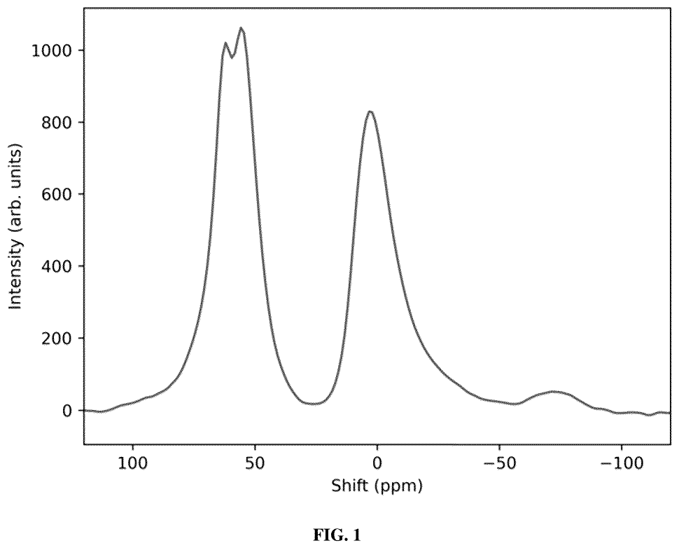

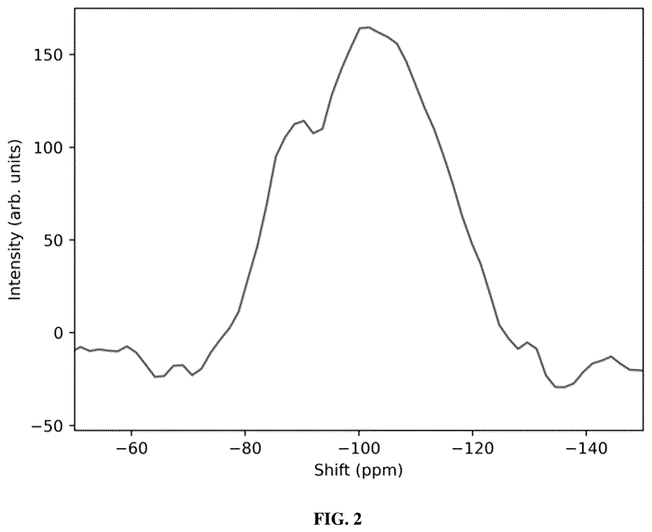

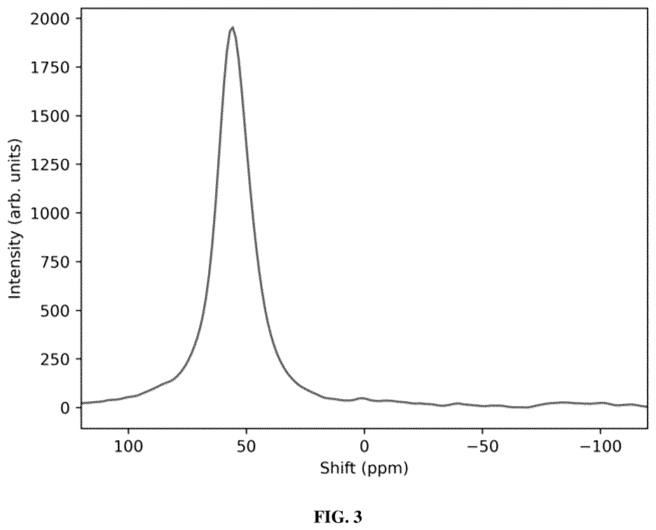

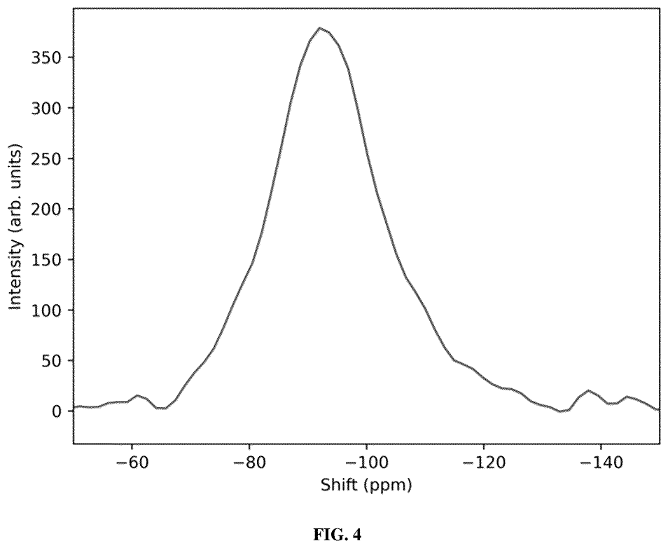

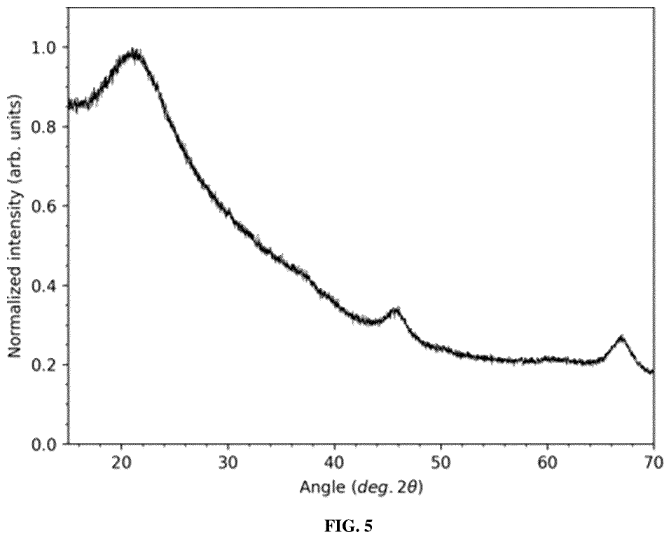

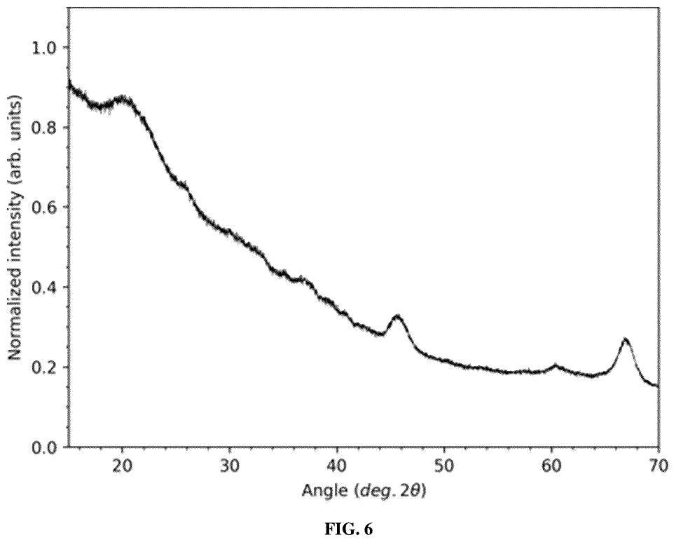

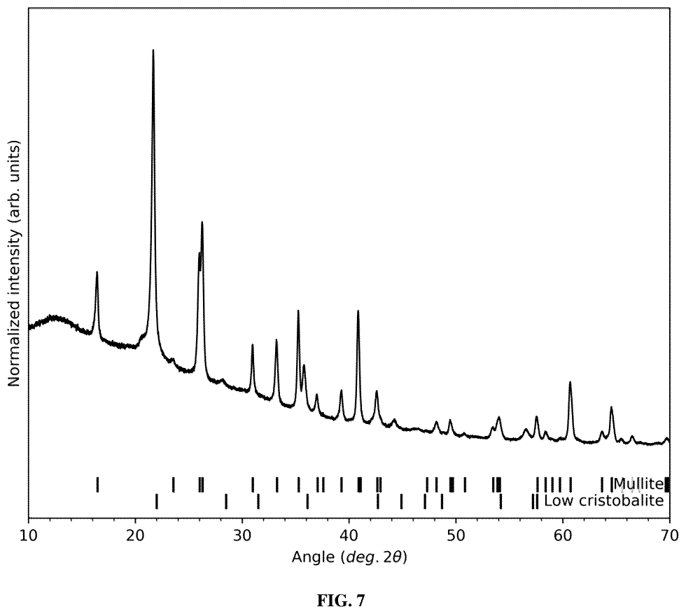

Initial tests were performed using tetramethylammonium hydroxide (“TMAOH”) as the organic base because the compound was commercially available as a hydroxide and was known to be comparable in strength to sodium hydroxide. A solution with the composition TMAOH·0.87SiO₂·7.7H₂O was prepared and mixed with Al₂O₃·2SiO₂ powder synthesized by OISE to give an overall composition of about TMAOH·0.9Al₂O₃·3.8SiO₂·7.7 H₂O. After about one month at 50° C. in a high-humidity environment, the composition became hard to the touch and broke in a brittle manner. As illustrated in FIGS. 1-4, ²⁷Al NMR showed a mixture of four- and six-coordinated aluminum rather than entirely four-coordinated aluminum, as in typical alkali geopolymer, while ²⁹Si NMR showed less aluminum substitution for silicon than in alkali-ion geopolymer. The TMAOH geopolymer composition was almost entirely amorphous when fired at 900° C. for four hours and then 1050° C. for four hours, but crystallized into a mixture of mullite, cristobalite, and quartz when fired at 1050° C. for four hours and then 1300° C. for four hours, as illustrated in FIGS. 5-7.

One sample was made using TMAOH and 3Al₂O₃·2 SiO₂ synthetic powder with an overall composition of 2TMAH·3Al₂O₃·2SiO₂·25H₂O. The composition became firmer over time while being kept in a humid environment at 50° C., but the composition did not become truly solid within two months of monitoring the composition. The comparable composition using NaOH instead of TMAOH solidified within a few minutes. Two samples were made using TMA silicate solution and amorphous Al₂O₃ having the 3Al₂O₃:2SiO₂ ratio of mullite. For the first sample, the silicate solution alone was held (in a closed cup) at 50° C. for 2 days and demonstrated precipitation of one phase from the silicate solution, and there was insufficient liquid remaining to adequately mix in the Al₂O₃. The composition of the precipitated phase was not examined. For the second sample, the silicate solution was stored at room temperature, and after a few minutes of high-shear mixing, the solution became much more viscous and somewhat plastic. The composition remained plastically deformable while in an oven set to 50° C. for 1.5 months. Without being bound by theory, it is believed that due to the slow equilibration of TMA silicate solutions, the second sample would be more successful if the silicate solution had been allowed to stir longer than six days. A mixture of TMAOH solution with synthetic Al₂O₃·4 SiO₂ powder (a typical geopolymer composition without alkali cations) did not solidify completely when held at room temperature, but instead formed a weak precipitate. The same mixture held at 50° C. for 1-2 months hardened fully into a single body. ²⁷Al NMR on the reaction products showed approximately equal amounts of four- and six-coordinated Al for the room-temperature TMAOH system, about 75% four-coordinated Al and 25% six-coordinated Al for a comparable KOH system, and about 90% four-coordinated Al and 10% six-coordinated Al for a comparable NaOH system.

### B. Tetramethylguanidine Samples.

TMG solutions mixed with commercial metakaolin essentially separated into a settled solid layer and a liquid layer. Mixtures of TMG with synthetic Al₂O₃·2 SiO₂ and also containing either ammonia (to try to slow the hydrolytic decomposition of the TMG) or dissolved SiO₂ (to give a composition of 2TMG·Al₂O₃·3SiO₂) were slightly more successful, in that homogeneous sludges resulted, but neither completely hardened. The TMG solution dissolved the silica more quickly than did the TMAOH, based on the decrease in viscosity after being stirred for one day. Therefore, TMG silicate solutions were mixed with amorphous Al₂O₃ at Al₂O₃:SiO₂ molar ratios of 3:2 (as seen in mullite) and 1:2 (low-SiO₂ geopolymer), which both became firmer over time, but neither of which hardened. When left in open air to dry for NMR analysis, the 3Al₂O₃·2SiO₂ sample disintegrated. ²⁷Al NMR spectra showed that nearly all of the aluminum was Al(VI) and a small amount was Al(IV) in both samples. By stirring silicate solutions longer to become fully equilibrated or raising the curing temperature to increase the reaction speed, it is expected that a geopolymer composition including TMG would cure to provide a hardened solid. TMG solution mixed with 3Al₂O₃·2SiO₂ hardened in about 1-2 hours at room temperature, and did not fall apart when dried in open air. Upon calcining, the cured geopolymer composition of TMG solution mixed with 3Al₂O₃·2SiO₂ produced mullite.

### C. Guanidinium Hydroxide and Guanidinium Carbonate Samples.

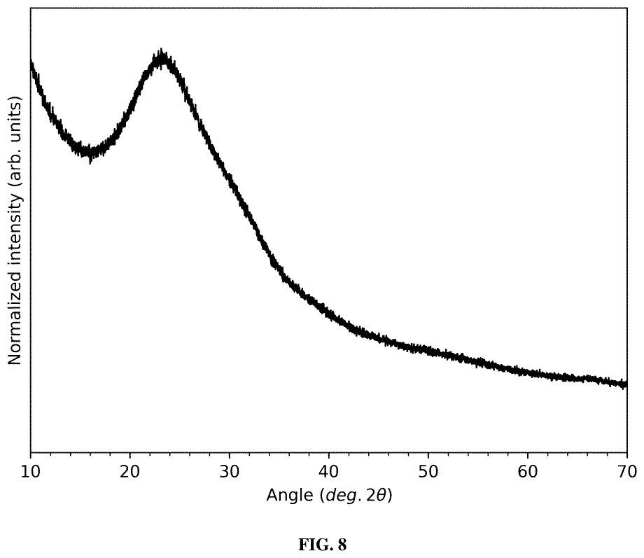

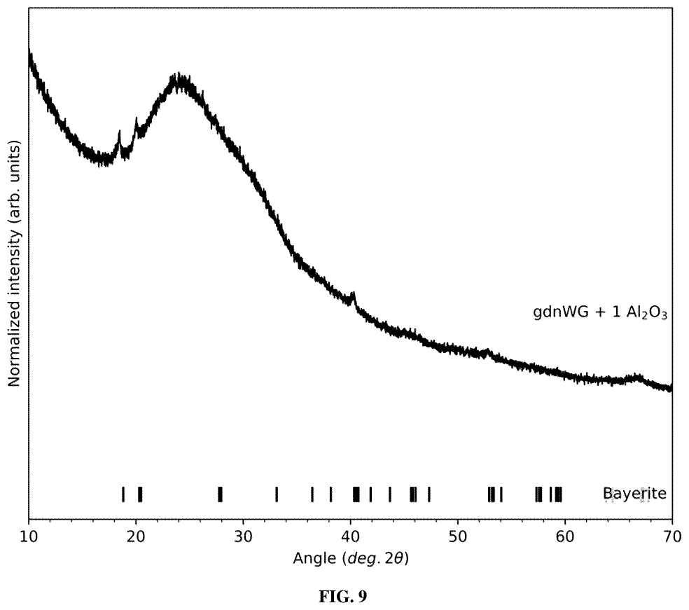

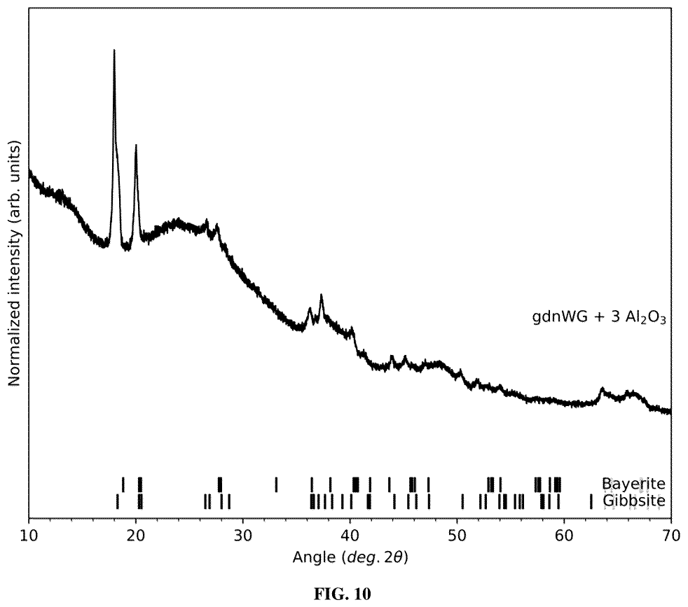

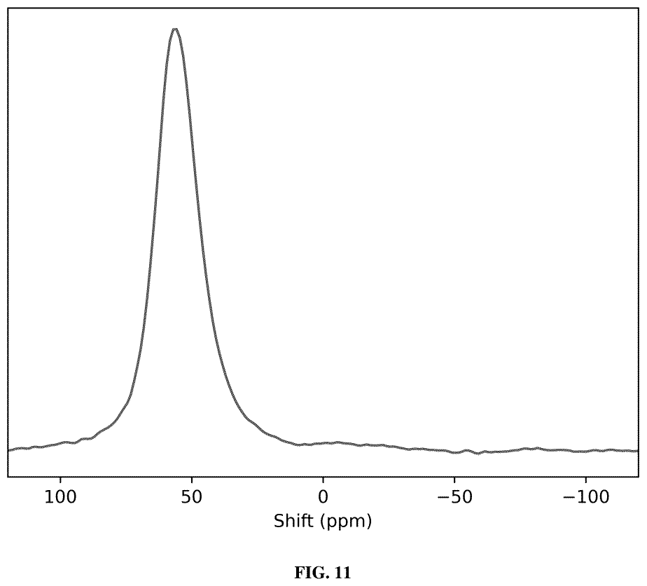

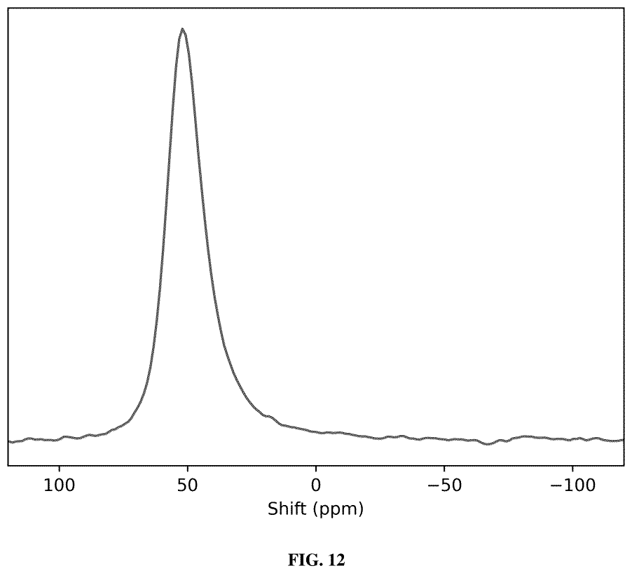

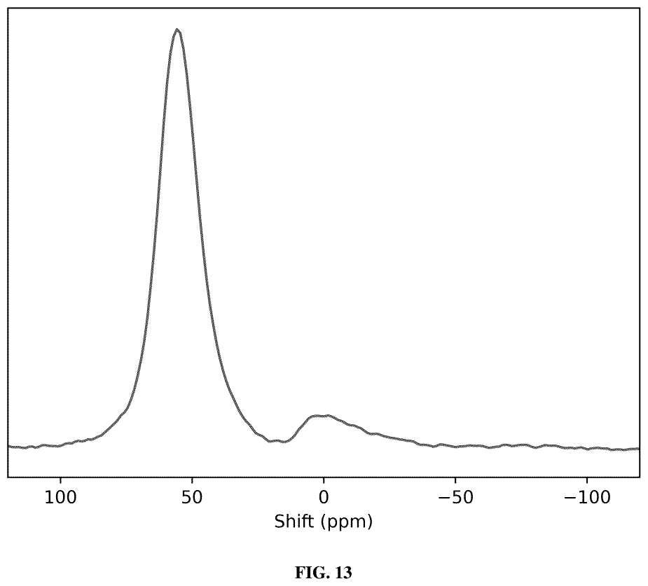

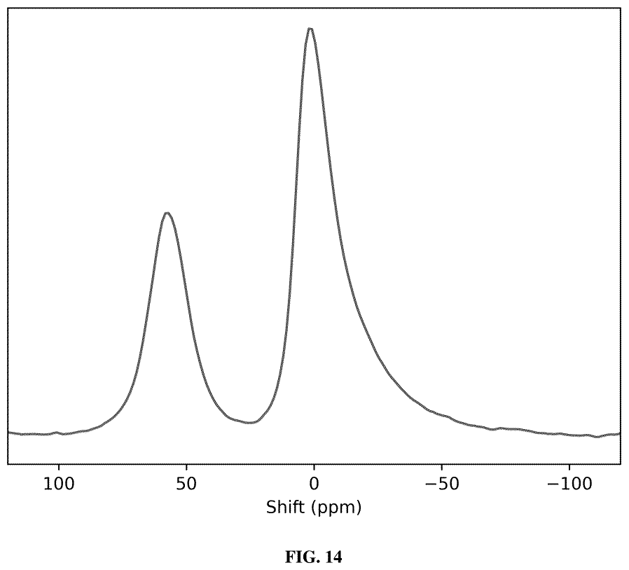

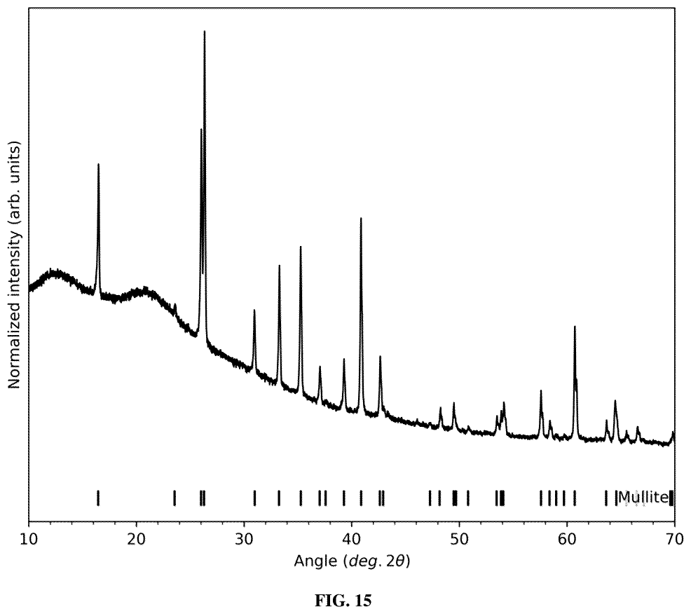

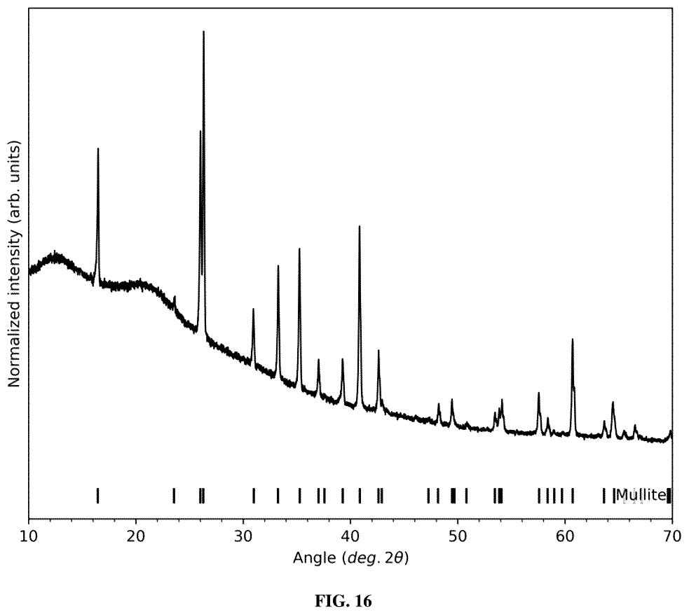

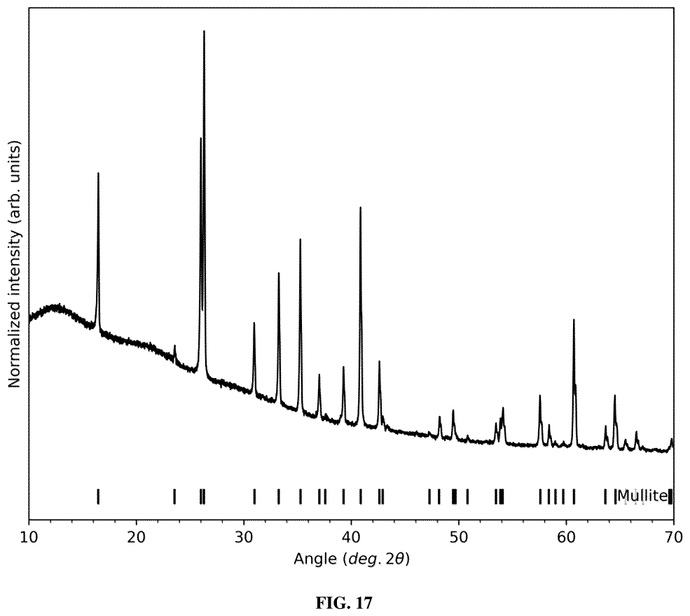

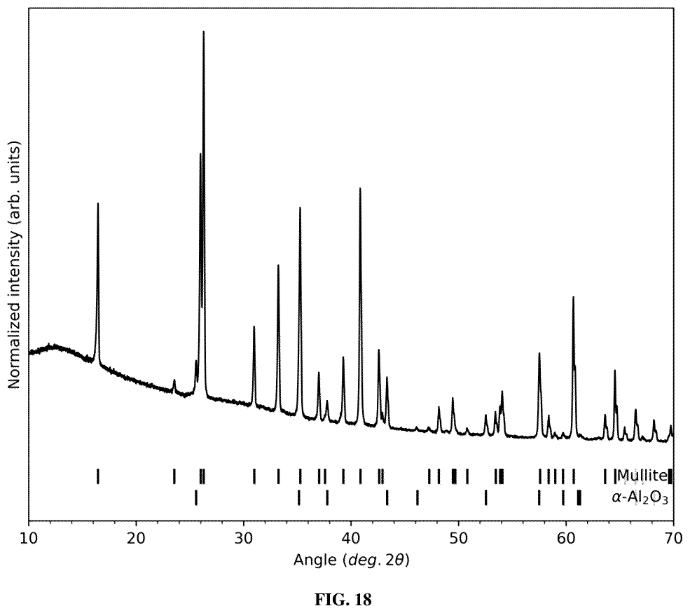

Samples made from gdmOH and gdm₂CO₃ solutions and 3Al₂O₃·2SiO₂ powder both solidified in a short time at room temperature. The sample using gdmOH solidified within about 10 minutes from the start of high-shear mixing, while the sample using gdm₂CO₃ solidified within 17 hours from the time of mixing. After firing at 1300° C. for 2 hours after a ramp rate of 2° C. per minute, both gdmOH and gdm₂CO₃ samples produced a mixture of mullite, θ-Al₂O₃, corundum, cristobalite, and perhaps some amorphous material, while firing at 1500° C. for 2 hours after a ramp rate of 2° C. per minute formed mullite, a small amount of corundum, and possibly an amorphous phase. Measurement of the ²⁷Al NMR spectra for the gdmOH and gdm₂CO₃ samples showed that nearly all of the aluminum was six-coordinated, and a small amount was four-coordinated, which matched the spectra of samples made from 2 NaOH+3Al₂O₃·2 SiO₂. Guanidine silicate solutions were prepared using concentrated guanidine filtrate, deionized water, and fumed silica with a nominal composition of 2 guanidine·2SiO₂·13H₂O. The silicate solutions were combined by high-shear mixing with Al₂O₃·2SiO₂ synthetic powders, commercial metakaolin (MetaMax HRM from BASF SE; nominal composition also Al₂O₃·2SiO₂), and Al₂O₃ synthetic powders as described above to provide mixtures with compositions of Al₂O₃·4SiO₂, Al₂O₃·2SiO₂, and 3Al₂O₃·2SiO₂. After a period of 30 seconds to about 3 days at room temperature, depending on the composition and precursors, the mixtures were hard to the touch and brittle. Curing at 50° C. reduced the hardening time for the mixture using metakaolin from about 3 days to less than 1 day. X-ray diffraction patterns of the mixtures with compositions Al₂O₃·4SiO₂ (made using synthetic Al₂O₃·2SiO₂), Al₂O₃·2SiO₂, and 3Al₂O₃·2SiO₂ are illustrated in FIGS. 8-10, respectively, and ²⁷Al NMR spectra of Al₂O₃·4SiO₂ (made using synthetic Al₂O₃·2SiO₂), Al₂O₃·4SiO₂ (made using commercial metakaolin), Al₂O₃·2SiO₂, and 3Al₂O₃·2SiO₂ are illustrated in FIGS. 11-14, respectively. The samples with compositions Al₂O₃·4SiO₂ (made using synthetic Al₂O₃·2SiO₂), Al₂O₃·4SiO₂ (made using commercial metakaolin), Al₂O₃·2SiO₂, and 3Al₂O₃·2SiO₂ were heated to 400° C. for 1 hour at 5° C./min and then to 1600° C. for 2 hours at 2° C./min to crystallize the samples, and the XRD patterns are illustrated in FIGS. 15-18, respectively.

Table 2 below lists the geopolymer compositions that have been demonstrated to solidify, and the conditions under which solids were formed.

TABLE 2

| Base or silicate solution | Aluminosilicate | Conditions |
|---|---|---|
| TMAOH•0.9SiO₂•7.7H₂O | Al₂O₃•2SiO₂ | 50° C. / 1 month |
| 2TMG•25H₂O | 3Al₂O₃•2SiO₂ | 20° C. / 1 hour |
| gdm₂CO₃•25H₂O | 3Al₂O₃•2SiO₂ | 20° C. / 17 hours |
| ~2 gdmOH•25H₂O | 3Al₂O₃•2SiO₂ | 20° C. / ~15 minutes |
| ~2 guanidine•2SiO₂•13H₂O | Al₂O₃•2SiO₂ (as | 20° C. / ~72 hours |
| | metakaolin) | |
| 2 guanidine•2SiO₂•13H₂O | Al₂O₃•2SiO₂ | 20° C./10 minutes |
| | (synthetic) | |
| 2 guanidine•2SiO₂•13H₂O | Al₂O₃ | 20° C./10 minutes |
| 2 guanidine•2SiO₂•13H₂O | 3Al₂O₃ | 20° C./30 seconds |

### EXAMPLE 2

### I. Introduction

In an example of the geopolymer compositions and example of the methods described herein, geopolymer precursors to the ceramics cordierite, mixed yttrium and aluminum silicates, yttrium disilicate, and willemite were cast, demonstrating the compositional flexibility that is possible with organic base geopolymers.

### II. Experimental Methods

All samples were synthesized by mixing a guanidine (“gdn”) silicate solution (2 gdn·2 SiO₂·13 H₂O; referred to as “WG,” “waterglass,” or “silicate solution”), a synthetic oxide power, and, optionally, a commercial metakaolin (Al₂O₃·2 SiO₂; “MK,” MetaMax HRM, BASF SE). The sample compositions in terms of molar oxide amounts and powders used for each geopolymer precursor are listed in Table 3. The solution component for each sample was 2 gdn·2 SiO₂·13 H₂O.

TABLE 3

| Overall composition | Powder component | Target ceramic |
|---|---|---|
| 2 gdn•2 MgO•2 Al₂O₃•5 | MK + 2 | Cordierite |
| SiO₂•13 H₂O | MgO•Al₂O₃•SiO₂ | |
| 2 gdn•Al₂O₃•Y₂O₃•4 | MK + Y₂O₃ | Mixed aluminates, |
| SiO₂•13 H₂O | | silicates |
| 2 gdn•Y₂O₃•2 | Y₂O₃ | Y₂O₃•2 SiO₂ |
| SiO₂•13 H₂O | | (yttrium disilicate) |
| 2 gdn•4 ZnO•2 | 4 ZnO | 2 ZnO•SiO₂ |
| SiO₂•13 H₂O | | (willemite; zinc silicate) |

To synthesize the samples of geopolymer precursors, the guanidine silicate solution was combined with the metakaolin or the synthetic oxide (if metakaolin was not used) in a stand mixer (Eurostar 200, IKA, Germany) equipped with a high-shear blade (R1303, IKA) by stirring at 2000 RPM for 10 minutes. The mixing yielded viscous pastes. For the samples containing metakaolin, the synthetic powder was added after the initial 10 minutes of mixing and dispersed with the high-shear mixing blade at 2000 RPM for about 2 minutes.

The mixed pastes were placed in weigh boats and sealed in plastic bags, which also held wet paper towels to maintain high humidity around the samples. The two compositions made with metakaolin were cured at room temperature, while the other two compositions were cured in a 50° C. oven until solid. A sample was considered to be solid if the sample could be handled as a single body; did not deform under small loads, including the sample's own weight; and was brittle and crumbled when ground with a mortar and pestle. Once a sample solidified, the bag was unsealed and the sample was allowed to dry in ambient air at about 20° C. and 15-35% relative humidity, except for a piece of the zinc silicate sample, which was dried in a vacuum jar immediately after removal from the oven to prepare the piece of zinc silicate sample for analysis.

The guanidine silicate solution was prepared by mixing guanidine (85% pure) with deionized water in a cup with a magnetic stir bar, and adding fumed silica (Cab-O-Sil M5, Cabot Corp., IL, USA) gradually over the course of about 3 days. The solution was left to stir for an additional day to allow the silica to completely dissolve, giving a clear solution that was colorless or green-tinted. The solution was used immediately.

The Y₂O₃, ZnO, and 2 MgO·Al₂O₃·SiO₂ powders were synthesized using the organic-inorganic steric entrapment method from Y(NO₃)₃·6 H₂O (Sigma-Aldrich, USA), Zn(NO₃)₂·6 H₂O (Sigma-Aldrich, USA), Mg(NO₃)₂·6 H₂O (Beantown Chemical, USA), Al(NO₃)₃·9 H₂O (Beantown Chemical), and colloidal silica (Ludox SK, W.R. Grace, USA). The appropriate proportion of each salt was dissolved in deionized water on a magnetic stir plate. Poly(vinyl alcohol) (“PVA,” 9-10 kDa, 80% hydrolyzed, Sigma-Aldrich) was added as a steric trapping agent at a ratio of 1 mole of PVA monomer to 4 moles of cation charge and a ratio of 5 PVA to 95 g H₂O.

The gels were dried in a muffle furnace (CWF1200, Carbolite, UK) at 200° C. for 4 hours with a ramp rate of 10° C./min. The dried gels were pulverized in a mortar and pestle and calcined to remove the PVA at the conditions listed in Table 4 below. After calcination, the ZnO powder was significantly consolidated into a single body with no distinct particles, but the body was very weak and porous. The body was ground into a powder again with a mortar and pestle. The calcined powders were attrition-milled as slurries in isopropanol (33 weight % solids) for 1 hour at 500 RPM with 5-millimeter zirconia balls. The balls were then strained out and rinsed, and the milled slurries were dried on a hot plate. The dried, milled powders were calcined at 600° C. with no dwell time at a ramp rate of 10° C./min to remove residual isopropanol, which would inhibit reaction with the silicate solution.

TABLE 4
Calcining Conditions for the Steric Entrapment Powders

| Powder Composition | Temp. (° C.) / time (hr.) / ramp rate (° C./min) |
|---|---|
| Y₂O₃ | 550 / 0 / 10 |
| ZnO | 600 / 0 / 10 |
| 2 MgO•Al₂O₃•SiO₂ | 800 / 1 / 5 |

The firing schedules for the samples are provided in Table 5. Prior to heating at the conditions in Table 5, each sample was first calcined in a muffle furnace (CWF1200, Carbolite) at 400° C. with a hold time of 1 hour and a ramp rate of 5° C./min to dry the sample and remove organic phases. Spherical alumina powder was used as setter sand to ensure that the samples did not stick to the dish.

TABLE 5
Firing Conditions for the Samples

| | Temp. (° C.) / time (hr.) / |
|---|---|
| Sample Composition | ramp rate (° C./min) |
| 2 gdn•2 MgO•2 Al₂O₃•5 SiO₂•13 H₂O | 1300 / 1 / 5 |
| 2 gdn•Al₂O₃•Y₂O₃•4 SiO₂•13 H₂O | 1500 / 1 / 5 |
| 2 gdn•Y₂O₃•2 SiO₂•13 H₂O | 1600 / 1 / 5 |
| 2 gdn•4 ZnO•2 SiO₂•13 H₂O | 1400 / 1 / 5 |

Powder x-ray diffractometry (XRD) was performed using a D8 Advance diffractometer (Bruker, USA) with Cu K, radiation (1.5418 Å wavelength), 0.2-millimeter incident slits, and panoramic Soller slits. Scans were run from 10° to 70° in 2θ in 0.01° steps, and a dwell time of 0.1 s/step. The sample holder was silicon and had no peaks in the scan range. Phases were identified by matching to reference files in the Inorganic Crystal Structure Database (“ICSD”; data release 2023.1) and Powder Diffraction File (“PDF”) database, either by manual matching or the phase matching feature in the Jade v9 software.

Solid-state ²⁷Al nuclear magnetic resonance (“NMR”) spectra were measured for the 2 MgO·Al₂O₃·SiO₂ powder and the GP+2 MgO·Al₂O₃·SiO₂ sample using direct-polarization experiments on a 7.05 T spectrometer (Unity INOVA 300, Agilent, USA) with magic-angle spinning at 10 kHz to improve the resolution and the samples held in 4-millimeter ZrO₂ rotors. The experiments consisted of 4000 scans using a spectral width of 100 kHz, acquisition time of 5.12 ms, and a recycle delay of 1 s. For the 2 MgO·Al₂O₃·SiO₂ precursor powder, the 900 pulse width was 1.0 μs, whereas for the GP+2 MgO·Al₂O₃·SiO₂ sample, it was 0.8375 μs. Spectra used an external reference of 1 M Al(NO₃)₃ solution at 0 ppm.

Solid-state ²⁹Si NMR spectra were measured using high-power proton decoupling experiments on an 11.74 T spectrometer (Bruker 500 MHz) with a 6-millimeter HXY probe (PhoenixNMR, USA) and magic-angle spinning at 8 kHz). For the samples, the spectral width was 50 kHz, the acquisition time was 10.24 ms, the recycle delay was 30 s, and the pulse width was 7.5 μs. Tetrakis(trimethylsilyl)silane at −9.9 ppm was used as an external reference. The number of scans was adjusted based on the silicon content of each composition: 300 scans for GP+2MgO·Al₂O₃·SiO₂, 600 scans for WG+Y₂O₃, and 1000 scans for WG+ZnO.

The GP+Y₂O₃ sample was not exampled by ²⁷Al or ²⁹Si NMR spectroscopy because the extent of reaction between the silicate solution and the Y₂O₃ powder was expected to be small compared to the reaction between the silicate solution and metakaolin, and because it would not be possible to distinguish between silicon with yttrium substitution and silicon with aluminum substitution.

All spectra for both ²⁷Al and ²⁹Si samples were normalized by the maximum intensity when plotted.

Fresh fracture surfaces were examined by scanning electron microscopy (“SEM”) (Thermo Axia ChemSEM, Thermo Fisher, USA) after sputter coating with gold to prevent charging.

The particle sizes of the milled synthetic powders were measured by laser diffraction while dispersed in deionized water (Partica LA-950V2), Horiba Ltd., Japan). The measurement software assumed that the particles were spherical and performed volume-weighed averaging when calculating the size distribution.

The specific surface area of the milled, synthetic precursor powders were measured by the Brunauer-Emmett-Teller (“BET”) method in a pressure range dictated by the Rouquerol criteria. Measurements were performed with an ASAP2020 gas adsorption analyzer (Micromeritics, USA). The powders were degassed for 5 hours at 300° C. prior to analysis. Adsorption experiments used 15 equally spaced points of relative pressures from 0.01 to 0.40 with an equilibration time of 5 s.

### III. Results and Discussion

### A. Precursor Powder Characterization.

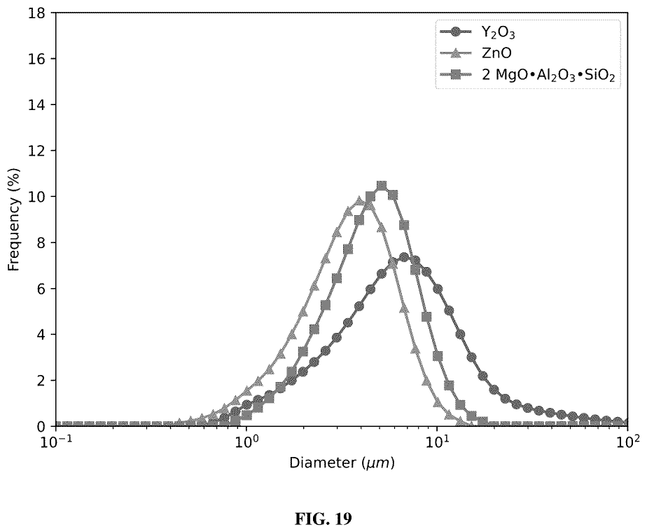

The 2 MgO·Al₂O₃·SiO₂ and ZnO powders had narrow size distribution whereas Y₂O₃ had a relatively wide distribution with a substantial fraction of particles larger than 10 μm, although the average particle size was 4-10 μm for all three compositions (Table 6 and FIG. 19). The sizes likely represented agglomerates of nanoparticles because agglomerates is the typical structure of powders made by the steric entrapment method. The existence of fine-scale structure was reflected by the high-specific surface areas of the 2 MgO·Al₂O₃·SiO₂ and Y₂O₃ powders. The ZnO powder had quite a low specific surface area, which may be related to consolidation observed after the first calcination step. The metakaolin was not characterized, but has been characterized previously.

TABLE 6
Particle Size and Specific Surface Area of the Synthetic Powders

| | Average Particle | Specific Surface |
|---|---|---|
| | Size (μm) ± | Area (m²/g) ± |
| Powder | Standard Devisation | Standard Deviation |
| 2 MgO•Al₂O₃•SiO₂ | 4.7 ± 2.4 | 74.3 ± 1.1 |
| Y₂O₃ | 9.0 ± 13.7 | 44.8 ± 0.2 |
| ZnO | 3.6± | 3.5 ± 0.01 |

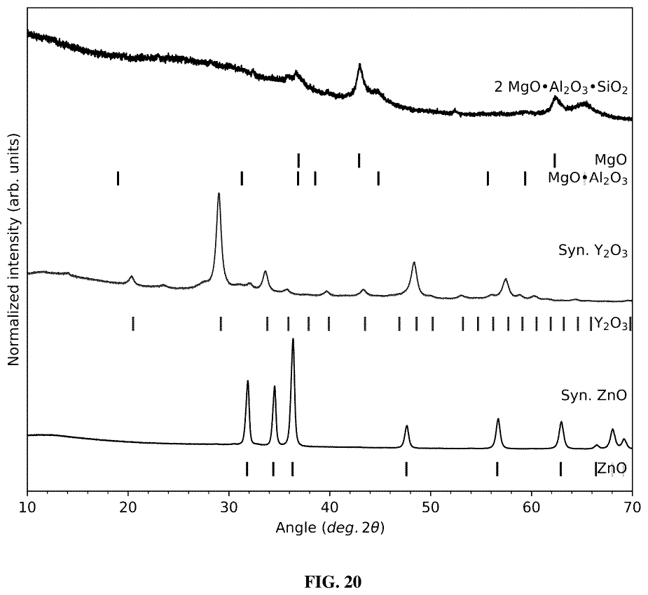

None of the synthetic powders were amorphous, as illustrated in FIG. 20, although only ZnO had very sharp peaks indicative of a highly crystalline material. Crystallinity was undesirable because amorphous powders are more reactive toward silicate solutions than crystalline powders and crystalline materials would also react less readily during the firing step to convert the samples into the target ceramics. The 2 MgO·Al₂O₃·SiO₂ powder was the most amorphous and had only a small amount of poorly crystalline MgO and MgO·Al₂O₃ spinel. The spinel should be inert, but crystalline or non-crystalline MgO may be problematic because magnesium is known to react with dissolved silica to give insoluble magnesium silicates. Reference powder XRD patterns from the Inorganic Crystal Structure Database (“ICSD”) illustrated in FIG. 20 include: MgO (ICSD 52026), MgO·Al₂O₃(ICSD 40030), Y₂O₃(ICSD 23811), and ZnO (ICSD 26170).

The Y₂O₃ powder caused broad peaks indicative of poor crystallization. Some amorphous phase may have been present because there was a slight halo at about 29° in 2θ. There was a small amount of an unknown impurity that caused ill-defined peaks at approximately 25°, 27.5°, 31°, and 32.5° in 2θ that could not be matched to a phase. To attempt to resolve the unknown peaks, the powder was heated to 900° C.; instead of resolving the peaks, the peaks vanished entirely. The ZnO powder was better crystallized than the Y₂O₃, although there was still a slight halo at about 12° in 2θ.

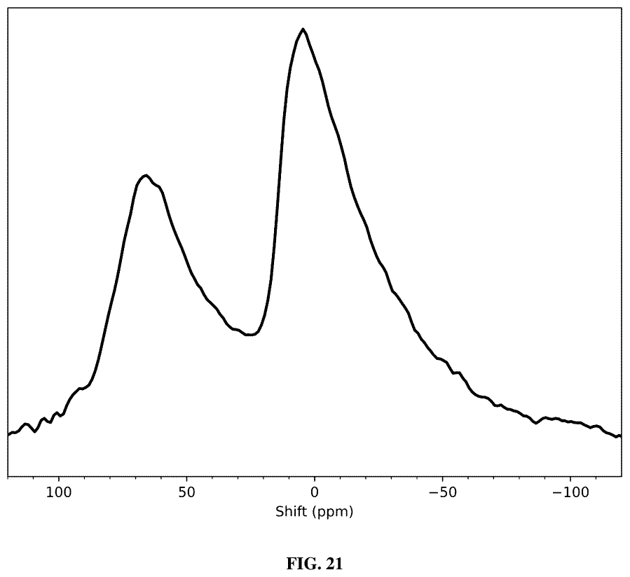

To better assess the reactivity of the 2 MgO·Al₂O₃·SiO₂ powder, the powder was examined with ²⁷Al NMR spectroscopy, as illustrated in FIG. 21. The presence of a substantial amount of five-coordinated aluminum (“Al^{[5]}”) would indicate that the powder would react well with the silicate solution. However, only two peaks were visible: one peak at 66 ppm from four-coordinated aluminum (“Al^{[4]}”) and one peak at 4.5 ppm from six-coordinated aluminum (“Al^{[6]}”). The apparent lack of Al^{[5]} was an advantageous result, because reaction of the 2 MgO·Al₂O₃·SiO₂ powder with dissolved silica is undesirable. Preferably, the 2 MgO·Al₂O₃·SiO₂ would be inert until the sample is fired. The ²⁹Si spectrum was not collected for the 2 MgO·Al₂O₃·SiO₂ powder, but because colloidal silica was used to synthesize the powder, the powder likely had a core of silica with little or no aluminum or magnesium substitution and a shell layer of MgO+Al₂O₃. Though determination of yttrium coordination was of interest, doing so by ⁸⁹Y NMR spectroscopy was not successful because the relaxation from a 900 tip angle was found to be approximately 3-4 hours.

### B. Cast Sample Characterization.

Every sample solidified within 3 days, but the hardening times varied slightly between compositions, as shown in Table 7. The two compositions that used metakaolin were consistent with or slightly shorter than the hardening time of 3 days for unmodified metakaolin-based geopolymer at room temperature. The GP+2 MgO·Al₂O₃·SiO₂ sample hardened faster than the other compositions, which may indicate that the synthetic powder reacted with the silicate solution. If the synthetic powder did not react, it may still have behaved as a reinforcing agent and have made the sample appear to be solid when still actually plastically deformable. By contrast, the GP+Y₂O₃ sample hardened in the same amount of time as typical metakaolin-based geopolymer, indicating that Y₂O₃ was likely substantially inert in the GP+Y₂O₃ composition compared to the metakaolin. None of the samples were analyzed prior to more than 3 days of hardening time, so incomplete reaction at the time of further analysis was unlikely.

TABLE 7
Hardening Time of Each Composition

| | Days to Harden |
|---|---|
| Sample Composition | (Cure Temperature) |
| 2 gdn•2 MgO•2 Al₂O₃•5 SiO₂•13 H₂O | 1 (20° C.) |
| 2 gdn•Al₂O₃•Y₂O₃•4 SiO₂•13 H₂O | 3 (20° C.) |
| 2 gdn•Y₂O₃•2 SiO₂•13 H₂O | 3 (50° C.) |
| 2 gdn•4 ZnO•2 SiO₂•13 H₂O | 1 (50° C.) |

Despite the very low specific surface area and high crystallinity of the ZnO powder, the 2 gdn·4 ZnO·2 SiO₂·13 H₂O sample solidified within one day at 50° C., similarly to metakaolin-based geopolymer at 50° C. The unexpected reactivity of the ZnO powder may have been due to the good solubility of ZnO at high pH and elevated temperature. Although the 2 gdn·4 ZnO·2 SiO₂·13 H₂O hardened quickly, while drying in ambient air, the sample broke down into small pieces. The cause of the fracturing did not appear to be the rate of water loss, because the section of the sample that was immediately dried under vacuum for SEM remained intact even though the section was larger than the pieces that resulted from the air-dried body.

The slow hardening of WG+Y₂O₃ signified that the Y₂O₃ powder was not very reactive, probably due to the relatively low solubility of Y₂O₃. Although the WG+Y₂O₃ sample appeared solid after 3 days, the WG+Y₂O₃ experienced a noticeable gain in strength during another 7 days held at 50° C. in a humid environment. The reactivity may be improved if the specific surface area is increased or the crystallinity decreased. Alternatively, because Y₂O₃ and ZnO may form Y(OH)ₙ^{m+} and Zn(OH)ₙ^{m+} ions at high pH, the use of hydroxide rather than oxide powder may be beneficial.

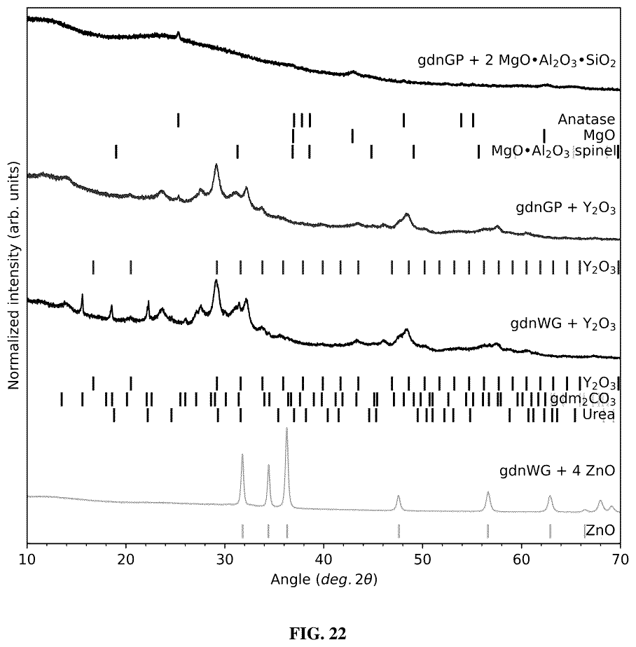

Powder XRDs of the hardened samples illustrated in FIG. 22 demonstrated that the synthetic powders did not completely dissolve, because peaks from the powders were still visible. An amorphous halo was present in the diffraction pattern for GP+2 MgO·Al₂O₃·SiO₂ at about 24° in 2θ, as was observed for guanidine geopolymers without added 2 MgO·Al₂O₃·SiO₂ powder. No halo was observed for GP+Y₂O₃, but the halo may have been obscured by Y₂O₃ peaks. Compared to the diffraction pattern of the Y₂O₃ alone, the GP+Y₂O₃ peaks were less prominent relative to the background and to the unidentified peaks, which are present and appear more pronounced. The diffraction pattern of the WG+Y₂O₃ sample was similar to the pattern of GP+Y₂O₃ aside from peaks originating from guanidinium carbonte and urea, which indicated some carbonation and hydrolysis of guanidine. Reference powder XRD patterns illustrated in FIG. 22 include: anatase (ICSD 9852), MgO (ICSD 52026), MgO·Al₂O₃ spinel (ICSD 40030), Y₂O₃ (ICSD 23811), gdm₂CO₃ (ICSD 2152), urea (ICSD 15432), and ZnO (ICSD 26170).

For the WG+4 ZnO sample, a weak halo developed at about 23° in 20 (barely visible in FIG. 22). The halo may have originated from a product phase formed by reaction of some ZnO with the dissolved silica. Based on the intensities of the ZnO peaks, much of the ZnO powder did not dissolve, which may have been due to an excess of Zn relative to SiO₂. Further, no Zn(OH)₂ developed, unlike Al₂O₃-rich systems, which demonstrated the formation of Al(OH)₃. There was also no precipitated 2 ZnO·SiO₂, 4 ZnO·2 SiO₂·n H₂O, or γ-Zn(OH)₂ as observed for solutions of tetrabutylammonium hydroxide and zinc acetate reacting with a glass flask. The lack of observed precipitate may be due to the availability of SiO₂ already in solution, which may facilitate precipitation as an amorphous material rather than as a crystalline phase.

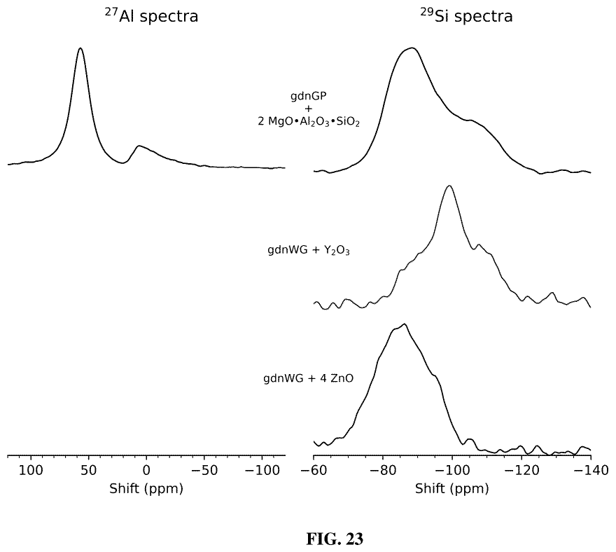

The extent of reaction was also examined by NMR spectroscopy (FIG. 23). In the ²⁷Al spectrum of GP+2 MgO·Al₂O₃·SiO₂, an Al^{[4]} peak was observed at 58 ppm, attributable to the geopolymer phase, and an Al^{[6]} peak appeared at 6.7 ppm, which may be from octahedral aluminum in the unreacted portion of the 2 MgO·Al₂O₃·SiO₂ powder, such as the unintended MgO·Al₂O₃ spinel impurity. The ²⁹Si spectrum of the GP+2 MgO·Al₂O₃·SiO₂ sample had two peaks: the first peak, at −110 ppm, came from Q⁴(0 Al) units that originated from the colloidal silica core of the powder, cores of aluminosilicate powders observed not to dissolve while alumina shells reacted; the second peak, at −88 ppm, came from Q⁴(1-4 Al) groups in the geopolymer, but the position was slightly more positive than the position of typical metakaolin-based geopolymer (at about −93 ppm), which is associated with a lower SiO₂/Al₂O₃ ratio. The lower SiO₂/Al₂O₃ ratio may be the result of alumina from 2 MgO·Al₂O₃·SiO₂ powder, but not the silica core, being incorporated into the geopolymer along with the aluminum from the metakaolin, which would also account for solidification faster than expected at 20° C.

In the ²⁹Si spectrum of WG+Y₂O₃, there was an intense peak at −99 ppm with shoulders at −107 ppm and −90 ppm. Assignment of the peaks was attempted by assuming that the chemical shift ranges of Qⁿ groups in yttrium silicate gels and aluminosilicate gels are similar. From the XRD pattern, the Y₂O₃ did not completely dissolve, so some of the dissolved silica did not react and would have precipitated as the sample dried. The precipitated silica could account for the shoulder at −107 ppm, which may be Q⁴(0 Y) and optionally Q⁴(1 Y) silica groups. The peak at −99 ppm may reflect Q⁴(1-3 Y) groups or Q³ silicon.

There was only only one very broad peak observed in the ²⁹Si spectrum of WG+4 ZnO, centered at −85 ppm, which was visually similar to the geopolymers made from guanidine WG+1 Al₂O₃ that had a high amount of Q⁴(3-4 Al) silicon units. The sample in the study matched the range of Q⁴(1-3 Zn) reported for zinc silicate zeolites.

Because both the WG+Y₂O₃ and WG+4 ZnO samples solidified and their NMR spectra appeared to show some new reaction product, some amount of geopolymeric yttrium silicate and zinc silicate phases were concluded to have developed.

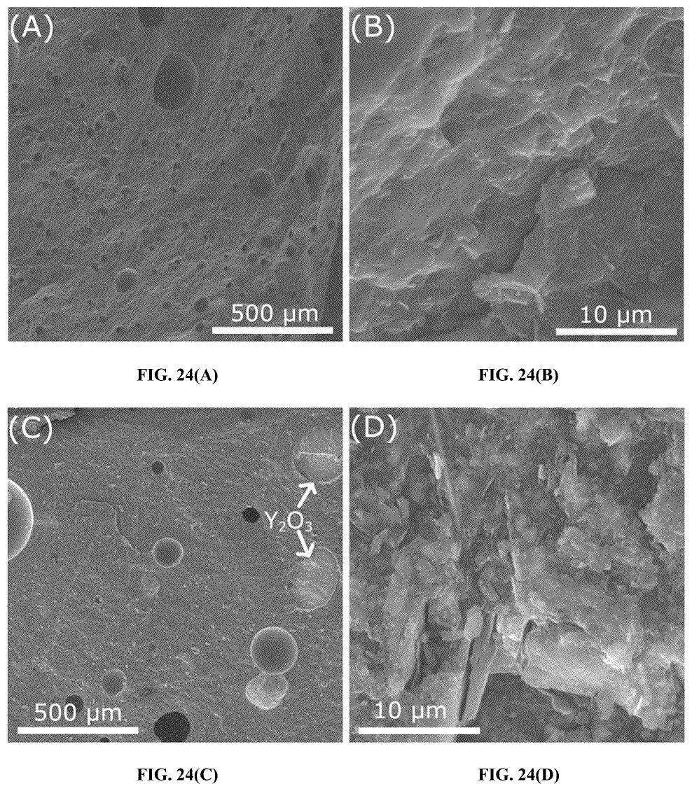

Scanning electron microscopy revealed large, spherical pores in all four of the samples listed in Table 7. The pores were induced by the mixing step. The GP+2 MgO·Al₂O₃·SiO₂ sample seemed the most porous based on visual appearance, as illustrated in FIGS. 24(A) and 24(B). The GP+2 MgO·Al₂O₃·SiO₃ mixture was the most viscous, and the high viscosity would have impeded air bubbles from floating up to the surface, thereby eliminating pores. In the GP+Y₂O₃ sample, illustrated in FIGS. 24(C) and 24(D), there were some large Y₂O₃ particles (labeled by arrows in FIG. 24(C)) that had not been broken up and dispersed by the mixer. No other disparities were evident at low magnification. At higher magnification, the GP+2 MgO·Al₂O₃·SiO₂ fracture surface appeared identical to the fracture surface of a Al₂O₃·4 SiO₂ guanidine geopolymer, as illustrated in FIG. 24(B). As illustrated in FIG. 24(D), at high magnification, the GP+Y₂O₃ sample showed many small particles embedded within the geopolymer matrix.

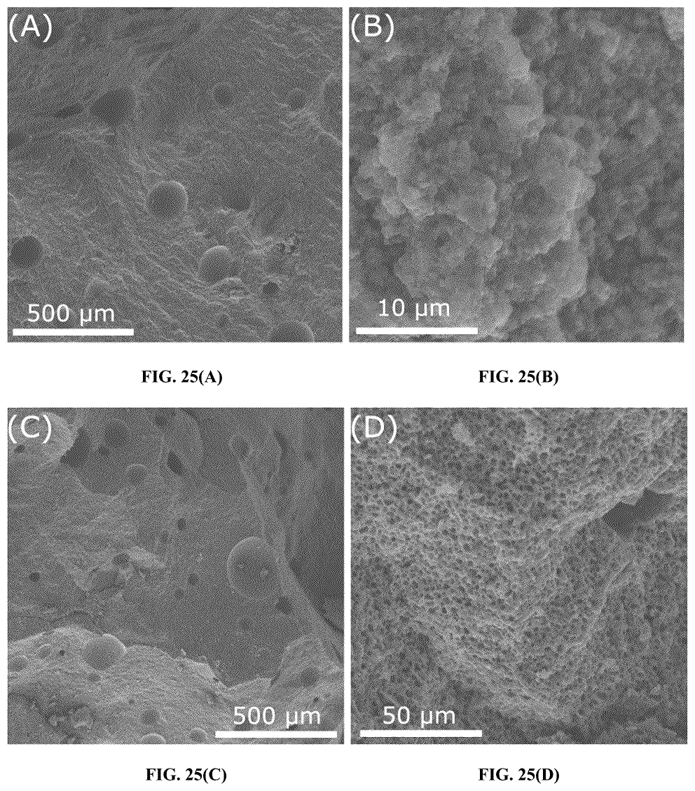

By contrast, the WG+Y₂O₃ illustrated in FIG. 25(A) had a very rough texture at high magnification, as illustrated in FIG. 25(B). The WG+Y₂O₃ was visually similar to a sample of guanidine silicate solution+metakaolin+5 γ-Al₂O₃. The small-scale structure of the WG+4 ZnO sample was different from the other samples because the WG+4 ZnO sample was riddled with 1-5 μm pores, as illustrated in FIGS. 25(C) and 25(D). The source of the pores was unknown. The matrix around the pores appeared similar to typical metakaolin-based geopolymer.

### C. Characterization of Fired Samples.

Aside from the WG+4 ZnO composition, each specimen was calcined and fired as a bulk body that was approximately 4-8 millimeters thick, and up to 25 millimeters long on a side. The WG+4 ZnO sample cracked into small pieces (2-4 millimeters on a side) while drying in air, and many of the pieces were heated instead of a single, large bulk section. Firing at high temperature according to Table 5 caused every sample to shrink. Further, through-body cracks formed in every sample except GP+Y₂O₃, and the cordierite sample exhibited slight bloating or swelling, visible as bumps on the exterior surface.

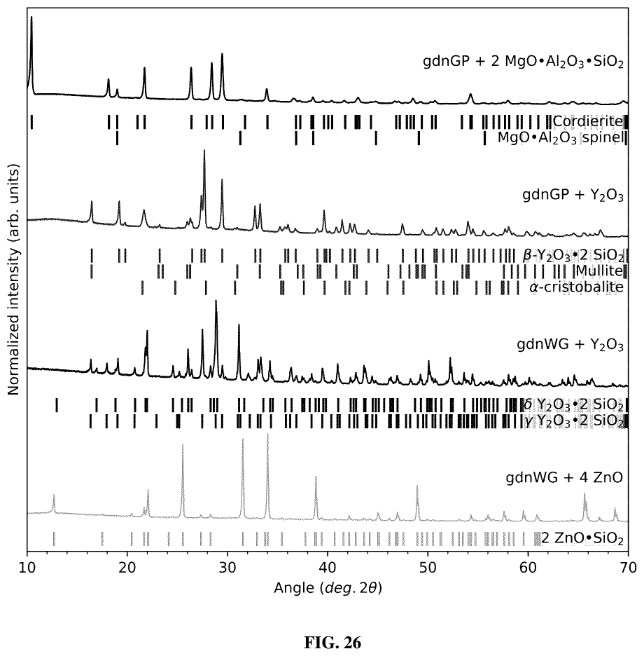

Each sample was converted predominantly into the target ceramics, as determined by powder XRD illustrated in FIG. 26. Some secondary phases were also detected, but the low intensity of the XRD peaks suggested that the phase fractions of the secondary phases were low. In all samples except for the WG+Y₂O₃ composition, there was a visible halo at about 120 in 2θ, which was indicative of amorphous material that might crystallize with a longer dwell time or a higher temperature.

In the GP+2 MgO·Al₂O₃·SiO₂ sample, cordierite was the highly predominant primary product. A small amount of MgO·Al₂O₃ spinel was present, but the spinel may have formed during firing or have been present in the original precursor powder. The GP+Y₂O₃ composition also crystallized into a combination of expected silicate phases. The phases, or the amounts thereof, would change if the firing temperature or time were adjusted to eliminate residual amorphous phase. For WG+Y₂O₃, two polymorphs of Y₂O₃·2 SiO₂ developed: the δ and γ phases. It was unknown whether the two phases formed at the same time or if one phase was converted to the other during heating or cooling. WG+4 ZnO produced mostly the desired willemite (2 ZnO·SiO₂). Aside from the armophouse phase, there was another unidentifiable impurity product with very weak peaks at approximately 24°, 30°, and 36°-39° in 20.

Reference powder XRD patterns from the ICSD illustrated in FIG. 26 include cordierite (ICSD 30947), MgO·Al₂O₃ (ICSD 40030), and 2 ZnO·SiO₂ (ICSD 2425). Reference powder XRD patterns from the Powder Diffraction File (“PDF”) illustrated in FIG. 26 include β-Y₂O₃·2 SiO₂ (PDF 04-012-4410), mullite (PDF 04-014-4567), α-cristobalite (PDF 04-012-1126), 6-Y₂O₃·2 SiO₂ (PDF 04-009-5693), and 7-Y₂O₃·2 SiO₂ (PDF 04-015-5861).

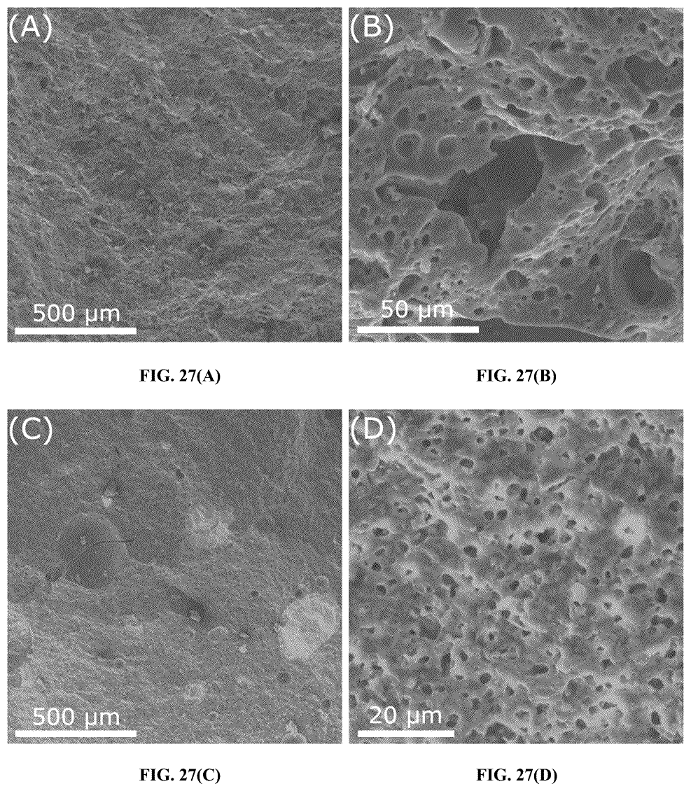

The fracture surfaces of the fired samples exhibited large-scale pores observed by scanning electron miscropy (“SEM”), as illustrated in FIGS. 27(A)-(D) and 29(A)-(D), demonstrating that insufficient liquid phase formed during firing to completely fill the pores. Except in the WG+4 ZnO sample, new pores also formed. Some of the pores were spheroidal and others were irregularly shaped, so the pores were though to have originated from combined action of expanding, trapped gases, and crystallization-induced shrinkage. The cordierite sample developed a high amount of porosity despite originally appearing dense. The porosity was accompanied by some bloating and cracking on the outer surface of the cordierite sample, which was evidence of trapped interior gases.

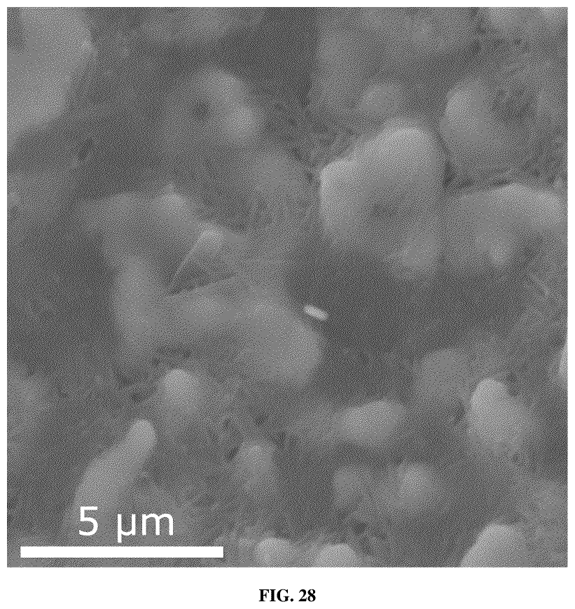

In the GP+Y₂O₃ sample, three phases could be observed by SEM, as illustrated in FIG. 28, not including the undispersed grains of Y₂O₃. One of the phases looked smooth, appeared to coat the other material, and was presumed to be the amorphous phase detected by XRD. A second phase, with needle-like grains, was most similar to mullite. The mullite needles were thinner than in the Al₂O₃·2 SiO₂, Al₂O₃·4 SiO₂, and 3 Al₂O₃·2 SiO₂ compositions. The third phase had ball-like grains illustrated in FIG. 28, the composition of which was not known and could not be determined by energy-dispersive X-ray spectroscopy in the SEM due to the small size of the grains (<3 μm).

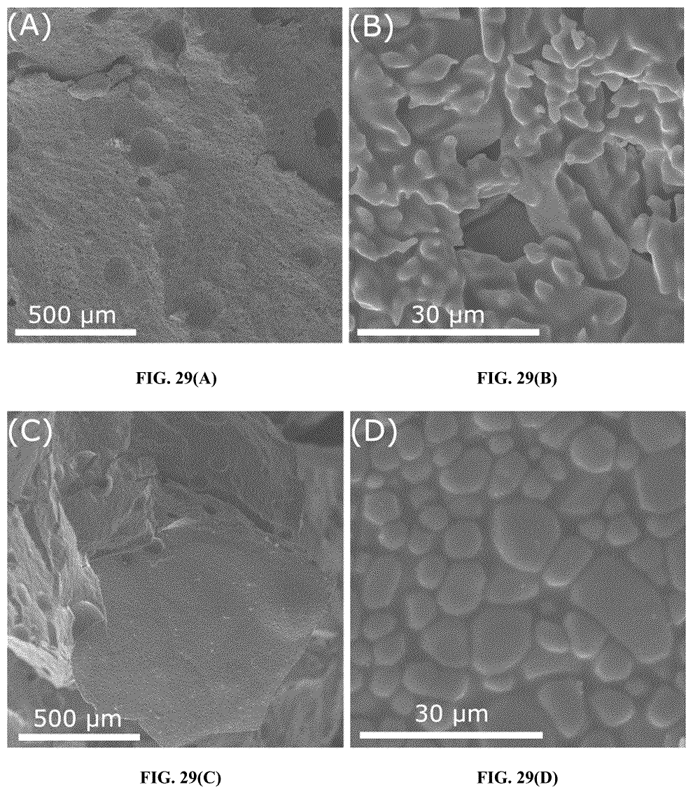

Both the WG+Y₂O₃ and WG+4 ZnO samples developed a phase that coated and bonded the irregularly shaped grains, as illustrated in FIG. 29(A)-(D). For the WG+4 ZnO sample, the coating phase was likely the amorphouse phase observed by XRD, but the nature of the phase was unclear for the WG+Y₂O₃ speciment, because there was no apparent amorphous halo in the XRD pattern for the sample after firing. Throughout the WG+Y₂O₃ sample, there were interconnected, non-spherical pores, but no small pores were observed in the WG+4 ZnO sample. Therefore a highly dense willemite ceramic or willemite/gass composite may be produced if the mixing process could be improved to eliminate large air bubbles. In the WG+Y₂O₃ sample, and likely in the GP+Y₂O₃ sample, the existence of multiple crystalline phases may prevent effective densification due to constrained sintering effects.

Although the present disclosure has been described with reference to examples and the accompanying drawings, the present disclosure is not limited thereto, but may be variously modified and altered by those skilled in the art to which the present disclosure pertains without departing from the spirit and scope of the present disclosure.

The subject-matter of the disclosure may also relate, among others, to the following aspects:

A first aspect relates to a geopolymer composition, comprising: an organic base; and an aluminosilicate.

A second aspect relates to the geopolymer composition of aspect 1, wherein the organic base comprises an amidine, a guanidine, a vinamidine, a tetra-substituted ammonium species, an amine, a phosphazene, a tetra-substituted phosphonium species, a conjugate acid thereof, a salt thereof, or any combination thereof.

A third aspect relates to the geopolymer composition of aspect 1 or 2, wherein the organic base comprises a compound of formula (I), or a salt of a conjugate acid of a compound of formula (I):

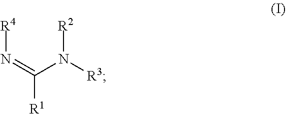

wherein each of R¹, R², R³, and R⁴ is independently selected from hydrogen, (C₁-C₂₀)alkyl, (C₁-C₂₀)alkoxy, (C₂-C₂₀)alkenyl, (C₂-C₂₀)alkenyloxy, (C₂-C₂₀)alkynyl, (C₂-C₂₀)alkynyloxy, aryl, aryloxy, heteroaryl, heteroaryloxy, heterocyclyl, heterocyclyloxy, aryl(C₁-C₄)alkyl, (C₁-C₄)alkylaryl(C₁-C₄)alkyl, heteroaryl(C₁-C₄)alkyl, (C₁-C₄)alkylheteroaryl(C₁-C₄)alkyl, heterocyclyl(C₁-C₄)alkyl, and (C₁-C₄)alkylheterocyclyl(C₁-C₄)alkyl, each of which is optionally substituted with alkoxy, hydroxy, amino, or N-substituted amino; or any two of R¹, R², R³, and R⁴, taken together with the carbon and/or nitrogen to which the two of R¹, R², R³, and R⁴ are respectively bonded, form a heterocyclic or heteroaryl ring that is optionally substituted with alkoxy, hydroxy, amino, or N-substituted amino; and provided that R¹, R², R³, and R⁴ are not all simultaneously hydrogen.

A fourth aspect relates to the geopolymer composition of aspect 1 or 2, wherein the organic base comprises a compound of formula (II), or a salt of a conjugate acid of a compound of formula (II):

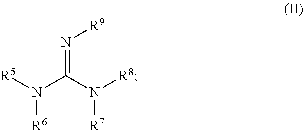

wherein each of R⁵, R⁶, R⁷, R⁸, and R⁹ is independently selected from hydrogen, (C₁-C₂₀)alkyl, (C₁-C₂₀)alkoxy, (C₂-C₂₀)alkenyl, (C₂-C₂₀)alkenyloxy, (C₂-C₂₀)alkynyl, (C₂-C₂₀)alkynyloxy, aryl, aryloxy, heteroaryl, heteroaryloxy, heterocyclyl, heterocyclyloxy, aryl(C₁-C₄)alkyl, (C₁-C₄)alkylaryl(C₁-C₄)alkyl, heteroaryl(C₁-C₄)alkyl, (C₁-C₄)alkylheteroaryl(C₁-C₄)alkyl, heterocyclyl(C₁-C₄)alkyl, and (C₁-C₄)alkylheterocyclyl(C₁-C₄)alkyl, each of which is optionally substituted with alkoxy, hydroxy, amino, or N-substituted amino; and wherein any two of R⁵, R⁶, R⁷, R⁸, and R⁹, taken together with nitrogen to which the two of R⁵, R⁶, R⁷, R⁸, and R⁹ are bonded and optionally carbon, optionally form a heterocyclic or heteroaryl ring that is optionally substituted with alkoxy, hydroxy, amino, or N-substituted amino.

A fifth aspect relates to the geopolymer composition of aspect 1 or 2, wherein the organic base comprises a compound of formula (III) or a salt thereof:

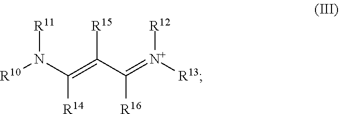

wherein each of R¹⁰, R¹¹, R¹², R¹³, R¹⁴, R¹⁵, and R¹⁶ is independently selected from hydrogen, (C₁-C₂₀)alkyl, (C₁-C₂₀)alkoxy, (C₂-C₂₀)alkenyl, (C₂-C₂₀)alkenyloxy, (C₂-C₂₀)alkynyl, (C₂-C₂₀)alkynyloxy, aryl, aryloxy, heteroaryl, heteroaryloxy, heterocyclyl, heterocyclyloxy, aryl(C₁-C₄)alkyl, (C₁-C₄)alkylaryl(C₁-C₄)alkyl, heteroaryl(C₁-C₄)alkyl, (C₁-C₄)alkylheteroaryl(C₁-C₄)alkyl, heterocyclyl(C₁-C₄)alkyl, and (C₁-C₄)alkylheterocyclyl(C₁-C₄)alkyl, each of which is optionally substituted with alkoxy, hydroxy, amino, or N-substituted amino; wherein R¹⁵, and one of R¹¹ or R¹², taken together with the carbons and nitrogen between R¹⁵, and the one of R¹¹ or R¹², optionally form a heterocyclic or heteroaryl ring; wherein R¹⁰ and R¹¹ and/or R¹² and R¹³, taken together with nitrogen, optionally form a heterocyclic or heteroaryl ring; wherein R¹⁴, and one of R¹⁰ or R¹¹, and/or R¹⁶, and one of R¹² and R¹³, taken together with carbon and nitrogen, optionally form a heterocyclic ring; wherein R¹⁴ and R¹⁶, taken together with the carbons between R¹⁴ and R¹⁶, optionally form a carbocyclic or heterocyclic ring; provided that R¹⁰ and R¹¹ are not simultaneously hydrogen; and provided that R¹² and R¹³ are not simultaneously hydrogen.

A sixth aspect relates to the geopolymer composition of aspect 1 or 2, wherein the organic base comprises a compound of formula (IV) or a salt thereof:

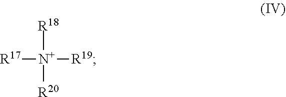

wherein each of R¹⁷, R¹⁸, R¹⁹, and R²⁰ is independently selected from (C₁-C₂₀)alkyl, (C₁-C₂₀)alkoxy, (C₂-C₂₀)alkenyl, (C₂-C₂₀)alkenyloxy, (C₂-C₂₀)alkynyl, (C₂-C₂₀)alkynyloxy, aryl, aryloxy, heteroaryl, heteroaryloxy, heterocyclyl, heterocyclyloxy, aryl(C₁-C₄)alkyl, (C₁-C₄)alkylaryl(C₁-C₄)alkyl, heteroaryl(C₁-C₄)alkyl, (C₁-C₄)alkylheteroaryl(C₁-C₄)alkyl, heterocyclyl(C₁-C₄)alkyl, and (C₁-C₄)alkylheterocyclyl(C₁-C₄)alkyl, each of which is optionally substituted with alkoxy, hydroxy, amino, or N-substituted amino; and wherein any two of R¹⁷, R¹⁸, R¹⁹, and R²⁰, taken together with nitrogen, optionally form a heterocyclic or heteroaryl ring.

A seventh aspect relates to the geopolymer composition of aspect 1 or 2, wherein the organic base comprises a compound of formula (V) or a salt of a conjugate acid of a compound of formula (V):

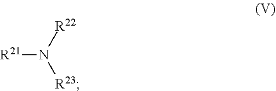

wherein each of R²¹, R²², and R²³ is independently selected from (C₁-C₂₀)alkyl, (C₁-C₂₀)alkoxy, (C₂-C₂₀)alkenyl, (C₂-C₂₀)alkenyloxy, (C₂-C₂₀)alkynyl, (C₂-C₂₀)alkynyloxy, aryl, aryloxy, heteroaryl, heteroaryloxy, heterocyclyl, heterocyclyloxy, aryl(C₁-C₄)alkyl, (C₁-C₄)alkylaryl(C₁-C₄)alkyl, heteroaryl(C₁-C₄)alkyl, (C₁-C₄)alkylheteroaryl(C₁-C₄)alkyl, heterocyclyl(C₁-C₄)alkyl, and (C₁-C₄)alkylheterocyclyl(C₁-C₄)alkyl, each of which is optionally substituted with alkoxy, hydroxy, amino, or N-substituted amino; and wherein any two of R²¹, R²², and R²³, taken together with nitrogen, optionally form a heterocyclic or heteroaryl ring.

An eighth aspect relates to the geopolymer composition of aspect 1 or 2, wherein the organic base comprises a compound of formula (VI) or a salt of a compound of formula (VI):

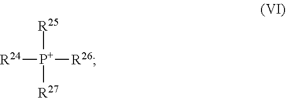

wherein each of R²⁴, R²⁵, R²⁶, and R²⁷ is independently selected from (C₁-C₂₀)alkyl, (C₁-C₂₀)alkoxy, (C₂-C₂₀)alkenyl, (C₂-C₂₀)alkenyloxy, (C₂-C₂₀)alkynyl, (C₂-C₂₀)alkynyloxy, aryl, aryloxy, heteroaryl, heteroaryloxy, heterocyclyl, heterocyclyloxy, aryl(C₁-C₄)alkyl, (C₁-C₄)alkylaryl(C₁-C₄)alkyl, heteroaryl(C₁-C₄)alkyl, (C₁-C₄)alkylheteroaryl(C₁-C₄)alkyl, heterocyclyl(C₁-C₄)alkyl, and (C₁-C₄)alkylheterocyclyl(C₁-C₄)alkyl, each of which is optionally substituted with alkoxy, hydroxy, amino, or N-substituted amino; and wherein any two of R²⁴, R²⁵, R²⁶, and R²⁷, taken together with phosphorus, optionally form a heterocyclic ring.

A ninth aspect relates to the geopolymer composition of aspect 1 or 2, wherein the organic base comprises a compound of formula (VII) or a salt of a conjugate acid of formula (VII):

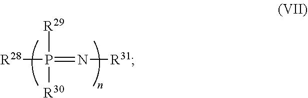

wherein each of R²⁸, R²⁹, and R³⁰ is N(R³²)₂ or N═P(N(R³³)₂)₃; wherein R³¹, each R³², and each R³³ are independently selected from hydrogen, (C₁-C₂₀)alkyl, (C₁-C₂₀)alkoxy, (C₂-C₂₀)alkenyl, (C₂-C₂₀)alkenyloxy, (C₂-C₂₀)alkynyl, (C₂-C₂₀)alkynyloxy, aryl, aryloxy, heteroaryl, heteroaryloxy, heterocyclyl, heterocyclyloxy, aryl(C₁-C₄)alkyl, (C₁-C₄)alkylaryl(C₁-C₄)alkyl, heteroaryl(C₁-C₄)alkyl, (C₁-C₄)alkylheteroaryl(C₁-C₄)alkyl, heterocyclyl(C₁-C₄)alkyl, and (C₁-C₄)alkylheterocyclyl(C₁-C₄)alkyl, each of which is optionally substituted with alkoxy, hydroxy, amino, or N-substituted amino; and wherein any two of R²⁸, R²⁹, and R³⁰, and/or any two R³², and/or any two R³³, taken together with nitrogen, may form a heterocyclic ring.

A tenth aspect relates to the geopolymer composition of aspects 1 to 9, wherein the organic base comprises formamidine, acetamidine, 1,8-diazabicyclo[5.4.0]undec-7-ene, tetramethylguanidine, guanidine, tetramethylammonium, 1,8-bis(dimethylamino)naphthalene, diphenyldimethylphosphonium, P3 phosphazene, t-Bu-P₄, 2-tert-butylimino-2-ethylamino-1,3-dimethylperhydro-1,3,2-diazaphosphorine, a conjugate acid thereof, a salt thereof, or any combination thereof.

An eleventh aspect relates to the geopolymer composition of aspects 2 to 10, wherein the salt is a hydroxide or carbonate salt.

A twelfth aspect relates to the geopolymer composition of aspects 1 to 11, further comprising water.

A thirteenth aspect relates to the geopolymer composition of aspects 1 to 12, wherein the aluminosilicate comprises a molar ratio of Al₂O₃ to SiO₂ of from about 1:5 to about 5:1.

A fourteenth aspect relates to the geopolymer composition of aspects 1 to 13 that is free of alkali metal species.

A fifteenth aspect relates to the geopolymer composition of aspects 1 to 14 that is free of calcium.

A sixteenth aspect relates to a cured composition formed from the geopolymer composition of aspects 1 to 15.

A seventeenth aspect relates to a ceramic, comprising the geopolymer composition of aspects 1 to 16.

An eighteenth aspect relates to the ceramic of aspect 17, comprising mullite.

A nineteenth aspect relates to a coating comprising the geopolymer composition of aspects 1 to 15.

A twentieth aspect relates to a three-dimensional printing resin comprising the geopolymer composition of aspects 1 to 15.

A twenty-first aspect relates to a method of making the geopolymer composition of aspects 1 to 15, comprising mixing the aluminosilicate with the organic base to provide the geopolymer composition.

A twenty-second aspect relates to the method of aspect 21, further comprising dissolving the organic base in water to provide an aqueous solution of the organic base prior to the mixing.

A twenty-third aspect relates to the method of aspect 22, further comprising dissolving silica in the aqueous solution of the organic base prior to the mixing.

A twenty-fourth aspect relates to the method of aspects 21 to 23, further comprising forming the geopolymer composition into a desired shape to provide a set geopolymer composition.

A twenty-fifth aspect relates to the method of aspect 24, further comprising curing the set geopolymer composition to provide a cured geopolymer composition.

A twenty-sixth aspect relates to the method of aspect 25, wherein the curing is at a temperature of from about 5° C. to about 90° C. for a period of up to 1 month.

A twenty-seventh aspect relates to a method of making a ceramic from the cured geopolymer composition of aspect 25, comprising heating the cured geopolymer composition at a temperature of at least about 300° C. for at least about 4 hours.

A twenty-eighth aspect relates to the method of aspect 27, wherein the ceramic comprises mullite.

A twenty-ninth aspect relates to a method of making an alkali-free ceramic, comprising: mixing an aqueous solution of an organic base with an aluminosilicate to provide a geopolymer composition; forming the geopolymer composition into a desired shape to provide a set geopolymer composition; curing the set geopolymer composition to provide a cured geopolymer composition; and heating the cured geopolymer composition to provide the alkali-free ceramic.

A thirtieth aspect relates to the method of aspect 29, further comprising dissolving silica in the aqueous solution of the organic base prior to the mixing.

A thirty-first aspect relates to the method of aspect 29 or 30, wherein the organic base comprises an amidine, a guanidine, a vinamidine, a tetra-substituted ammonium species, an amine, a phosphazene, a tetra-substituted phosphonium species, a conjugate acid thereof, a salt thereof, or any combination thereof.

A thirty-second aspect relates to the method of aspects 29 to 31, wherein the organic base comprises a compound of formula (I), or a salt of a conjugate acid of a compound of formula (I):

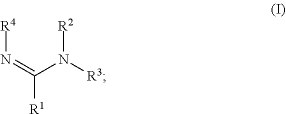

wherein each of R¹, R², R³, and R⁴ is independently selected from hydrogen, (C₁-C₂₀)alkyl, (C₁-C₂₀)alkoxy, (C₂-C₂₀)alkenyl, (C₂-C₂₀)alkenyloxy, (C₂-C₂₀)alkynyl, (C₂-C₂₀)alkynyloxy, aryl, aryloxy, heteroaryl, heteroaryloxy, heterocyclyl, heterocyclyloxy, aryl(C₁-C₄)alkyl, (C₁-C₄)alkylaryl(C₁-C₄)alkyl, heteroaryl(C₁-C₄)alkyl, (C₁-C₄)alkylheteroaryl(C₁-C₄)alkyl, heterocyclyl(C₁-C₄)alkyl, and (C₁-C₄)alkylheterocyclyl(C₁-C₄)alkyl, each of which is optionally substituted with alkoxy, hydroxy, amino, or N-substituted amino; or any two of R¹, R², R³, and R⁴, taken together with the carbon and/or nitrogen to which the two of R¹, R², R³, and R⁴ are respectively bonded, form a heterocyclic or heteroaryl ring that is optionally substituted with alkoxy, hydroxy, amino, or N-substituted amino; and provided that R¹, R², R³, and R⁴ are not all simultaneously hydrogen.

A thirty-third aspect relates to the method of aspects 29 to 31, wherein the organic base comprises a compound of formula (II), or a salt of a conjugate acid of a compound of formula (II):

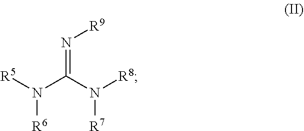

wherein each of R⁵, R⁶, R⁷, R⁸, and R⁹ is independently selected from hydrogen, (C₁-C₂₀)alkyl, (C₁-C₂₀)alkoxy, (C₂-C₂₀)alkenyl, (C₂-C₂₀)alkenyloxy, (C₂-C₂₀)alkynyl, (C₂-C₂₀)alkynyloxy, aryl, aryloxy, heteroaryl, heteroaryloxy, heterocyclyl, heterocyclyloxy, aryl(C₁-C₄)alkyl, (C₁-C₄)alkylaryl(C₁-C₄)alkyl, heteroaryl(C₁-C₄)alkyl, (C₁-C₄)alkylheteroaryl(C₁-C₄)alkyl, heterocyclyl(C₁-C₄)alkyl, and (C₁-C₄)alkylheterocyclyl(C₁-C₄)alkyl, each of which is optionally substituted with alkoxy, hydroxy, amino, or N-substituted amino; and wherein any two of R⁵, R⁶, R⁷, R⁸, and R⁹, taken together with nitrogen to which the two of R⁵, R⁶, R⁷, R⁸, and R⁹ are bonded and optionally carbon, optionally form a heterocyclic or heteroaryl ring that is optionally substituted with alkoxy, hydroxy, amino, or N-substituted amino.

A thirty-fourth aspect relates to the method of aspects 29 to 31, wherein the organic base comprises a compound of formula (III) or a salt thereof:

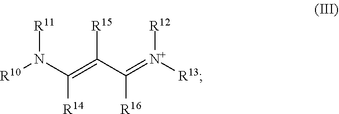

wherein each of R¹⁰, R¹¹, R¹², R¹³, R¹⁴, R¹⁵, and R¹⁶ is independently selected from hydrogen, (C₁-C₂₀)alkyl, (C₁-C₂₀)alkoxy, (C₂-C₂₀)alkenyl, (C₂-C₂₀)alkenyloxy, (C₂-C₂₀)alkynyl, (C₂-C₂₀)alkynyloxy, aryl, aryloxy, heteroaryl, heteroaryloxy, heterocyclyl, heterocyclyloxy, aryl(C₁-C₄)alkyl, (C₁-C₄)alkylaryl(C₁-C₄)alkyl, heteroaryl(C₁-C₄)alkyl, (C₁-C₄)alkylheteroaryl(C₁-C₄)alkyl, heterocyclyl(C₁-C₄)alkyl, and (C₁-C₄)alkylheterocyclyl(C₁-C₄)alkyl, each of which is optionally substituted with alkoxy, hydroxy, amino, or N-substituted amino; wherein R¹⁵, and one of R¹¹ or R¹², taken together with the carbons and nitrogen between R¹⁵, and the one of R¹¹ or R¹², optionally form a heterocyclic or heteroaryl ring; wherein R¹⁰ and R¹¹ and/or R¹² and R¹³, taken together with nitrogen, optionally form a heterocyclic or heteroaryl ring; wherein R¹⁴, and one of R¹⁰ or R¹¹, and/or R¹⁶, and one of R¹² and R¹³, taken together with carbon and nitrogen, optionally form a heterocyclic ring; wherein R¹⁴ and R¹⁶, taken together with the carbons between R¹⁴ and R¹⁶, optionally form a carbocyclic or heterocyclic ring; provided that R¹⁰ and R¹¹ are not simultaneously hydrogen; and provided that R¹² and R¹³ are not simultaneously hydrogen.

A thirty-fifth aspect relates to the method of aspects 29 to 31, wherein the organic base comprises a compound of formula (IV) or a salt thereof:

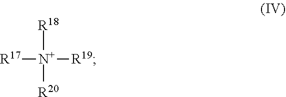

wherein each of R¹⁷, R¹⁸, R¹⁹, and R²⁰ is independently selected from (C₁-C₂₀)alkyl, (C₁-C₂₀)alkoxy, (C₂-C₂₀)alkenyl, (C₂-C₂₀)alkenyloxy, (C₂-C₂₀)alkynyl, (C₂-C₂₀)alkynyloxy, aryl, aryloxy, heteroaryl, heteroaryloxy, heterocyclyl, heterocyclyloxy, aryl(C₁-C₄)alkyl, (C₁-C₄)alkylaryl(C₁-C₄)alkyl, heteroaryl(C₁-C₄)alkyl, (C₁-C₄)alkylheteroaryl(C₁-C₄)alkyl, heterocyclyl(C₁-C₄)alkyl, and (C₁-C₄)alkylheterocyclyl(C₁-C₄)alkyl, each of which is optionally substituted with alkoxy, hydroxy, amino, or N-substituted amino; and wherein any two of R¹⁷, R¹⁸, R¹⁹, and R²⁰, taken together with nitrogen, optionally form a heterocyclic or heteroaryl ring.

A thirty-sixth aspect relates to the method of aspects 29 to 31, wherein the organic base comprises a compound of formula (V) or a salt of a conjugate acid of a compound of formula (V):

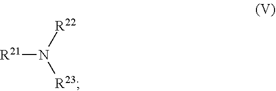

wherein each of R²¹, R²², and R²³ is independently selected from (C₁-C₂₀)alkyl, (C₁-C₂₀)alkoxy, (C₂-C₂₀)alkenyl, (C₂-C₂₀)alkenyloxy, (C₂-C₂₀)alkynyl, (C₂-C₂₀)alkynyloxy, aryl, aryloxy, heteroaryl, heteroaryloxy, heterocyclyl, heterocyclyloxy, aryl(C₁-C₄)alkyl, (C₁-C₄)alkylaryl(C₁-C₄)alkyl, heteroaryl(C₁-C₄)alkyl, (C₁-C₄)alkylheteroaryl(C₁-C₄)alkyl, heterocyclyl(C₁-C₄)alkyl, and (C₁-C₄)alkylheterocyclyl(C₁-C₄)alkyl, each of which is optionally substituted with alkoxy, hydroxy, amino, or N-substituted amino; and wherein any two of R²¹, R²², and R²³, taken together with nitrogen, optionally form a heterocyclic or heteroaryl ring.

A thirty-seventh aspect relates to the method of aspects 29 to 31, wherein the organic base comprises a compound of formula (VI) or a salt of a compound of formula (VI):

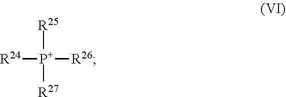

wherein each of R²⁴, R²⁵, R²⁶, and R²⁷ is independently selected from (C₁-C₂₀)alkyl, (C₁-C₂₀)alkoxy, (C₂-C₂₀)alkenyl, (C₂-C₂₀)alkenyloxy, (C₂-C₂₀)alkynyl, (C₂-C₂₀)alkynyloxy, aryl, aryloxy, heteroaryl, heteroaryloxy, heterocyclyl, heterocyclyloxy, aryl(C₁-C₄)alkyl, (C₁-C₄)alkylaryl(C₁-C₄)alkyl, heteroaryl(C₁-C₄)alkyl, (C₁-C₄)alkylheteroaryl(C₁-C₄)alkyl, heterocyclyl(C₁-C₄)alkyl, and (C₁-C₄)alkylheterocyclyl(C₁-C₄)alkyl, each of which is optionally substituted with alkoxy, hydroxy, amino, or N-substituted amino; and wherein any two of R²⁴, R²⁵, R²⁶, and R²⁷, taken together with phosphorus, optionally form a heterocyclic ring.

A thirty-eighth aspect relates to the method of aspects 29 to 31, wherein the organic base comprises a compound of formula (VII) or a salt of a conjugate acid of formula (VII):

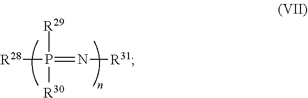

wherein each of R²⁸, R²⁹, and R³⁰ is N(R³²)₂ or N═P(N(R³³)₂)₃; wherein R³¹, each R³², and each R³³ are independently selected from hydrogen, (C₁-C₂₀)alkyl, (C₁-C₂₀)alkoxy, (C₂-C₂₀)alkenyl, C₂-C₂₀)alkenyloxy, (C₂-C₂₀)alkynyl, (C₂-C₂₀)alkynyloxy, aryl, aryloxy, heteroaryl, heteroaryloxy, heterocyclyl, heterocyclyloxy, aryl(C₁-C₄)alkyl, (C₁-C₄)alkylaryl(C₁-C₄)alkyl, heteroaryl(C₁-C₄)alkyl, (C₁-C₄)alkylheteroaryl(C₁-C₄)alkyl, heterocyclyl(C₁-C₄)alkyl, and (C₁-C₄)alkylheterocyclyl(C₁-C₄)alkyl, each of which is optionally substituted with alkoxy, hydroxy, amino, or N-substituted amino; and wherein any two of R²⁸, R²⁹, and R³⁰, and/or any two R³², and/or any two R³³, taken together with nitrogen, may form a heterocyclic ring.

A thirty-ninth aspect relates to the method of aspects 29 to 38, wherein the organic base comprises formamidine, acetamidine, 1,8-diazabicyclo[5.4.0]undec-7-ene, tetramethylguanidine, guanidine, tetramethylammonium, 1,8-bis(dimethylamino)naphthalene, diphenyldimethylphosphonium, P3 phosphazene, t-Bu-P₄, 2-tert-butylimino-2-diethylamino-1,3-dimethylperhydro-1,3,2-diazaphosphorine, a conjugate acid thereof, a salt thereof, or any combination thereof.

A fortieth aspect relates to the method of aspects 31 to 39, wherein the salt is a hydroxide or carbonate salt.

A forty-first aspect relates to the method of aspects 29 to 40, wherein the aluminosilicate comprises a molar ratio of Al₂O₃ to SiO₂ of from about 1:5 to about 5:1.

A forty-second aspect relates to the method of aspects 29 to 41 wherein the ceramic is free of calcium.

A forty-third aspect relates to the method of aspects 29 to 42 that is free of ion exchange.

A forty-fourth aspect relates to the method of aspects 29 to 43, wherein the forming comprises applying the geopolymer composition as a coating that is the set geopolymer composition.

A forty-fifth aspect relates to the method of aspects 29 to 43, wherein the forming comprises three-dimensionally printing the desired shape.

A forty-sixth aspect relates to the method of aspects 29 to 43, wherein the forming comprises extruding the desired shape.

A forty-seventh aspect relates to the method of aspects 29 to 46, wherein the curing is at a temperature of from about 5° C. to about 90° C. for a period of up to 1 month.

A forty-eighth aspect relates to the method of aspects 29 to 47, wherein the heating is at a temperature of at least about 300° C. for at least about 4 hours.

A forty-ninth aspect relates to the method of aspects 29 to 48, wherein the ceramic comprises mullite.

A fiftieth aspect relates to a geopolymer composition, comprising: an organic base; and a silicate of magnesium, zinc, aluminum, and/or one or more rare earth elements.

A fifty-first aspect relates to the geopolymer composition of aspect 50, wherein the one or more rare earth elements is yttrium.

A fifty-second aspect relates to the geopolymer composition of aspect 50 or 51, wherein the organic base comprises an amidine, a guanidine, a vinamidine, a tetra-substituted ammonium species, an amine, a phosphazene, a tetra-substituted phosphonium species, a conjugate acid thereof, a salt thereof, or any combination thereof.

A fifty-third aspect relates to the geopolymer composition of aspects 50 to 52, wherein the organic base comprises a compound of formula (I), or a salt of a conjugate acid of a compound of formula (I):

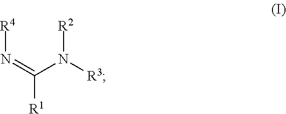

wherein each of R¹, R², R³, and R⁴ is independently selected from hydrogen, (C₁-C₂₀)alkyl, (C₁-C₂₀)alkoxy, (C₂-C₂₀)alkenyl, (C₂-C₂₀)alkenyloxy, (C₂-C₂₀)alkynyl, (C₂-C₂₀)alkynyloxy, aryl, aryloxy, heteroaryl, heteroaryloxy, heterocyclyl, heterocyclyloxy, aryl(C₁-C₄)alkyl, (C₁-C₄)alkylaryl(C₁-C₄)alkyl, heteroaryl(C₁-C₄)alkyl, (C₁-C₄)alkylheteroaryl(C₁-C₄)alkyl, heterocyclyl(C₁-C₄)alkyl, and (C₁-C₄)alkylheterocyclyl(C₁-C₄)alkyl, each of which is optionally substituted with alkoxy, hydroxy, amino, or N-substituted amino, or any two of R¹, R², R³, and R⁴, taken together with the carbon and/or nitrogen to which the two of R¹, R², R³, and R⁴ are respectively bonded, form a heterocyclic or heteroaryl ring that is optionally substituted with alkoxy, hydroxy, amino, or N-substituted amino; and provided that R¹, R², R³, and R⁴ are not all simultaneously hydrogen.

A fifty-fourth aspect relates to the geopolymer composition of aspects 50 to 52, wherein the organic base comprises a compound of formula (II), or a salt of a conjugate acid of a compound of formula (II):

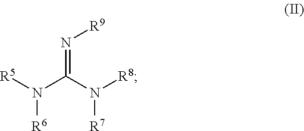

wherein each of R⁵, R⁶, R⁷, R⁸, and R⁹ is independently selected from hydrogen, (C₁-C₂₀)alkyl, (C₁-C₂₀)alkoxy, (C₂-C₂₀)alkenyl, (C₂-C₂₀)alkenyloxy, (C₂-C₂₀)alkynyl, (C₂-C₂₀)alkynyloxy, aryl, aryloxy, heteroaryl, heteroaryloxy, heterocyclyl, heterocyclyloxy, aryl(C₁-C₄)alkyl, (C₁-C₄)alkylaryl(C₁-C₄)alkyl, heteroaryl(C₁-C₄)alkyl, (C₁-C₄)alkylheteroaryl(C₁-C₄)alkyl, heterocyclyl(C₁-C₄)alkyl, and (C₁-C₄)alkylheterocyclyl(C₁-C₄)alkyl, each of which is optionally substituted with alkoxy, hydroxy, amino, or N-substituted amino; and wherein any two of R⁵, R⁶, R⁷, R⁸, and R⁹, taken together with nitrogen to which the two of R⁵, R⁶, R⁷, R⁸, and R⁹ are bonded and optionally carbon, optionally form a heterocyclic or heteroaryl ring that is optionally substituted with alkoxy, hydroxy, amino, or N-substituted amino.

A fifty-fifth aspect relates to the geopolymer composition of aspects 50 to 52, wherein the organic base comprises a compound of formula (III) or a salt thereof:

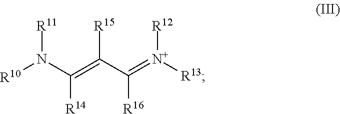

wherein each of R¹⁰, R¹¹, R¹², R¹³, R¹⁴, R¹⁵, and R¹⁶ is independently selected from hydrogen, (C₁-C₂₀)alkyl, (C₁-C₂₀)alkoxy, (C₂-C₂₀)alkenyl, (C₂-C₂₀)alkenyloxy, (C₂-C₂₀)alkynyl, (C₂-C₂₀)alkynyloxy, aryl, aryloxy, heteroaryl, heteroaryloxy, heterocyclyl, heterocyclyloxy, aryl(C₁-C₄)alkyl, (C₁-C₄)alkylaryl(C₁-C₄)alkyl, heteroaryl(C₁-C₄)alkyl, (C₁-C₄)alkylheteroaryl(C₁-C₄)alkyl, heterocyclyl(C₁-C₄)alkyl, and (C₁-C₄)alkylheterocyclyl(C₁-C₄)alkyl, each of which is optionally substituted with alkoxy, hydroxy, amino, or N-substituted amino; wherein R¹⁵, and one of R¹¹ or R¹⁵, taken together with the carbons and nitrogen between R¹⁵, and the one of R¹¹ or R¹², optionally form a heterocyclic or heteroaryl ring; wherein R¹⁰ and R¹¹ and/or R¹² and R¹³, taken together with nitrogen, optionally form a heterocyclic or heteroaryl ring; wherein R¹⁴, and one of R¹⁰ or R¹¹, and/or R¹⁶, and one of R¹² and R¹³, taken together with carbon and nitrogen, optionally form a heterocyclic ring; wherein R¹⁴ and R¹⁶, taken together with the carbons between R¹⁴ and R¹⁶, optionally form a carbocyclic or heterocyclic ring; provided that R¹⁰ and R¹¹ are not simultaneously hydrogen; and provided that R¹² and R¹³ are not simultaneously hydrogen.

A fifty-sixth aspect relates to the geopolymer composition of aspects 50 to 52, wherein the organic base comprises a compound of formula (IV) or a salt thereof:

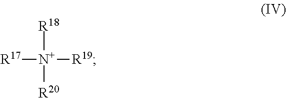

wherein each of R¹⁷, R¹⁸, R¹⁹, and R²⁰ is independently selected from (C₁-C₂₀)alkyl, (C₁-C₂₀)alkoxy, (C₂-C₂₀)alkenyl, (C₂-C₂₀)alkenyloxy, (C₂-C₂₀)alkynyl, (C₂-C₂₀)alkynyloxy, aryl, aryloxy, heteroaryl, heteroaryloxy, heterocyclyl, heterocyclyloxy, aryl(C₁-C₄)alkyl, (C₁-C₄)alkylaryl(C₁-C₄)alkyl, heteroaryl(C₁-C₄)alkyl, (C₁-C₄)alkylheteroaryl(C₁-C₄)alkyl, heterocyclyl(C₁-C₄)alkyl, and (C₁-C₄)alkylheterocyclyl(C₁-C₄)alkyl, each of which is optionally substituted with alkoxy, hydroxy, amino, or N-substituted amino; and wherein any two of R¹⁷, R¹⁸, R¹⁹, and R²⁰, taken together with nitrogen, optionally form a heterocyclic or heteroaryl ring.

A fifty-seventh aspect relates to the geopolymer composition of aspects 50 to 52, wherein the organic base comprises a compound of formula (V) or a salt of a conjugate acid of a compound of formula (V):

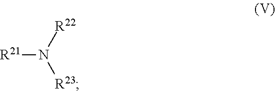

wherein each of R²¹, R²², and R²³ is independently selected from (C₁-C₂₀)alkyl, (C₁-C₂₀)alkoxy, (C₂-C₂₀)alkenyl, (C₂-C₂₀)alkenyloxy, (C₂-C₂₀)alkynyl, (C₂-C₂₀)alkynyloxy, aryl, aryloxy, heteroaryl, heteroaryloxy, heterocyclyl, heterocyclyloxy, aryl(C₁-C₄)alkyl, (C₁-C₄)alkylaryl(C₁-C₄)alkyl, heteroaryl(C₁-C₄)alkyl, (C₁-C₄)alkylheteroaryl(C₁-C₄)alkyl, heterocyclyl(C₁-C₄)alkyl, and (C₁-C₄)alkylheterocyclyl(C₁-C₄)alkyl, each of which is optionally substituted with alkoxy, hydroxy, amino, or N-substituted amino; and wherein any two of R²¹, R²², and R²³, taken together with nitrogen, optionally form a heterocyclic or heteroaryl ring.

A fifty-eighth aspect relates to the geopolymer composition of aspects 50 to 52, wherein the organic base comprises a compound of formula (VI) or a salt of a compound of formula (VI):

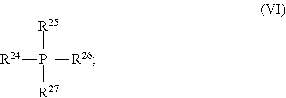

wherein each of R²⁴, R²⁵, R²⁶, and R²⁷ is independently selected from (C₁-C₂₀)alkyl, (C₁-C₂₀)alkoxy, (C₂-C₂₀)alkenyl, (C₂-C₂₀)alkenyloxy, (C₂-C₂₀)alkynyl, (C₂-C₂₀)alkynyloxy, aryl, aryloxy, heteroaryl, heteroaryloxy, heterocyclyl, heterocyclyloxy, aryl(C₁-C₄)alkyl, (C₁-C₄)alkylaryl(C₁-C₄)alkyl, heteroaryl(C₁-C₄)alkyl, (C₁-C₄)alkylheteroaryl(C₁-C₄)alkyl, heterocyclyl(C₁-C₄)alkyl, and (C₁-C₄)alkylheterocyclyl(C₁-C₄)alkyl, each of which is optionally substituted with alkoxy, hydroxy, amino, or N-substituted amino; and wherein any two of R²⁴, R²⁵, R²⁶, and R²⁷, taken together with phosphorus, optionally form a heterocyclic ring.

A fifty-ninth aspect relates to the geopolymer composition of aspects 50 to 52, wherein the organic base comprises a compound of formula (VII) or a salt of a conjugate acid of formula (VII):

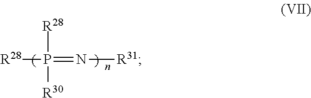

wherein each of R²⁸, R²⁹, and R³⁰ is N(R³²)₂ or N═P(N(R³³)₂)₃; wherein R³¹, each R³², and each R³³ are independently selected from hydrogen, (C₁-C₂₀)alkyl, (C₁-C₂₀)alkoxy, (C₂-C₂₀)alkenyl, (C₂-C₂₀)alkenyloxy, (C₂-C₂₀)alkynyl, (C₂-C₂₀)alkynyloxy, aryl, aryloxy, heteroaryl, heteroaryloxy, heterocyclyl, heterocyclyloxy, aryl(C₁-C₄)alkyl, (C₁-C₄)alkylaryl(C₁-C₄)alkyl, heteroaryl(C₁-C₄)alkyl, (C₁-C₄)alkylheteroaryl(C₁-C₄)alkyl, heterocyclyl(C₁-C₄)alkyl, and (C₁-C₄)alkylheterocyclyl(C₁-C₄)alkyl, each of which is optionally substituted with alkoxy, hydroxy, amino, or N-substituted amino; and wherein any two of R²⁸, R²⁹, and R³⁰, and/or any two R³², and/or any two R³³, taken together with nitrogen, may form a heterocyclic ring.

A sixtieth aspect relates to the geopolymer composition of aspects 50 to 59, wherein the organic base comprises formamidine, acetamidine, 1,8-diazabicyclo[5.4.0]undec-7-ene, tetramethylguanidine, guanidine, tetramethylammonium, 1,8-bis(dimethylamino)naphthalene, diphenyldimethylphosphonium, P3 phosphazene, t-Bu-P₄, 2-tert-butylimino-2-diethylamino-1,3-dimethylperhydro-1,3,2-diazaphosphorine, a conjugate acid thereof, a salt thereof, or any combination thereof.

A sixty-first aspect relates to the geopolymer composition of aspects 52 to 60, wherein the salt is a hydroxide or carbonate salt.

A sixty-second aspect relates to the geopolymer composition of aspects 50 to 61, further comprising water.

A sixty-third aspect relates to the geopolymer composition of aspects 50 to 62 that is free of alkali metal species.

A sixty-fourth aspect relates to the geopolymer composition of aspects 50 to 63 that is free of calcium.

A sixty-fifth aspect relates to a cured composition formed from the geopolymer composition of aspects 50 to 64.

A sixty-sixth aspect relates to a ceramic, comprising the geopolymer composition of aspects 50 to 64.

A sixty-seventh aspect relates to the ceramic of aspect 66, comprising cordierite.

A sixty-eighth aspect relates to the ceramic of aspect 66, comprising a mixed yttrium and aluminum silicate.

A sixty-ninth aspect relates to the ceramic of aspect 66, comprising yttrium disilicate.

A seventieth aspect relates to the ceramic of aspect 66, comprising willemite.

A seventy-first aspect relates to a coating comprising the geopolymer composition of aspects 50 to 64.

A seventy-second aspect relates to a three-dimensional printing resin comprising the geopolymer composition of aspects 50 to 64.

A seventy-third aspect relates to a method of making the geopolymer composition of aspects 50 to 64, comprising mixing the silicate with the organic base to provide the geopolymer composition.

A seventy-fourth aspect relates to the method of aspect 73, further comprising dissolving the organic base in water to provide an aqueous solution of the organic base prior to the mixing.

A seventy-fifth aspect relates to the method of aspect 74, further comprising dissolving silica in the aqueous solution of the organic base prior to the mixing.

A seventy-sixth aspect relates to the method of aspects 73 to 75, further comprising forming the geopolymer composition into a desired shape to provide a set geopolymer composition.

A seventy-seventh aspect relates to the method of aspect 76, further comprising curing the set geopolymer composition to provide a cured geopolymer composition.

A seventy-eighth aspect relates to the method of aspect 77, wherein the curing is at a temperature of from about 5° C. to about 90° C. for a period of up to 1 day.

A seventy-ninth aspect relates to the method of aspect 78, wherein the curing is for a period of up to 3 days.

An eightieth aspect relates a method of making a ceramic from the cured geopolymer composition of aspect 65, comprising heating the cured geopolymer at a temperature of at least about 1000° C. for at least about 1 hour.

An eighty-first aspect relates to the method of aspect 80, wherein the ceramic comprises cordierite.

An eighty-second aspect relates to the method of aspect 80, wherein the ceramic comprises a mixed yttrium and aluminum silicate.

An eighty-third aspect relates to the method of aspect 80, wherein the ceramic comprises yttrium disilicate.

An eighty-fourth aspect relates to the method of aspect 80, wherein the ceramic comprises willemite.

An eighty-fifth aspect relates to a method of making an alkali-free ceramic, comprising: mixing an aqueous solution of an organic base with a silicate of magnesium, zinc, aluminum, and/or one or more rare earth elements to provide a geopolymer composition; forming the geopolymer composition into a desired shape to provide a set geopolymer composition; curing the set geopolymer composition to provide a cured geopolymer composition; and heating the cured geopolymer composition to provide the alkali-free ceramic.

An eighty-sixth aspect relates to the method of aspect 85, wherein the one or more rare earth elements is yttrium.

An eighty-seventh aspect relates to the method of aspect 85 or 86, further comprising dissolving silica in the aqueous solution of the organic base prior to the mixing.

An eighty-eighth aspect relates to the method of aspects 85 to 87, wherein the organic base comprises an amidine, a guanidine, a vinamidine, a tetra-substituted ammonium species, an amine, a phosphazene, a tetra-substituted phosphonium species, a conjugate acid thereof, a salt thereof, or any combination thereof.

An eighty-ninth aspect relates to the method of aspects 85 to 88, wherein the organic base comprises a compound of formula (I), or a salt of a conjugate acid of a compound of formula (I):

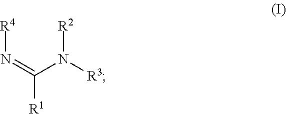

wherein each of R¹, R², R³, and R⁴ is independently selected from hydrogen, (C₁-C₂₀)alkyl, (C₁-C₂₀)alkoxy, (C₂-C₂₀)alkenyl, (C₂-C₂₀)alkenyloxy, (C₂-C₂₀)alkynyl, (C₂-C₂₀)alkynyloxy, aryl, aryloxy, heteroaryl, heteroaryloxy, heterocyclyl, heterocyclyloxy, aryl(C₁-C₄)alkyl, (C₁-C₄)alkylaryl(C₁-C₄)alkyl, heteroaryl(C₁-C₄)alkyl, (C₁-C₄)alkylheteroaryl(C₁-C₄)alkyl, heterocyclyl(C₁-C₄)alkyl, and (C₁-C₄)alkylheterocyclyl(C₁-C₄)alkyl, each of which is optionally substituted with alkoxy, hydroxy, amino, or N-substituted amino, or any two of R¹, R², R³, and R⁴, taken together with the carbon and/or nitrogen to which the two of R¹, R², R³, and R⁴ are respectively bonded, form a heterocyclic or heteroaryl ring that is optionally substituted with alkoxy, hydroxy, amino, or N-substituted amino; and provided that R¹, R², R³, and R⁴ are not all simultaneously hydrogen.

A ninetieth aspect relates to the method of aspects 85 to 88, wherein the organic base comprises a compound of formula (II), or a salt of a conjugate acid of a compound of formula (II):

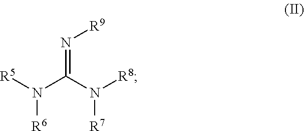

wherein each of R⁵, R⁶, R⁷, R⁸, and R⁹ is independently selected from hydrogen, (C₁-C₂₀)alkyl, (C₁-C₂₀)alkoxy, (C₂-C₂₀)alkenyl, (C₂-C₂₀)alkenyloxy, (C₂-C₂₀)alkynyl, (C₂-C₂₀)alkynyloxy, aryl, aryloxy, heteroaryl, heteroaryloxy, heterocyclyl, heterocyclyloxy, aryl(C₁-C₄)alkyl, (C₁-C₄)alkylaryl(C₁-C₄)alkyl, heteroaryl(C₁-C₄)alkyl, (C₁-C₄)alkylheteroaryl(C₁-C₄)alkyl, heterocyclyl(C₁-C₄)alkyl, and (C₁-C₄)alkylheterocyclyl(C₁-C₄)alkyl, each of which is optionally substituted with alkoxy, hydroxy, amino, or N-substituted amino; and wherein any two of R⁵, R⁶, R⁷, R⁸, and R⁹, taken together with nitrogen to which the two of R⁵, R⁶, R⁷, R⁸, and R⁹ are bonded and optionally carbon, optionally form a heterocyclic or heteroaryl ring that is optionally substituted with alkoxy, hydroxy, amino, or N-substituted amino.

A ninety-first aspect relates to the method of aspects 85 to 88, wherein the organic base comprises a compound of formula (III) or a salt thereof:

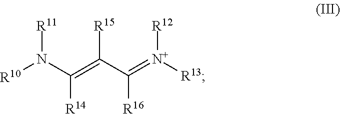

wherein each of R¹⁰, R¹¹, R¹², R¹³, R¹⁴, R¹⁵, and R¹⁶ is independently selected from hydrogen, (C₁-C₂₀)alkyl, (C₁-C₂₀)alkoxy, (C₂-C₂₀)alkenyl, (C₂-C₂₀)alkenyloxy, (C₂-C₂₀)alkynyl, (C₂-C₂₀)alkynyloxy, aryl, aryloxy, heteroaryl, heteroaryloxy, heterocyclyl, heterocyclyloxy, aryl(C₁-C₄)alkyl, (C₁-C₄)alkylaryl(C₁-C₄)alkyl, heteroaryl(C₁-C₄)alkyl, (C₁-C₄)alkylheteroaryl(C₁-C₄)alkyl, heterocyclyl(C₁-C₄)alkyl, and (C₁-C₄)alkylheterocyclyl(C₁-C₄)alkyl, each of which is optionally substituted with alkoxy, hydroxy, amino, or N-substituted amino; wherein R¹⁵, and one of R¹¹ or R¹⁵, taken together with the carbons and nitrogen between R¹⁵, and the one of R¹¹ or R¹², optionally form a heterocyclic or heteroaryl ring; wherein R¹⁰ and R¹¹ and/or R¹² and R¹³, taken together with nitrogen, optionally form a heterocyclic or heteroaryl ring; wherein R¹⁴, and one of R¹⁰ or R¹¹, and/or R¹⁶, and one of R¹² and R¹³, taken together with carbon and nitrogen, optionally form a heterocyclic ring; wherein R¹⁴ and R¹⁶, taken together with the carbons between R¹⁴ and R¹⁶, optionally form a carbocyclic or heterocyclic ring; provided that R¹⁰ and R¹¹ are not simultaneously hydrogen; and provided that R¹² and R¹³ are not simultaneously hydrogen.

A ninety-second aspect relates to the method of aspects 85 to 88, wherein the organic base comprises a compound of formula (IV) or a salt thereof:

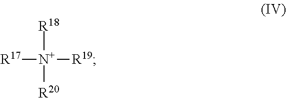

wherein each of R¹⁷, R¹⁸, R¹⁹, and R²⁰ is independently selected from (C₁-C₂₀)alkyl, (C₁-C₂₀)alkoxy, (C₂-C₂₀)alkenyl, (C₂-C₂₀)alkenyloxy, (C₂-C₂₀)alkynyl, (C₂-C₂₀)alkynyloxy, aryl, aryloxy, heteroaryl, heteroaryloxy, heterocyclyl, heterocyclyloxy, aryl(C₁-C₄)alkyl, (C₁-C₄)alkylaryl(C₁-C₄)alkyl, heteroaryl(C₁-C₄)alkyl, (C₁-C₄)alkylheteroaryl(C₁-C₄)alkyl, heterocyclyl(C₁-C₄)alkyl, and (C₁-C₄)alkylheterocyclyl(C₁-C₄)alkyl, each of which is optionally substituted with alkoxy, hydroxy, amino, or N-substituted amino; and wherein any two of R¹⁷, R¹⁸, R¹⁹, and R²⁰, taken together with nitrogen, optionally form a heterocyclic or heteroaryl ring.

A ninety-third aspect relates to the method of aspects 85 to 88, wherein the organic base comprises a compound of formula (V) or a salt of a conjugate acid of a compound of formula (V):

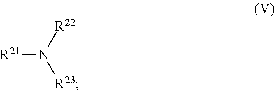

wherein each of R²¹, R²², and R²³ is independently selected from (C₁-C₂₀)alkyl, (C₁-C₂₀)alkoxy, (C₂-C₂₀)alkenyl, (C₂-C₂₀)alkenyloxy, (C₂-C₂₀)alkynyl, (C₂-C₂₀)alkynyloxy, aryl, aryloxy, heteroaryl, heteroaryloxy, heterocyclyl, heterocyclyloxy, aryl(C₁-C₄)alkyl, (C₁-C₄)alkylaryl(C₁-C₄)alkyl, heteroaryl(C₁-C₄)alkyl, (C₁-C₄)alkylheteroaryl(C₁-C₄)alkyl, heterocyclyl(C₁-C₄)alkyl, and (C₁-C₄)alkylheterocyclyl(C₁-C₄)alkyl, each of which is optionally substituted with alkoxy, hydroxy, amino, or N-substituted amino; and wherein any two of R²¹, R²², and R²³, taken together with nitrogen, optionally form a heterocyclic or heteroaryl ring.

A ninety-fourth aspect relates to the method of aspects 85 to 88, wherein the organic base comprises a compound of formula (VI) or a salt of a compound of formula (VI):

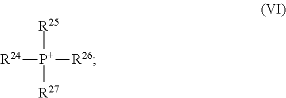

wherein each of R²⁴, R²⁵, R²⁶, and R²⁷ is independently selected from (C₁-C₂₀)alkyl, (C₁-C₂₀)alkoxy, (C₂-C₂₀)alkenyl, (C₂-C₂₀)alkenyloxy, (C₂-C₂₀)alkynyl, (C₂-C₂₀)alkynyloxy, aryl, aryloxy, heteroaryl, heteroaryloxy, heterocyclyl, heterocyclyloxy, aryl(C₁-C₄)alkyl, (C₁-C₄)alkylaryl(C₁-C₄)alkyl, heteroaryl(C₁-C₄)alkyl, (C₁-C₄)alkylheteroaryl(C₁-C₄)alkyl, heterocyclyl(C₁-C₄)alkyl, and (C₁-C₄)alkylheterocyclyl(C₁-C₄)alkyl, each of which is optionally substituted with alkoxy, hydroxy, amino, or N-substituted amino; and wherein any two of R²⁴, R²⁵, R²⁶, and R²⁷, taken together with phosphorus, optionally form a heterocyclic ring.

A ninety-fifth aspect relates to the method of aspects 85 to 88, wherein the organic base comprises a compound of formula (VII) or a salt of a conjugate acid of formula (VII):

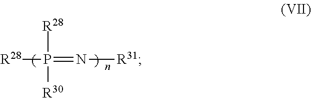

wherein each of R²⁸, R²⁹, and R³⁰ is N(R³²)₂ or N═P(N(R³³)₂)₃; wherein R³¹, each R³², and each R³³ are independently selected from hydrogen, (C₁-C₂₀)alkyl, (C₁-C₂₀)alkoxy, (C₂-C₂₀)alkenyl, (C₂-C₂₀)alkenyloxy, (C₂-C₂₀)alkynyl, (C₂-C₂₀)alkynyloxy, aryl, aryloxy, heteroaryl, heteroaryloxy, heterocyclyl, heterocyclyloxy, aryl(C₁-C₄)alkyl, (C₁-C₄)alkylaryl(C₁-C₄)alkyl, heteroaryl(C₁-C₄)alkyl, (C₁-C₄)alkylheteroaryl(C₁-C₄)alkyl, heterocyclyl(C₁-C₄)alkyl, and (C₁-C₄)alkylheterocyclyl(C₁-C₄)alkyl, each of which is optionally substituted with alkoxy, hydroxy, amino, or N-substituted amino; and wherein any two of R²⁸, R²⁹, and R³⁰, and/or any two R³², and/or any two R³³, taken together with nitrogen, may form a heterocyclic ring.

A ninety-sixth aspect relates to the method of aspects 85 to 95, wherein the organic base comprises formamidine, acetamidine, 1,8-diazabicyclo[5.4.0]undec-7-ene, tetramethylguanidine, guanidine, tetramethylammonium, 1,8-bis(dimethylamino)naphthalene, diphenyldimethylphosphonium, P3 phosphazene, t-Bu-P₄, 2-tert-butylimino-2-diethylamino-1,3-dimethylperhydro-1,3,2-diazaphosphorine, a conjugate acid thereof, a salt thereof, or any combination thereof.

A ninety-seventh aspect relates to the method of aspects 88 to 96, wherein the salt is a hydroxide or carbonate salt.

A ninety-eighth aspect relates to the method of aspects 85 to 97, wherein the ceramic is free of calcium.

A ninety-ninth aspect relates to the method of aspects 85 to 98 that is free of ion exchange.

A one hundredth aspect relates to the method of aspects 85 to 99, wherein the forming comprises applying the geopolymer composition as a coating that is the set geopolymer composition.

A one hundred first aspect relates to the method of aspects 85 to 99, wherein the forming comprises three-dimensionally printing the desired shape.

A one hundred second aspect relates to the method of aspects 85 to 99, wherein the forming comprises extruding the desired shape.

A one hundred third aspect relates to the method of aspects 85 to 102, wherein the curing is at a temperature of from about 5° C. to about 90° C. for a period of at least 1 day.

A one hundred fourth aspect relates to the method of aspects 85 to 103, wherein the heating is at a temperature of at least about 1000° C. for at least about 1 hour.

A one hundred fifth aspect relates to the method of aspects 85 to 104, wherein the ceramic comprises cordierite.

A one hundred sixth aspect relates to the method of aspects 85 to 104, wherein the ceramic comprises mixed yttrium and aluminum silicate.

A one hundred seventh aspect relates to the method of aspects 85 to 104, wherein the ceramic comprises yttrium disilicate.

A one hundred eighth aspect relates to the method of aspects 85 to 104, wherein the ceramic comprises willemite.

In addition to the features mentioned in each of the independent aspects enumerated above, some examples may show, alone or in combination, the optional features mentioned in the dependent aspects and/or as disclosed in the description above and shown in the figures.

What is claimed is:

1. A geopolymer composition, comprising:
an organic base; and
an aluminosilicate.

2. The geopolymer composition of claim 1, wherein the organic base comprises an amidine, a guanidine, a vinamidine, a tetra-substituted ammonium species, an amine, a phosphazene, a tetra-substituted phosphonium species, a conjugate acid thereof, a salt thereof, or any combination thereof.

3. The geopolymer composition of claim 1, wherein the organic base comprises:
a compound of formula (I), (II), (III), (IV), (V), (VI), or (VII), or a salt of a conjugate acid of a compound of formula (I), (II), (V), or (VII), or a salt of a compound of formula (III), (IV), or (VI): 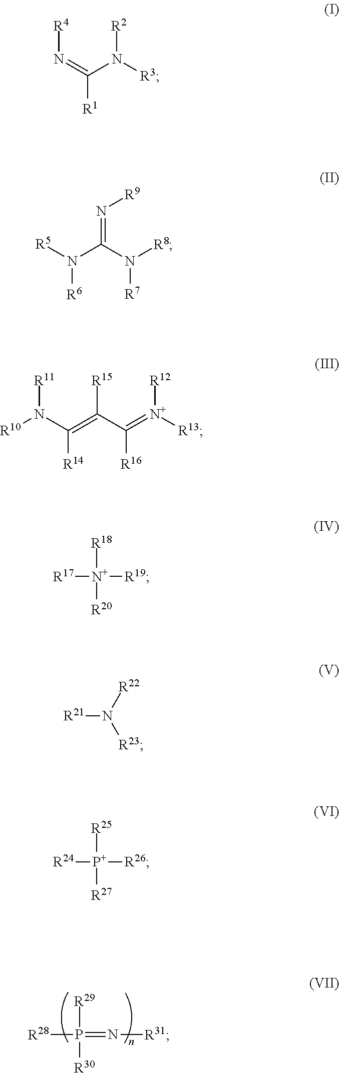
wherein each of R¹, R², R³, and R⁴ is independently selected from hydrogen, (C₁-C₂₀)alkyl, (C₁-C₂₀)alkoxy, (C₂-C₂₀)alkenyl, (C₂-C₂₀)alkenyloxy, (C₂-C₂₀)alkynyl, (C₂-C₂₀)alkynyloxy, aryl, aryloxy, heteroaryl, heteroaryloxy, heterocyclyl, heterocyclyloxy, aryl(C₁-C₄)alkyl, (C₁-C₄)alkylaryl(C₁-C₄)alkyl, heteroaryl(C₁-C₄)alkyl, (C₁-C₄)alkylheteroaryl(C₁-C₄)alkyl, heterocyclyl(C₁-C₄)alkyl, and (C₁-C₄)alkylheterocyclyl(C₁-C₄)alkyl, each of which is optionally substituted with alkoxy, hydroxy, amino, or N-substituted amino; or any two of R¹, R², R³, and R⁴, taken together with the carbon and/or nitrogen to which the two of R¹, R², R³, and R⁴ are respectively bonded, form a heterocyclic or heteroaryl ring that is optionally substituted with alkoxy, hydroxy, amino, or N-substituted amino;
provided that R¹, R², R³, and R⁴ are not all simultaneously hydrogen;
wherein each of R⁵, R⁶, R⁷, R⁸, and R⁹ is independently selected from hydrogen, (C₁-C₂₀)alkyl, (C₁-C₂₀)alkoxy, (C₂-C₂₀)alkenyl, (C₂-C₂₀)alkenyloxy, (C₂-C₂₀)alkynyl, (C₂-C₂₀)alkynyloxy, aryl, aryloxy, heteroaryl, heteroaryloxy, heterocyclyl, heterocyclyloxy, aryl(C₁-C₄)alkyl, (C₁-C₄)alkylaryl(C₁-C₄)alkyl, heteroaryl(C₁-C₄)alkyl, (C₁-C₄)alkylheteroaryl(C₁-C₄)alkyl, heterocyclyl(C₁-C₄)alkyl, and (C₁-C₄)alkylheterocyclyl(C₁-C₄)alkyl, each of which is optionally substituted with alkoxy, hydroxy, amino, or N-substituted amino;
wherein any two of R⁵, R⁶, R⁷, R⁸, and R⁹, taken together with nitrogen to which the two of R⁵, R⁶, R⁷, R⁸, and R⁹ are bonded and optionally carbon, optionally form a heterocyclic or heteroaryl ring that is optionally substituted with alkoxy, hydroxy, amino, or N-substituted amino;
wherein each of R¹⁰, R^{D}, R¹², R¹³, R¹⁴, R¹⁵, and R¹⁶ is independently selected from hydrogen, (C₁-C₂₀)alkyl, (C₁-C₂₀)alkoxy, (C₂-C₂₀)alkenyl, (C₂-C₂₀)alkenyloxy, (C₂-C₂₀)alkynyl, (C₂-C₂₀)alkynyloxy, aryl, aryloxy, heteroaryl, heteroaryloxy, heterocyclyl, heterocyclyloxy, aryl(C₁-C₄)alkyl, (C₁-C₄)alkylaryl(C₁-C₄)alkyl, heteroaryl(C₁-C₄)alkyl, (C₁-C₄)alkylheteroaryl(C₁-C₄)alkyl, heterocyclyl(C₁-C₄)alkyl, and (C₁-C₄)alkylheterocyclyl(C₁-C₄)alkyl, each of which is optionally substituted with alkoxy, hydroxy, amino, or N-substituted amino;
wherein R¹⁵, and one of R¹¹ or R¹⁵, taken together with the carbons and nitrogen between R¹⁵, and the one of R¹¹ or R¹², optionally form a heterocyclic or heteroaryl ring;
wherein R¹⁰ and R¹¹ and/or R¹² and R¹³, taken together with nitrogen, optionally form a heterocyclic or heteroaryl ring;
wherein R¹⁴, and one of R¹⁰ or R¹¹, and/or R¹⁶, and one of R¹² and R¹³, taken together with carbon and nitrogen, optionally form a heterocyclic ring;
wherein R¹⁴ and R¹⁶, taken together with the carbons between R¹⁴ and R¹⁶, optionally form a carbocyclic or heterocyclic ring;
provided that R¹⁰ and R¹¹ are not simultaneously hydrogen;
provided that R¹² and R¹³ are not simultaneously hydrogen;
wherein each of R¹⁷, R¹⁸, R¹⁹, and R²⁰ is independently selected from (C₁-C₂₀)alkyl, (C₁-C₂₀)alkoxy, (C₂-C₂₀)alkenyl, (C₂-C₂₀)alkenyloxy, (C₂-C₂₀)alkynyl, (C₂-C₂₀)alkynyloxy, aryl, aryloxy, heteroaryl, heteroaryloxy, heterocyclyl, heterocyclyloxy, aryl(C₁-C₄)alkyl, (C₁-C₄)alkylaryl(C₁-C₄)alkyl, heteroaryl(C₁-C₄)alkyl, (C₁-C₄)alkylheteroaryl(C₁-C₄)alkyl, heterocyclyl(C₁-C₄)alkyl, and (C₁-C₄)alkylheterocyclyl(C₁-C₄)alkyl, each of which is optionally substituted with alkoxy, hydroxy, amino, or N-substituted amino;
wherein any two of R¹⁷, R¹⁸, R¹⁹, and R²⁰, taken together with nitrogen, optionally form a heterocyclic or heteroaryl ring;
wherein each of R²¹, R²², and R²³ is independently selected from (C₁-C₂₀)alkyl, (C₁-C₂₀)alkoxy, (C₂-C₂₀)alkenyl, (C₂-C₂₀)alkenyloxy, (C₂-C₂₀)alkynyl, (C₂-C₂₀)alkynyloxy, aryl, aryloxy, heteroaryl, heteroaryloxy, heterocyclyl, heterocyclyloxy, aryl(C₁-C₄)alkyl, (C₁-C₄)alkylaryl(C₁-C₄)alkyl, heteroaryl(C₁-C₄)alkyl, (C₁-C₄)alkylheteroaryl(C₁-C₄)alkyl, heterocyclyl(C₁-C₄)alkyl, and (C₁-C₄)alkylheterocyclyl(C₁-C₄)alkyl, each of which is optionally substituted with alkoxy, hydroxy, amino, or N-substituted amino;
wherein any two of R²¹, R²², and R²³, taken together with nitrogen, optionally form a heterocyclic or heteroaryl ring;
wherein each of R²⁴, R²⁵, R²⁶, and R²⁷ is independently selected from (C₁-C₂₀)alkyl, (C₁-C₂₀)alkoxy, (C₂-C₂₀)alkenyl, (C₂-C₂₀)alkenyloxy, (C₂-C₂₀)alkynyl, (C₂-C₂₀)alkynyloxy, aryl, aryloxy, heteroaryl, heteroaryloxy, heterocyclyl, heterocyclyloxy, aryl(C₁-C₄)alkyl, (C₁-C₄)alkylaryl(C₁-C₄)alkyl, heteroaryl(C₁-C₄)alkyl, (C₁-C₄)alkylheteroaryl(C₁-C₄)alkyl, heterocyclyl(C₁-C₄)alkyl, and (C₁-C₄)alkylheterocyclyl(C₁-C₄)alkyl, each of which is optionally substituted with alkoxy, hydroxy, amino, or N-substituted amino;
wherein any two of R²⁴, R²⁵, R²⁶, and R²⁷, taken together with phosphorus, optionally form a heterocyclic ring;
wherein each of R²⁸, R²⁹, and R³¹ is N(R³²)₂ or N═P(N(R³³)₂)₃;
wherein R³¹, each R³², and each R³³ are independently selected from hydrogen, (C₁-C₂₀)alkyl, (C₁-C₂₀)alkoxy, (C₂-C₂₀)alkenyl, (C₂-C₂₀)alkenyloxy, (C₂-C₂₀)alkynyl, (C₂-C₂₀)alkynyloxy, aryl, aryloxy, heteroaryl, heteroaryloxy, heterocyclyl, heterocyclyloxy, aryl(C₁-C₄)alkyl, (C₁-C₄)alkylaryl(C₁-C₄)alkyl, heteroaryl(C₁-C₄)alkyl, (C₁-C₄)alkylheteroaryl(C₁-C₄)alkyl, heterocyclyl(C₁-C₄)alkyl, and (C₁-C₄)alkylheterocyclyl(C₁-C₄)alkyl, each of which is optionally substituted with alkoxy, hydroxy, amino, or N-substituted amino; and
wherein any two of R²⁸, R²⁹, and R³⁰, and/or any two R³², and/or any two R³³, taken together with nitrogen, may form a heterocyclic ring.

4. The geopolymer composition of claim 1 that is free of alkali metal species.

5. The geopolymer composition of claim 1 that is free of calcium.

6. A cured composition formed from the geopolymer composition of claim 1.

7. A ceramic, comprising the geopolymer composition of claim 1.

8. The ceramic of claim 7, comprising mullite.

9. A coating or a three-dimensional printing resin comprising the geopolymer composition of claim 1.

10. A method of making an alkali-free ceramic, comprising:
mixing an aqueous solution of an organic base with an aluminosilicate to provide a geopolymer composition;
forming the geopolymer composition into a desired shape to provide a set geopolymer composition;
curing the set geopolymer composition to provide a cured geopolymer composition; and
heating the cured geopolymer composition to provide the alkali-free ceramic.

11. The method of claim 10, further comprising dissolving silica in the aqueous solution of the organic base prior to the mixing.

12. The method of claim 10, wherein the aluminosilicate comprises a molar ratio of Al₂O₃ to SiO₂ of from about 1:5 to about 5:1.

13. The method of claim 10, wherein the curing is at a temperature of from about 5° C. to about 90° C. for a period of up to 1 month.

14. The method of claim 10, wherein the heating is at a temperature of at least about 300° C. for at least about 4 hours.

15. A geopolymer composition, comprising:
an organic base; and
a silicate of magnesium, zinc, aluminum, and/or one or more rare earth elements.

16. The geopolymer composition of claim 15, wherein the one or more rare earth elements is yttrium.

17. The geopolymer composition of claim 15, wherein the organic base comprises an amidine, a guanidine, a vinamidine, a tetra-substituted ammonium species, an amine, a phosphazene, a tetra-substituted phosphonium species, a conjugate acid thereof, a salt thereof, or any combination thereof.

18. The geopolymer composition of claim 15, wherein the organic base comprises:
a compound of formula (I), (II), (III), (IV), (V), (VI), or (VII), or a salt of a conjugate acid of a compound of formula (I), (II), (V), or (VII), or a salt of a compound of formula (III), (IV), or (VI): 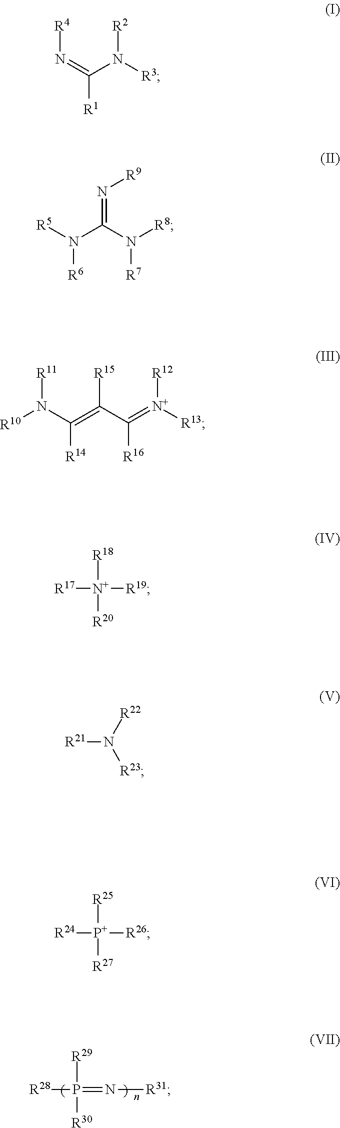
wherein each of R¹, R², R³, and R⁴ is independently selected from hydrogen, (C₁-C₂₀)alkyl, (C₁-C₂₀)alkoxy, (C₂-C₂₀)alkenyl, (C₂-C₂₀)alkenyloxy, (C₂-C₂₀)alkynyl, (C₂-C₂₀)alkynyloxy, aryl, aryloxy, heteroaryl, heteroaryloxy, heterocyclyl, heterocyclyloxy, aryl(C₁-C₄)alkyl, (C₁-C₄)alkylaryl(C₁-C₄)alkyl, heteroaryl(C₁-C₄)alkyl, (C₁-C₄)alkylheteroaryl(C₁-C₄)alkyl, heterocyclyl(C₁-C₄)alkyl, and (C₁-C₄)alkylheterocyclyl(C₁-C₄)alkyl, each of which is optionally substituted with alkoxy, hydroxy, amino, or N-substituted amino; or any two of R¹, R², R³, and R⁴, taken together with the carbon and/or nitrogen to which the two of R¹, R², R³, and R⁴ are respectively bonded, form a heterocyclic or heteroaryl ring that is optionally substituted with alkoxy, hydroxy, amino, or N-substituted amino;
provided that R¹, R², R³, and R⁴ are not all simultaneously hydrogen;
wherein each of R⁵, R⁶, R⁷, R⁸, and R⁹ is independently selected from hydrogen, (C₁-C₂₀)alkyl, (C₁-C₂₀)alkoxy, (C₂-C₂₀)alkenyl, (C₂-C₂₀)alkenyloxy, (C₂-C₂₀)alkynyl, (C₂-C₂₀)alkynyloxy, aryl, aryloxy, heteroaryl, heteroaryloxy, heterocyclyl, heterocyclyloxy, aryl(C₁-C₄)alkyl, (C₁-C₄)alkylaryl(C₁-C₄)alkyl, heteroaryl(C₁-C₄)alkyl, (C₁-C₄)alkylheteroaryl(C₁-C₄)alkyl, heterocyclyl(C₁-C₄)alkyl, and (C₁-C₄)alkylheterocyclyl(C₁-C₄)alkyl, each of which is optionally substituted with alkoxy, hydroxy, amino, or N-substituted amino;
wherein any two of R⁵, R⁶, R⁷, R⁸, and R⁹, taken together with nitrogen to which the two of R⁵, R⁶, R⁷, R⁸, and R⁹ are bonded and optionally carbon, optionally form a heterocyclic or heteroaryl ring that is optionally substituted with alkoxy, hydroxy, amino, or N-substituted amino;
wherein each of R¹⁰, R¹¹, R¹², R¹³, R¹⁴, R¹⁵, and R¹⁶ is independently selected from hydrogen, (C₁-C₂₀)alkyl, (C₁-C₂₀)alkoxy, (C₂-C₂₀)alkenyl, (C₂-C₂₀)alkenyloxy, (C₂-C₂₀)alkynyl, (C₂-C₂₀)alkynyloxy, aryl, aryloxy, heteroaryl, heteroaryloxy, heterocyclyl, heterocyclyloxy, aryl(C₁-C₄)alkyl, (C₁-C₄)alkylaryl(C₁-C₄)alkyl, heteroaryl(C₁-C₄)alkyl, (C₁-C₄)alkylheteroaryl(C₁-C₄)alkyl, heterocyclyl(C₁-C₄)alkyl, and (C₁-C₄)alkylheterocyclyl(C₁-C₄)alkyl, each of which is optionally substituted with alkoxy, hydroxy, amino, or N-substituted amino;
wherein R¹⁵, and one of R¹¹ or R¹⁵, taken together with the carbons and nitrogen between R¹⁵, and the one of R¹¹ or R¹², optionally form a heterocyclic or heteroaryl ring;
wherein R¹⁰ and R¹¹ and/or R¹² and R¹³, taken together with nitrogen, optionally form a heterocyclic or heteroaryl ring;
wherein R¹⁴, and one of R¹⁰ or R¹¹, and/or R¹⁶, and one of R¹² and R¹³, taken together with carbon and nitrogen, optionally form a heterocyclic ring;
wherein R¹⁴ and R¹⁶, taken together with the carbons between R¹⁴ and R¹⁶, optionally form a carbocyclic or heterocyclic ring;
provided that R¹⁰ and R¹¹ are not simultaneously hydrogen;
provided that R¹² and R¹³ are not simultaneously hydrogen;
wherein each of R¹⁷, R¹⁸, R¹⁹, and R²⁰ is independently selected from (C₁-C₂₀)alkyl, (C₁-C₂₀)alkoxy, (C₂-C₂₀)alkenyl, (C₂-C₂₀)alkenyloxy, (C₂-C₂₀)alkynyl, (C₂-C₂₀)alkynyloxy, aryl, aryloxy, heteroaryl, heteroaryloxy, heterocyclyl, heterocyclyloxy, aryl(C₁-C₄)alkyl, (C₁-C₄)alkylaryl(C₁-C₄)alkyl, heteroaryl(C₁-C₄)alkyl, (C₁-C₄)alkylheteroaryl(C₁-C₄)alkyl, heterocyclyl(C₁-C₄)alkyl, and (C₁-C₄)alkylheterocyclyl(C₁-C₄)alkyl, each of which is optionally substituted with alkoxy, hydroxy, amino, or N-substituted amino;
wherein any two of R¹⁷, R¹⁸, R¹⁹, and R²⁰, taken together with nitrogen, optionally form a heterocyclic or heteroaryl ring;
wherein each of R²¹, R²², and R²³ is independently selected from (C₁-C₂₀)alkyl, (C₁-C₂₀)alkoxy, (C₂-C₂₀)alkenyl, (C₂-C₂₀)alkenyloxy, (C₂-C₂₀)alkynyl, (C₂-C₂₀)alkynyloxy, aryl, aryloxy, heteroaryl, heteroaryloxy, heterocyclyl, heterocyclyloxy, aryl(C₁-C₄)alkyl, (C₁-C₄)alkylaryl(C₁-C₄)alkyl, heteroaryl(C₁-C₄)alkyl, (C₁-C₄)alkylheteroaryl(C₁-C₄)alkyl, heterocyclyl(C₁-C₄)alkyl, and (C₁-C₄)alkylheterocyclyl(C₁-C₄)alkyl, each of which is optionally substituted with alkoxy, hydroxy, amino, or N-substituted amino;
wherein any two of R²¹, R²², and R²³, taken together with nitrogen, optionally form a heterocyclic or heteroaryl ring;
wherein each of R²⁴, R²¹, R²⁶, and R²⁷ is independently selected from (C₁-C₂₀)alkyl, (C₁-C₂₀)alkoxy, (C₂-C₂₀)alkenyl, (C₂-C₂₀)alkenyloxy, (C₂-C₂₀)alkynyl, (C₂-C₂₀)alkynyloxy, aryl, aryloxy, heteroaryl, heteroaryloxy, heterocyclyl, heterocyclyloxy, aryl(C₁-C₄)alkyl, (C₁-C₄)alkylaryl(C₁-C₄)alkyl, heteroaryl(C₁-C₄)alkyl, (C₁-C₄)alkylheteroaryl(C₁-C₄)alkyl, heterocyclyl(C₁-C₄)alkyl, and (C₁-C₄)alkylheterocyclyl(C₁-C₄)alkyl, each of which is optionally substituted with alkoxy, hydroxy, amino, or N-substituted amino;
wherein any two of R²⁴, R²⁵, R²⁶, and R²⁷, taken together with phosphorus, optionally form a heterocyclic ring;
wherein each of R²⁸, R²⁹, and R³⁰ is N(R³²)₂ or N═P(N(R³³)₂)₃;
wherein R³¹, each R³², and each R³³ are independently selected from hydrogen, (C₁-C₂₀)alkyl, (C₁-C₂₀)alkoxy, (C₂-C₂₀)alkenyl, (C₂-C₂₀)alkenyloxy, (C₂-C₂₀)alkynyl, (C₂-C₂₀)alkynyloxy, aryl, aryloxy, heteroaryl, heteroaryloxy, heterocyclyl, heterocyclyloxy, aryl(C₁-C₄)alkyl, (C₁-C₄)alkylaryl(C₁-C₄)alkyl, heteroaryl(C₁-C₄)alkyl, (C₁-C₄)alkylheteroaryl(C₁-C₄)alkyl, heterocyclyl(C₁-C₄)alkyl, and (C₁-C₄)alkylheterocyclyl(C₁-C₄)alkyl, each of which is optionally substituted with alkoxy, hydroxy, amino, or N-substituted amino; and
wherein any two of R²⁸, R²⁹, and R³⁰, and/or any two R³², and/or any two R³³, taken together with nitrogen, may form a heterocyclic ring.

19. A ceramic, comprising the geopolymer composition of claim 15.

20. The ceramic of claim 19, comprising cordierite, a mixed yttrium and aluminum silicate, yttrium disilicate, or willemite.
